(19) United States
(12) Patent Application Publication
(10) Pub. No.: US 2024/0413324 A1
(43) Pub. Date: Dec. 12, 2024

(54) LITHIUM ION BATTERY

(71) Applicant: SEMICONDUCTOR ENERGY LABORATORY CO., LTD., Atsugi-shi, Kanagawa-ken (JP)

(72) Inventors: Seiya SAITO, Atsugi, Kanagawa (JP); Tetsuya KAKEHATA, Isehara, Kanagawa (JP); Kazutaka KURIKI, Ebina, Kanagawa (JP); Taisuke NAKAO, Atsugi, Kanagawa (JP); Kenji ARAI, Isehara, Kanagawa (JP)

(21) Appl. No.: 18/703,508

(22) PCT Filed: Oct. 14, 2022
(86) PCT No.: PCT/IB2022/059839

§ 371 Date: Apr. 22, 2024

(30) Foreign Application Priority Data
Oct. 26, 2021 (JP) 2021-174618

(51) Int. Cl. H01M 4/525; H01M 4/02; H01M 10/0525; H01M 10/0569

(52) U.S. Cl. CPC H01M 4/525; H01M 10/0525; H01M 10/0569; H01M 2004/028; H01M 2300/004

(57) ABSTRACT

A lithium ion battery having excellent discharge characteristics even at a temperature below freezing is provided. The lithium ion battery includes a positive electrode containing a positive electrode active material, an electrolyte solution, and a negative electrode containing a negative electrode active material that is a carbon material; the carbon material has peaks at 2θ of greater than or equal to 20° and less than or equal to 24°, 2θ of greater than or equal to 42° and less than or equal to 46.5°, and 2θ of greater than or equal to 78° and less than or equal to 82° in X-ray diffraction (XRD) analysis; and a value of the discharge capacity obtained by subjecting the lithium ion battery to constant current and constant voltage charging (0.1 C, 4.5 V, and a termination current of 0.01 C) at 25° C. and then discharging at −40° C. is higher than or equal to 40% of a value of the discharge capacity in discharging at 25° C.

### TECHNICAL FIELD

The invention disclosed in this specification and the like (hereinafter sometimes referred to as “the present invention” in this specification and the like) relates to a power storage device, a secondary battery, and the like. In particular, the present invention relates to a lithium ion battery.

The present invention relates to an object, a method, or a manufacturing method. Alternatively, the present invention relates to a process, a machine, manufacture, or a composition (composition of matter). Alternatively, the present invention relates to a semiconductor device, a display device, a light-emitting device, a power storage device, a lighting device, an electronic device, or a manufacturing method thereof.

### BACKGROUND ART

In recent years, a variety of power storage devices such as lithium ion batteries, lithium ion capacitors, and air batteries have been actively developed. In particular, demands for lithium ion batteries with high output and high energy density have rapidly grown with the development of the semiconductor industry, for portable information terminals such as mobile phones, smartphones, and laptop computers, portable music players, digital cameras, medical equipment, clean energy vehicles such as hybrid electric vehicles (HVs), electric vehicles (EVs), and plug-in hybrid electric vehicles (PHVs), and the like, and the lithium ion batteries are essential as rechargeable energy supply sources for today's information society.

In a lithium ion battery, charge characteristics and/or discharge characteristics change depending on a charge environment and/or a discharge environment of the battery. For example, it is known that the discharge capacity of a lithium ion battery changes depending on a discharge temperature.

Thus, a lithium ion battery having excellent battery characteristics even in a low-temperature environment is required (e.g., see Patent Document 1).

### REFERENCES

### Patent Document

[Patent Document 1] Japanese Published Patent Application No. 2015-026608

### Non-Patent Document

[Non-Patent Document 1] Zhaohui Chen et al, “Staging Phase Transitions in LiₓCoO₂”, Journal of The Electrochemical Society, 2002, 149(12) A1604-A1609

### SUMMARY OF THE INVENTION

### Problems to be Solved by the Invention

Patent Document 1 describes that a lithium ion battery capable of operating even in a low-temperature environment can be obtained with use of the nonaqueous solvent described in Patent Document 1. However, even the lithium ion battery described in Patent Document 1 does not have high discharge capacity when discharging is performed at a temperature lower than or equal to 0° C. (also referred to as “temperature below freezing”) at the time of application, and further improvement is desired.

An object of one embodiment of the present invention is to provide a lithium ion battery having excellent discharge characteristics even at a temperature below freezing. Another object is to provide a lithium ion battery having excellent charge characteristics even at a temperature below freezing.

Specifically, an object is to provide a lithium ion battery that has high discharge capacity and/or high discharge energy density even when discharging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.). Another object is to provide a lithium ion battery that has a low decrease rate, in comparison with a value(s) of discharge capacity and/or discharge energy density obtained by discharging at 25° C., even when discharging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.). Another object is to provide a lithium ion battery that has high charge capacity even when charging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.). Another object is to provide a lithium ion battery that has a low decrease rate, in comparison with a value of charge capacity obtained by charging at 25° C., even when charging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.).

Another object is to provide a secondary battery with high charge voltage. Another object is to provide a highly safe or highly reliable secondary battery. Another object is to provide a secondary battery that hardly deteriorates. Another object is to provide a long-life secondary battery. Another object is to provide a novel secondary battery.

Another object is to provide a novel material, a novel active material, a novel power storage device, or a manufacturing method thereof.

Note that the description of these objects does not preclude the existence of other objects. One embodiment of the present invention does not need to achieve all these objects. Other objects can be derived from the descriptions of the specification, the drawings, the claims, and the like.

### Means for Solving the Problems

In order to achieve the above objects and the like, one embodiment of the present invention employs the following structure.

One embodiment of the present invention is a lithium ion battery including a positive electrode containing a positive electrode active material, an electrolyte solution, and a negative electrode containing a negative electrode active material that is a carbon material; in X-ray diffraction (XRD) analysis with CuKα₁ radiation, the carbon material has peaks at 2θ of greater than or equal to 20° and less than or equal to 24°, 2θ of greater than or equal to 42° and less than or equal to 46.5°, and 2θ of greater than or equal to 78° and less than or equal to 82°; and a value of the discharge capacity obtained by subjecting the lithium ion battery to constant current charging at a charge rate of 0.1 C (1 C=200 mA/g) to a voltage of 4.5 V and constant voltage charging at 4.5 V to a current value of 0.05 C at 25° C. and then constant current discharging at a discharge rate of 0.1 C to a voltage of 2.5 V at −40° C. is higher than or equal to 40% of a value of the discharge capacity obtained by subjecting the lithium ion battery to constant current charging at a charge rate of 0.1 C to a voltage of 4.5 V and constant voltage charging at 4.5 V to a current value of 0.05 C at 25° C. and then constant current discharging at a discharge rate of 0.1 C to a voltage of 2.5 V at 25° C.

The positive electrode active material contained in the lithium ion battery of one embodiment of the present invention preferably contains lithium cobalt oxide represented by LiₓCoO₂ (0<x≤1); when x in the LiₓCoO₂ is 1, the LiₓCoO₂ preferably has a layered rock-salt crystal structure of a space group R-3m; and when x in the LiₓCoO₂ is greater than 0.1 and less than or equal to 0.24 in a charged state, the LiₓCoO₂ preferably has a crystal structure of a space group P2/m where a lattice constant a=4.88±0.01 (×10⁻¹ nm), a lattice constant b=2.82±0.01 (×10⁻¹ nm), a lattice constant c=4.84±0.01 (×10⁻¹ nm), α=90°, β=109.58±0.01°, and γ=90°.

The positive electrode active material contained in the lithium ion battery of one embodiment of the present invention preferably contains lithium cobalt oxide represented by LiₓCoO₂ (0<x≤1); when x in the LiₓCoO₂ is 1, the LiₓCoO₂ preferably has a layered rock-salt crystal structure of a space group R-3m; and when x in the LiₓCoO₂ is greater than 0.1 and less than or equal to 0.24 in a charged state, a diffraction pattern of the LiₓCoO₂ analyzed by X-ray diffraction with CuKα₁ radiation preferably has peaks at least at 2θ of greater than or equal to 19.37° and less than or equal to 19.57° and 2θ of greater than or equal to 45.57° and less than or equal to 45.67°.

The electrolyte solution included in the lithium ion battery of one embodiment of the present invention preferably contains ethylene carbonate, ethyl methyl carbonate, and dimethyl carbonate, and the volume ratio between the ethylene carbonate, the ethyl methyl carbonate, and the dimethyl carbonate is preferably x:y:100−x−y (5≤x≤35 and 0<y<65) when a total amount of the ethylene carbonate, the ethyl methyl carbonate, and the dimethyl carbonate is set to 100 Vol %.

### Effect of the Invention

One embodiment of the present invention can provide a lithium ion battery that has high discharge capacity and/or high discharge energy density even when discharging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.). Another embodiment of the present invention can provide a lithium ion battery that has a low decrease rate, in comparison with a value(s) of discharge capacity and/or discharge energy density obtained by discharging at 25° C., even when discharging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.). Another embodiment of the present invention can provide a lithium ion battery that has high charge capacity even when charging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.). Another embodiment of the present invention can provide a lithium ion battery that has a low decrease rate, in comparison with a value of charge capacity obtained by charging at 25° C., even when charging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.).

Another embodiment of the present invention can provide a secondary battery with high charge voltage. Another embodiment of the present invention can provide a highly safe or highly reliable secondary battery. Another embodiment of the present invention can provide a secondary battery that hardly deteriorates. Another embodiment of the present invention can provide a long-life secondary battery. Another embodiment of the present invention can provide a novel secondary battery.

Another embodiment of the present invention can provide a novel material, a novel active material particle, a novel power storage device, or a manufacturing method thereof.

### BRIEF DESCRIPTION OF THE DRAWINGS

FIG. 1 is an example of a cross-sectional view of a secondary battery.

FIG. 2A and FIG. 2B are diagrams showing temperature characteristics of half cells.

FIG. 3A and FIG. 3B are diagrams showing XRD measurement results.

FIG. 4A to FIG. 4C are diagrams showing voltage and energy of a secondary battery.

FIG. 5A1 and FIG. 5A2 are cross-sectional views of a positive electrode active material, and FIG. 5B1 and FIG. 5B2 are parts of a cross-sectional view of the positive electrode active material.

FIG. 6 is an example of a TEM image showing crystal orientations substantially aligned with each other.

FIG. 7A is an example of a STEM image showing crystal orientations substantially aligned with each other. FIG. 7B is an FFT pattern of a region of a rock-salt crystal RS, and FIG. 7C is an FFT pattern of a region of a layered rock-salt crystal LRS.

FIG. 8 is a diagram showing crystal structures of a positive electrode active material.

FIG. 9 is a diagram showing crystal structures of a conventional positive electrode active material.

FIG. 10A1 and FIG. 10A2 are parts of a cross-sectional view of a positive electrode active material.

FIG. 10B1 to FIG. 10C show calculation results of lithium cobalt oxide crystal planes and magnesium distribution.

FIG. 11A and FIG. 11B are cross-sectional views of a positive electrode active material, and FIG. 11C1 and FIG. 11C2 are parts of a cross-sectional view of the positive electrode active material.

FIG. 12 is a diagram showing XRD patterns calculated from crystal structures.

FIG. 13 is a diagram showing XRD patterns calculated from crystal structures.

FIG. 14A and FIG. 14B are diagrams showing XRD patterns calculated from crystal structures.

FIG. 15A to FIG. 15C show lattice constants calculated from XRD.

FIG. 16A to FIG. 16C show lattice constants calculated from XRD.

FIG. 17A and FIG. 17B are cross-sectional views of a positive electrode active material.

FIG. 18 is a cross-sectional view of a positive electrode active material.

FIG. 19A to FIG. 19C are diagrams showing a method for forming a positive electrode active material.

FIG. 20 is a diagram showing a method for forming a positive electrode active material.

FIG. 21A to FIG. 21C are diagrams showing a method for forming a positive electrode active material.

FIG. 22A is an exploded perspective view of a coin-type secondary battery, FIG. 22B is a perspective view of the coin-type secondary battery, and FIG. 22C is a cross-sectional perspective view thereof.

FIG. 23A illustrates an example of a cylindrical secondary battery. FIG. 23B illustrates an example of the cylindrical secondary battery. FIG. 23C illustrates an example of a plurality of cylindrical secondary batteries. FIG. 23D illustrates an example of a power storage system including the plurality of cylindrical secondary batteries.

FIG. 24A and FIG. 24B are diagrams illustrating examples of a secondary battery, and FIG. 24C is a diagram illustrating a state of the inside of the secondary battery.

FIG. 25A to FIG. 25C are diagrams illustrating an example of a secondary battery.

FIG. 26A and FIG. 26B are diagrams illustrating external views of a secondary battery.

FIG. 27A to FIG. 27C are diagrams illustrating a method for fabricating a secondary battery.

FIG. 28A to FIG. 28C are diagrams illustrating structure examples of a battery pack.

FIG. 29A to FIG. 29E are diagrams illustrating a structure example of a bendable secondary battery.

FIG. 30A and FIG. 30B illustrate a structure example of a secondary battery at the time of bending, and FIG. 30C is a model diagram of the secondary battery at the time of bending.

FIG. 31A and FIG. 31B are diagrams illustrating a method for fabricating a secondary battery.

FIG. 32A to FIG. 32E are diagrams illustrating a method for fabricating a secondary battery.

FIG. 33A to FIG. 33E are diagrams illustrating a method for fabricating a secondary battery.

FIG. 34A to FIG. 34F are diagrams illustrating a method for fabricating a secondary battery.

FIG. 35 is a diagram illustrating of a structure example of a secondary battery.

FIG. 36 is a diagram illustrating a method for processing a film.

FIG. 37A to FIG. 37E are diagrams illustrating a method for processing a film.

FIG. 38A and FIG. 38B are diagrams illustrating a method for processing a film.

FIG. 39A to FIG. 39C are diagrams illustrating a method for processing a film.

FIG. 40A to FIG. 40E are top views, a cross-sectional view, and a schematic view illustrating one embodiment of the present invention.

FIG. 41A and FIG. 41B are cross-sectional views of a secondary battery of one embodiment of the present invention.

FIG. 42A to FIG. 42E are diagrams illustrating a method for fabricating a secondary battery.

FIG. 43A to FIG. 43E are diagrams illustrating a structure example of a secondary battery.

FIG. 44A to FIG. 44C are diagrams illustrating structure examples of a secondary battery.

FIG. 45A to FIG. 45C are diagrams illustrating structure examples of a secondary battery.

FIG. 46A to FIG. 46C are diagrams illustrating structure examples of a secondary battery.

FIG. 47A is a perspective view of a battery pack of one embodiment of the present invention, FIG. 47B is a block diagram of the battery pack, and FIG. 47C is a block diagram of a vehicle having a motor.

FIG. 48A to FIG. 48D are diagrams illustrating examples of transport vehicles. FIG. 48E is a diagram illustrating an example of an artificial satellite.

FIG. 49A and FIG. 49B are diagrams illustrating power storage devices of one embodiment of the present invention.

FIG. 50A is a diagram illustrating an electric bicycle, FIG. 50B is a diagram illustrating a secondary battery of the electric bicycle, and FIG. 50C is a diagram illustrating an electric motorcycle.

FIG. 51A to FIG. 51D are diagrams illustrating examples of electronic devices.

FIG. 52A illustrates examples of wearable devices, FIG. 52B illustrates a perspective view of a watch-type device, FIG. 52C is a diagram illustrating a side surface of the watch-type device, and

FIG. 52D is a perspective view illustrating wireless earphones.

FIG. 53A to FIG. 53C are diagrams illustrating a structure example of an electronic device.

FIG. 54A to FIG. 54C are diagrams illustrating structure examples of electronic devices.

FIG. 55A is an external view illustrating an example of an electronic device of one embodiment of the present invention, FIG. 55B is an external view of the electronic device seen from the other direction, and FIG. 55C is a diagram illustrating an example of the appearance of a secondary battery incorporated in the electronic device.

FIG. 56 is a diagram showing battery characteristics in Example.

FIG. 57A and FIG. 57B are diagrams showing battery characteristics in Example.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In addition, in the drawings, the size, the layer thickness, or the region is exaggerated for clarity in some cases. Therefore, they are not limited to the illustrated scale.

The ordinal numbers such as “first” and “second” in this specification and the like are used for convenience and do not denote the order of steps or the stacking order of layers. Therefore, for example, the term “first” can be replaced with the term “second”, “third”, or the like as appropriate. In addition, the ordinal numbers in this specification and the like do not sometimes correspond to the ordinal numbers that are used to specify one embodiment of the present invention.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The particle diameter of a particle can be measured by laser diffraction particle size distribution measurement, for example, and can be represented as D50. D50 is a particle diameter when the cumulative volume of a particle size distribution curve accounts for 50% in a measurement result of the particle size distribution, i.e., a median diameter. The measurement of the particle diameter of a particle is not limited to laser diffraction particle size distribution measurement; in the case where the particle diameter of a particle is less than or equal to the lower measurement limit of laser diffraction particle size distribution measurement, the cross-sectional diameter of a particle cross section may be measured by analysis with a SEM (scanning electron microscope), a TEM (transmission electron microscope), or the like. As a method for measuring the particle diameter of a particle whose cross-sectional shape is not a circle, for example, the cross-sectional area of the particle is calculated by image processing or the like, whereby the particle diameter can be estimated assuming that the particle has a circular cross section with the equivalent area.

In this specification and the like, a space group is represented using the short notation of the international notation (or the Hermann-Mauguin notation). In addition, the Miller index is used for the expression of crystal planes and crystal orientations. An individual plane that shows a crystal plane is denoted by “( )”. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[ ]”, a set direction which shows all of the equivalent orientations is denoted with “< >” an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

A theoretical capacity of a positive electrode active material refers to the amount of electricity obtained when all lithium that can be inserted and extracted and is contained in the positive electrode active material is extracted. For example, the theoretical capacity of LixCoO₂ is 274 mAh/g, the theoretical capacity of lithium nickel oxide (LiNiO₂) is 275 mAh/g, and the theoretical capacity of lithium manganese oxide (LiMn₂O₄) is 148 mAh/g.

The remaining amount of lithium that can be inserted into and extracted from a positive electrode active material is represented by x in a compositional formula, e.g., x in LiₓCoO₂ or x in LiₓMO₂ (M is a transition metal). Note that x can also be referred to as the occupancy rate of Li in lithium sites. In the case of a positive electrode active material in a secondary battery, x=(theoretical capacity−charge capacity)/theoretical capacity can be satisfied. For example, in the case where a secondary battery using LiCoO₂ as a positive electrode active material is charged to 219.2 mAh/g, it can be said that the positive electrode active material is represented by Li_{0.2}CoO₂ or x=0.2. Note that “x in LiₓCoO₂ is small” means, for example, 0.1<x≤0.24. Note that the transition metal M can be selected from the elements belonging to Groups 4 to 13 of the periodic table and for example, at least one of manganese, cobalt, and nickel is used.

In the case where lithium cobalt oxide substantially satisfies the stoichiometric composition, the lithium cobalt oxide is LiCoO₂ and the occupancy rate x of Li in lithium sites is 1. In a secondary battery after its discharging ends, it can be said that contained lithium cobalt oxide is also LiCoO₂ and x=1. Here, “discharging ends” means that a voltage becomes lower than or equal to 2.5 V (vs. Li counter electrode) at a current of 100 mA/g, for example. In a lithium ion secondary battery, the voltage rapidly decreases when the occupancy rate of lithium in the lithium sites becomes x=1 and no more lithium can enter the lithium ion secondary battery. At this time, it can be said that discharging ends. In general, in a lithium ion secondary battery using LiCoO₂, the discharge voltage rapidly decreases before discharge voltage reaches 2.5 V; thus, discharging ends under the above-described conditions.

Charge capacity and/or discharge capacity used for calculation of x in LiₓCoO₂ is preferably measured under the condition where there is no influence or small influence of a short circuit and/or decomposition of an electrolyte. For example, data of a secondary battery, containing a sudden capacity change that seems to result from a short circuit, is preferably not used for calculation of x.

The space group of a crystal structure is identified by XRD, electron diffraction, neutron diffraction, or the like. Thus, in this specification and the like, belonging to a space group, being attributed to a space group, or being a space group can be rephrased as being identified as a space group.

Note that in a layered rock-salt crystal and a rock-salt crystal, a structure where A layer, B layer, and C layer having anions are shifted and stacked like “ABCABC” is referred to as a cubic close-packed structure. Accordingly, anions do not necessarily form a cubic lattice structure. At the same time, actual crystals always have a defect and thus, analysis results are not necessarily consistent with the theory. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is 5° or less or 2.5° or less.

Uniformity refers to a phenomenon in which, in a solid made of a plurality of elements (e.g., A, B, and C), a certain element (e.g., A) is distributed with similar features in specific regions. Note that it is acceptable for the specific regions to have substantially the same concentration of the element. For example, a difference in the concentration of the element between the specific regions can be 10% or less. Examples of the specific regions include a surface portion, a surface, a projection, a depression, and an inner portion.

Electrodes (a positive electrode and a negative electrode) each include an active material layer and a current collector. An electrode in which one surface of a current collector is provided with an active material layer is referred to as a single-side-coated electrode, and an electrode in which both surfaces of a current collector are provided with active material layers is referred to as a double-side-coated electrode. The electrode of one embodiment of the present invention and the fabrication method thereof are applicable to both a single-side-coated electrode and a double-side-coated electrode.

A positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a charge and discharge capacity decrease due to repeated charging and discharging.

### Embodiment 1

### [Lithium Ion Battery]

A lithium ion battery of one embodiment of the present invention includes a positive electrode, a negative electrode, and an electrolyte. When an electrolyte solution is used as the electrolyte, a separator is provided between the positive electrode and the negative electrode. The lithium ion battery of one embodiment of the present invention may include an exterior body covering at least part of the surroundings of the positive electrode, the negative electrode, and the electrolyte.

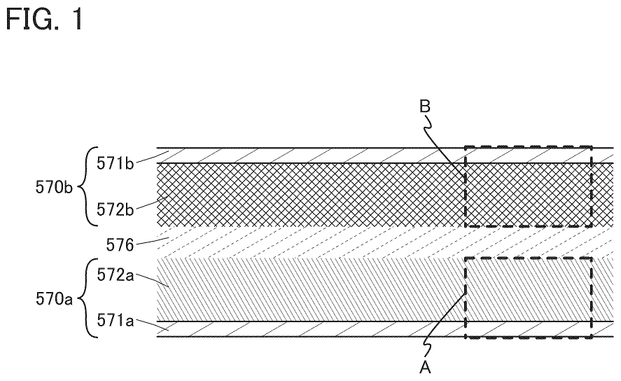

FIG. 1 is a schematic cross-sectional view illustrating the inside of the secondary battery of one embodiment of the present invention. A negative electrode 570a, a positive electrode 570b, and an electrolyte 576 illustrated in FIG. 1 can be used in a coin-type secondary battery, a cylindrical secondary battery, a laminated secondary battery, and the like in embodiments described later. The negative electrode 570a includes at least a negative electrode current collector 571a and a negative electrode active material layer 572a formed in contact with the negative electrode current collector 571a. The positive electrode 570b includes at least a positive electrode current collector 571b and a positive electrode active material layer 572b formed in contact with the positive electrode current collector 571b. The secondary battery may further include a separator between the negative electrode 570a and the positive electrode 570b (at the position of the electrolyte 576).

In this embodiment, description is made focusing on a structure of a lithium ion battery which is needed to provide a lithium ion battery with excellent discharge characteristics even at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.) and/or a lithium ion battery with excellent charge characteristics even at a temperature below freezing. Specifically, a negative electrode active material contained in the negative electrode and a positive electrode active material contained in the positive electrode are mainly described.

### [Negative Electrode]

The negative electrode includes a negative electrode active material layer and a negative electrode current collector. The negative electrode active material layer includes a negative electrode active material, and may further include a conductive material and a binder.

Metal foil can be used as the current collector, for example. The negative electrode can be formed by applying slurry onto the metal foil and drying the slurry. Note that pressing may be performed after drying. The negative electrode is a component obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry; in some cases, slurry for forming a negative electrode active material layer is referred to as slurry for a negative electrode.

### <Negative Electrode Active Material>

A carbon material is preferably used as the negative electrode active material. For example, graphite (natural graphite, artificial graphite), graphitizing carbon (soft carbon), or non-graphitizing carbon (hard carbon) can be used as the carbon material in a negative electrode of a lithium ion battery.

Non-graphitizing carbon is preferable as the negative electrode active material contained in a negative electrode of the lithium ion battery of one embodiment of the present invention that has high discharge capacity and/or high discharge energy density even when discharging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.).

Non-graphitizing carbon can be obtained by baking a synthetic resin such as a phenol resin, and an organic substance of plant origin, for example. The non-graphitizing carbon contained in the negative electrode active material of the lithium ion battery of one embodiment of the present invention preferably has a peak at 2θ of greater than or equal to 20° and less than or equal to 24°, greater than or equal to 42° and less than or equal to 46.5°, and greater than or equal to 78° and less than or equal to 82° in the X-ray diffraction (XRD) measurement.

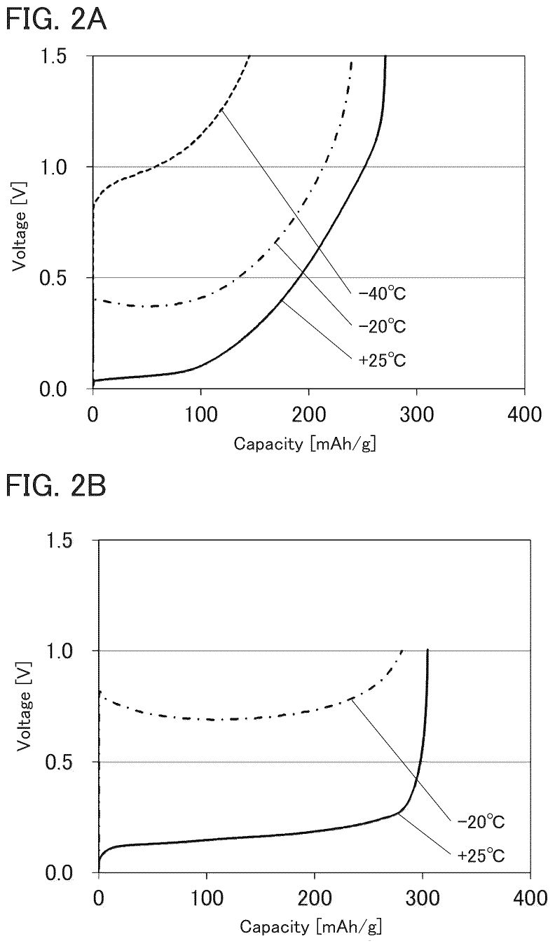

Such non-graphitizing carbon has higher insertion rate and desorption rate of lithium ions than general graphite, and can have high discharge capacity and/or discharge energy density even when discharging is performed at a temperature below freezing. FIG. 2A shows the temperature characteristics of a half cell (HC cell) fabricated using an electrode containing non-graphitizing carbon, for example. FIG. 2B shows the temperature characteristics of a half cell (graphite cell) fabricated using an electrode containing graphite. Note that in the unit (unit where capacity (mAh) is divided by mass (g)) of the horizontal axis in the graph in each of FIG. 2A and FIG. 2B, the mass is the total mass of an active material (non-graphitizing carbon or graphite) contained in the half cell.

The structures of the half cells (the HC cell and the graphite cell) shown in FIG. 2A and FIG. 2B are described. The electrode of the HC cell includes copper foil as a current collector and an active material layer containing non-graphitizing carbon, CMC (carboxymethyl cellulose), and SBR (styrenebutadiene rubber) at a weight ratio of 98:1:1. The electrode of the graphite cell includes copper foil as a current collector and an active material layer containing graphite, CMC, and SBR at a weight ratio of 98.5:0.5:1.

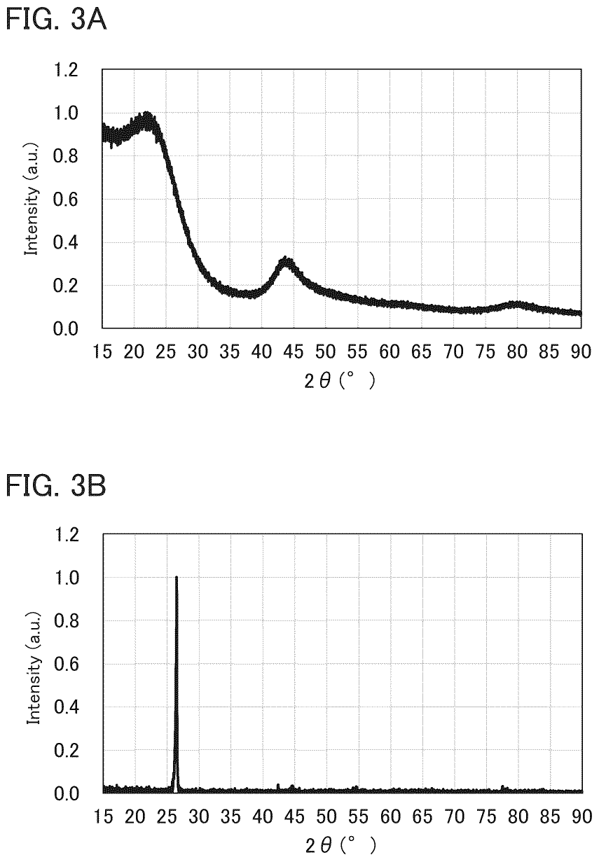

FIG. 3A shows the XRD measurement results of the above non-graphitizing carbon. FIG. 3B shows the XRD measurement results of the above graphite. In FIG. 3A, the peak is observed at 2θ of 22°, 44°, and 80°, which correspond to 0.40 nm, 0.20 nm, and 0.12 nm, respectively, when converted into interplanar spacing. In FIG. 3B, the peak is observed at 2θ of 26.50°, which correspond to 0.336 nm when converted into interplanar spacing. Note that the interplanar spacing can also be measured by a TEM (transmission electron microscope) or a STEM (scanning transmission electron microscope).

There is no particular limitation on the apparatus and conditions of the XRD measurement of the non-graphitizing carbon. The measurement can be performed with the apparatus and conditions as described below, for example.
XRD apparatus: D8 ADVANCE produced by Bruker AXS
X-ray source: CuKα₁ radiation
Output: 40 kV, 40 mA
Slit width: Div. Slit, 0.5°
Detector: LynxEye
Scanning method: 2θ/θ continuous scan
Measurement range (2θ): from 15° to 90°
Step width (2θ): 0.01°
Counting time: 0.2 seconds/step in the case of non-graphitizing carbon and 0.1 seconds/step in the case of graphite
Rotation of sample stage: 15 rpm
Sample fixing substrate: reflection-free Si plate

A counter electrode, an electrolyte, a separator, a positive electrode can, and a negative electrode can are common to the HC cell and the graphite cell. The counter electrode when the half cells are fabricated is a lithium metal. As the electrolyte, an organic electrolyte solution obtained by dissolving lithium hexafluorophosphate (LiPF₆) at 1 mol/L in a mixed organic solvent containing EC (ethylene carbonate), EMC (ethyl methyl carbonate), and DMC (dimethyl carbonate) at a volume ratio of 30:35:35 is used. As the separator, 25-μm-thick polypropylene is used. A positive electrode can and a negative electrode can that are formed using stainless steel (SUS) are used.

Note that the electrode containing non-graphitizing carbon and the electrode containing graphite can each be used as a negative electrode of a lithium ion battery; however, in the case of a half cell using lithium metal foil as a counter electrode, the electrodes each function as a positive electrode due to the reaction potentials with lithium ions.

FIG. 2A and FIG. 2B show the charge characteristics of the half cells (the HC cell and the graphite cell) under the temperature conditions of 25° C., −20° C., and −40° C. Charging is 0.2 C constant current charging, and the termination voltage of charging was 1.5 V for the HC cell and 1.0 V for the graphite cell. Note that for each of the HC cell and the graphite cell, 1 C=372 mA/g.

The HC cell including the electrode containing non-graphitizing carbon shown in FIG. 2A can be charged under any temperature conditions of 25° C., −20° C., and −40° C. Meanwhile, the graphite cell including the electrode containing graphite shown in FIG. 2B can be charged at temperature conditions of 25° C. and −20° C. but cannot be charged at −40° C.

Next, when charge curves of 25° C. and −20° C. are compared, the charge curves of 25° C. indicate higher voltage than the charge curves of −20° C. for both the HC cell and the graphite cell. The voltage difference between the charge curve of 25° C. and the charge curve of −20° C. of the HC cell is small, whereas the voltage difference between the charge curve of 25° C. and the charge curve of −20° C. of the graphite cell is large. That is, when the case where the electrode containing non-graphitizing carbon of the HC cell is used as a negative electrode of a lithium ion battery and the case where the electrode containing graphite of the graphite cell is used as a negative electrode of a lithium ion battery are compared to each other, the lithium ion battery that includes the electrode containing non-graphitizing carbon of the HC cell can keep discharge voltage high in a low-temperature environment.

Therefore, an electrode containing non-graphitizing carbon is preferable as a negative electrode of the lithium ion battery of one embodiment of the present invention that has high discharge capacity and/or high discharge energy density even when discharging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.).

Note that in addition to non-graphitizing carbon, one or more of graphite (natural graphite, artificial graphite), graphitizing carbon, carbon fiber (carbon nanotube, carbon nanofiber), graphene, carbon black, silicon (Si), tin (Sn), gallium (Ga), silicon monoxide (SiO), and lithium titanium oxide (Li₄Ti₅O₁₂) may be further contained as the negative electrode active material in the negative electrode.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide or, for instance, a cellulose derivative such as carboxymethyl cellulose (CMC), methyl cellulose, ethyl cellulose, hydroxypropyl cellulose, diacetyl cellulose, or regenerated cellulose and starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Conductive Material>

A conductive material is also referred to as a conductivity-imparting agent or a conductive additive, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

An active material layer such as the positive electrode active material layer or the negative electrode active material layer preferably contains a conductive material.

For example, one kind or two or more kinds of carbon black such as acetylene black or furnace black, graphite such as artificial graphite or natural graphite, carbon fiber such as carbon nanofiber or carbon nanotube, and a graphene compound can be used as the conductive material.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be formed by, for example, a vapor deposition method.

The active material layer may contain, as a conductive material, metal powder or metal fiber of copper, nickel, aluminum, silver, gold, or the like, a conductive ceramic material, or the like.

The content of the conductive additive to the total amount of the active material layer is preferably greater than or equal to 0.1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Thus, discharge capacity of the secondary battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The secondary battery obtained by the fabrication method of one embodiment of the present invention can have high capacity density and stability, and is effective as an in-vehicle secondary battery.

### <Current Collector>

For the current collector, it is possible to use a material which has high conductivity and is not alloyed with carrier ions of lithium or the like, e.g., a metal such as stainless steel, gold, platinum, zinc, iron, copper, aluminum, or titanium, an alloy thereof, or the like. The current collector can have a sheet-like shape, a net-like shape, a punching-metal shape, an expanded-metal shape, or the like as appropriate. The current collector preferably has a thickness greater than or equal to 10 μm and less than or equal to 30 μm.

Note that a material that is not alloyed with carrier ions of lithium or the like is preferably used for the negative electrode current collector.

As the current collector, a titanium compound may be stacked over the above-described metal. As a titanium compound, for example, it is possible to use one selected from titanium nitride, titanium oxide, titanium oxynitride in which part of nitrogen is substituted by oxygen (TiOₓN_{y}, where 0<x<2 and 0<y<1), and titanium nitride oxide in which part of oxygen is substituted by nitrogen, or a mixture or a stack of two or more of them. Titanium nitride is particularly preferable because it has high conductivity and has a high capability of inhibiting oxidation. Providing a titanium compound over the surface of the current collector inhibits a reaction between a material contained in the active material layer formed over the current collector and the metal, for example. In the case where the active material layer includes a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, providing a titanium compound over aluminum can inhibit an oxidation reaction between the current collector and the graphene oxide.

### [Positive Electrode]

A positive electrode includes a positive electrode active material layer and a positive electrode current collector. The positive electrode active material layer includes a positive electrode active material and may further include at least one of a conductive material and a binder. Note that the positive electrode current collector, the conductive material, and the binder described in [Negative electrode] can be used.

Metal foil can be used as the current collector, for example. The positive electrode can be formed by applying slurry onto the metal foil and drying the slurry. Note that pressing may be performed after drying. The positive electrode is a component obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode.

### <Positive Electrode Active Material>

A positive electrode active material applicable to a lithium ion battery capable of being charged and discharged even at low temperatures is described. As the positive electrode active material, lithium cobalt oxide and/or lithium nickel-cobalt-manganese oxide can be used. As the lithium cobalt oxide, for example, lithium cobalt oxide to which magnesium and fluorine are added is preferably used. It is preferable to use lithium cobalt oxide to which magnesium, fluorine, aluminum, and nickel are added.

As the lithium nickel-cobalt-manganese oxide, for example, lithium nickel-cobalt-manganese oxide with a ratio such as nickel:cobalt:manganese=1:1:1, nickel:cobalt:manganese=6:2:2, nickel:cobalt:manganese=8:1:1, nickel:cobalt:manganese=9:0.5:0.5, or the like can be used. As the above-described lithium nickel-cobalt-manganese oxide, for example, lithium nickel-cobalt-manganese oxide to which one or more of aluminum, calcium, barium, strontium, and gallium are added is preferably used.

In the lithium ion battery of one embodiment of the present invention that has high discharge capacity and/or high discharge energy density even when discharging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.), when non-graphitizing carbon is used as the negative electrode active material contained in the negative electrode, the positive electrode particularly preferably contains a positive electrode active material that can be used to high charge voltage.

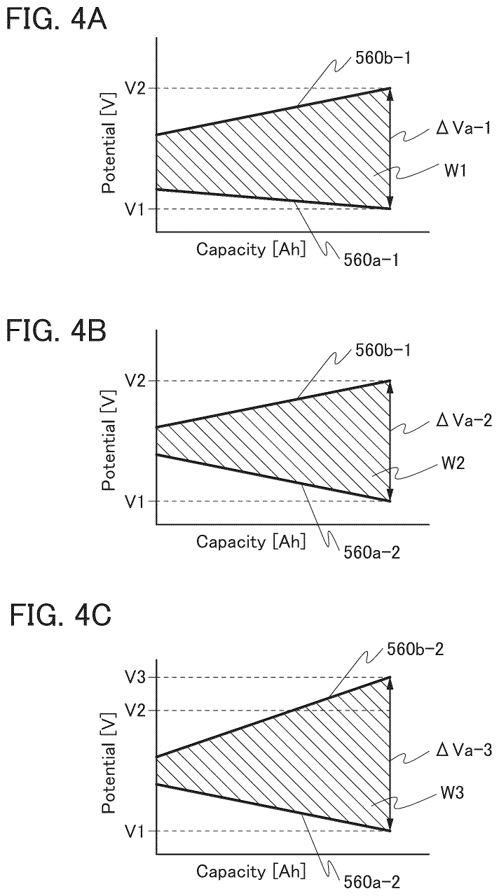

The reason why the positive electrode particularly preferably contains a positive electrode active material that can be used to high charge voltage in the case where non-graphitizing carbon is used as the negative electrode active material contained in the negative electrode is described with reference to FIG. 4A to FIG. 4C.

Negative electrode characteristic curves (560a-1 and 560a-2) and positive electrode characteristic curves (560b-1 and 560b-2) shown in FIG. 4A to FIG. 4C are characteristic curves showing the relation between the capacities and the potentials of the negative electrode active material layer 572a and the positive electrode active material layer 572b included in the negative electrode 570a and the positive electrode 570b that have the same areas and face each other in the regions surrounded by the dashed line A and the dashed line B in FIG. 1. Note that in the characteristic curves shown in FIG. 4A to FIG. 4C, the characteristic curve shapes are simplified and emphasized for description.

FIG. 4A is a diagram schematically showing the negative electrode characteristic curve 560a-1 of the negative electrode containing graphite as the negative electrode active material and the positive electrode characteristic curve 560b-1 of the positive electrode containing a positive electrode active material that cannot be used to high charge voltage. Here, a voltage ΔVa-1 of the secondary battery is a difference between the potential of the positive electrode represented by the positive electrode characteristic curve 560b-1 of the positive electrode and the potential of the negative electrode represented by the negative electrode characteristic curve 560a-1 at a certain capacity (at a certain point in time). The energy with which the secondary battery can be charged and discharged corresponds to the area of a region W1 indicated by hatching in the drawing.

Next, FIG. 4B is a diagram schematically showing the negative electrode characteristic curve 560a-2 of the negative electrode containing non-graphitizing carbon as the negative electrode active material and the positive electrode characteristic curve 560b-1 of the positive electrode containing a positive electrode active material that cannot be used to high charge voltage. Here, a voltage ΔVa-2 of the secondary battery is a difference between the potential of the positive electrode represented by the positive electrode characteristic curve 560b-1 of the positive electrode and the potential of the negative electrode represented by the negative electrode characteristic curve 560a-2 at a certain capacity (at a certain point in time). The negative electrode characteristic curve 560a-2 of the negative electrode is on the higher potential side than the negative electrode characteristic curve 560a-1. As shown in FIG. 2A and FIG. 2B, as compared with graphite, the negative electrode characteristic curve 560a-2 of the negative electrode containing non-graphitizing carbon as the negative electrode active material is high (a potential at which non-graphitizing carbon reacts with a lithium ion is high); thus, the voltage ΔVa-2 of the secondary battery might be relatively lower than the voltage ΔVa-1 of the secondary battery. At this time, the energy with which the secondary battery can be charged and discharged corresponds to the area of a region W2 indicated by hatching in the drawing, and the energy with which the secondary battery can be charged and discharged is decreased.

Here, FIG. 4C is a diagram schematically showing the negative electrode characteristic curve 560a-2 of the negative electrode containing non-graphitizing carbon as the negative electrode active material and the positive electrode characteristic curve 560b-2 of the positive electrode containing a positive electrode active material that can be used to high charge voltage. Here, a voltage ΔVa-3 of the secondary battery is a difference between the potential of the positive electrode represented by the positive electrode characteristic curve 560b-2 of the positive electrode and the potential of the negative electrode represented by the negative electrode characteristic curve 560a-2 at a certain capacity (at a certain point in time). In the case where the positive electrode active material that can be used to high charge voltage is used for the positive electrode, the voltage ΔVa-3 of the secondary battery can be higher than the voltage ΔVa-2 of the secondary battery. That is, the energy with which the secondary battery can be charged and discharged corresponds to the area of a region W3 indicated by hatching in the drawing, and the energy with which the secondary battery can be charged and discharged can be kept high.

As described above, in the case where the negative electrode contains non-graphitizing carbon as the negative electrode active material and the positive electrode contains a positive electrode active material that can be used to high charge voltage, a lithium ion battery that has high discharge capacity and/or high discharge energy density even when discharging is performed at a temperature below freezing (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.) can be obtained.

The positive electrode active material described in Embodiment 2 is preferably used as the positive electrode active material that can be used to high charge voltage.

In this specification and the like, unless otherwise specified, a “charge voltage” is shown with reference to the potential of a lithium metal. In this specification and the like, high charge voltage is a charge voltage, for example, higher than or equal to 4.6 V, preferably higher than or equal to 4.65 V, further preferably higher than or equal to 4.7 V, still further preferably higher than or equal to 4.75 V, most preferably higher than or equal to 4.8 V. Note that for the positive electrode active material, two or more kinds of materials having different particle diameters and/or compositions can be used as long as the materials have less deterioration due to charging and discharging even at high charge voltage. In this specification and the like, the term “having different compositions” includes not only the case where the elements contained in the materials have different compositions but also the case where the ratios of the elements contained in the materials are different even though the elements contained in the materials have the same composition.

As described above, “high charge voltage” in this specification and the like is the voltage higher than or equal to 4.6 V with reference to the potential when a lithium metal is used for the negative electrode; however, “high charge voltage” is the voltage higher than or equal to 4.5 V with reference to the potential when a carbon material (e.g., graphene or non-graphitizing carbon) is used for the negative electrode. In short, the charge voltage higher than or equal to 4.6 V is referred to as high charge voltage in the case of using a lithium metal as the negative electrode in a half cell, and the charge voltage higher than or equal to 4.5 V is referred to as high charge voltage in the case of using a carbon material (e.g., graphene or non-graphitizing carbon) for the negative electrode in a full cell.

### [Electrolyte]

For the electrolyte used as one embodiment of the present invention, a material with high lithium ion conductivity even in charging and/or discharging (charging and discharging) in a low-temperature environment (e.g., 0° C., −20° C., preferably −30° C., further preferably −40° C., still further preferably −50° C., most preferably −60° C.) can be used.

An example of an electrolyte is described below. Note that although the electrolyte described as an example in this embodiment is an organic solvent in which a lithium salt is dissolved and can be referred to as an electrolyte solution, the electrolyte is not limited to a liquid electrolyte (an electrolyte solution) that is liquid at room temperature and can be a solid electrolyte. Alternatively, an electrolyte including both a liquid electrolyte that is liquid at room temperature and a liquid electrolyte that is a solid at room temperature (such an electrolyte is referred to as a semi-solid electrolyte) can also be used.

For example, an organic solvent described in this embodiment contains ethylene carbonate (EC), ethyl methyl carbonate (EMC), and dimethyl carbonate (DMC). When a total amount of the ethylene carbonate, the ethyl methyl carbonate, and the dimethyl carbonate is set to 100 vol %, an organic solvent in which the volume ratio between the ethylene carbonate, the ethyl methyl carbonate, and the dimethyl carbonate is x:y:100−x−y (where 5≤x≤35 and 0<y<65) can be used. More specifically, an organic solvent containing EC, EMC, and DMC at EC:EMC:DMC=30:35:35 (volume ratio) can be used. Note that the volume ratio may be a volume ratio of the organic solvent before mixing, and the organic solvent may be mixed at room temperature (typically 25° C.).

EC is cyclic carbonate and has high relative dielectric constant, and thus has an effect of promoting dissociation of a lithium salt. Meanwhile, the EC has high viscosity and has a high freezing point (melting point) of 38° C.; thus, it is difficult to use in a low-temperature environment when EC is used alone as the organic solvent. Then, the organic solvent specifically described in one embodiment of the present invention includes not only EC but also EMC and DMC. EMC is a chain-like carbonate and has an effect of decreasing the viscosity of the electrolyte solution, and the freezing point is −54° C. In addition, DMC is also a chain-like carbonate and has an effect of decreasing the viscosity of the electrolyte solution, and the freezing point is −43° C. An electrolyte formed using a mixed organic solvent in a volume ratio of x:y:100−x−y (note that 5≤x≤35 and 0<y<65) with a total amount of these three organic solvents of EC, EMC, and DMC having such physical properties of 100 vol % has a characteristic in which the freezing point is lower than or equal to −40° C.

A general electrolyte used for a lithium ion battery is solidified at approximately −20° C.; thus, it is difficult to fabricate a battery that can be charged and discharged at −40° C. Since the electrolyte described as an example in this embodiment has a freezing point lower than or equal to −40° C., a lithium ion battery that can be charged and discharged even in an extremely low-temperature environment such as at −40° C. can be obtained.

As the electrolyte dissolved in the solvent, a lithium salt can be used. For example, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiBOB) can be used, or two or more of these lithium salts can be used in an appropriate combination with an appropriate ratio.

The electrolyte solution is preferably highly purified and contains a small amount of dust particles and elements other than the constituent elements of the electrolyte solution (hereinafter, also simply referred to as “impurities”). Specifically, the ratio of impurities to the electrolyte solution is preferably less than or equal to 1 wt %, further preferably less than or equal to 0.1 wt %, still further preferably less than or equal to 0.01 wt %.

In order to form a coating film (Solid Electrolyte Interphase) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

Although an example of an electrolyte that can be used for the lithium ion battery of one embodiment of the present invention is described above, the electrolyte that can be used for the lithium ion battery of one embodiment of the present invention should not be construed as being limited to the example. Another material can be used as long as it has high lithium ion conductivity even when charging and discharging are performed in a low-temperature environment.

### [Separator]

When the electrolyte includes an electrolyte solution, a separator is positioned between the positive electrode and the negative electrode. The separator can be formed using, for example, a fiber containing cellulose, such as paper, nonwoven fabric, glass fiber, ceramics, or synthetic fiber containing nylon (polyamide), polyimide, vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a polyimide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With use of a separator having a multilayer structure, the capacity per volume of the secondary battery can be increased because the safety of the secondary battery can be maintained even when the total thickness of the separator is small.

### [Exterior Body]

For an exterior body included in the battery, a metal material such as aluminum, stainless steel, or titanium or a resin material can be used, for example. A film-like exterior body can also be used. As the film, for example, it is possible to use a film having a three-layer structure in which a highly flexible metal thin film or metal foil of aluminum, stainless steel, titanium, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. Such a film with a multilayer structure can be referred to as a laminated film. At this time, the laminated film is sometimes referred to as an aluminum laminated film, a stainless steel laminated film, a titanium laminated film, a copper laminated film, a nickel laminated film, or the like using the material name of the metal layer included in the laminated film.

The material or thickness of the metal layer included in the laminated film sometimes affects the flexibility of a battery. As an exterior body used for a highly flexible (bendable) battery, for example, an aluminum laminated film including a polypropylene layer, an aluminum layer, and nylon is preferably used. Here, the thickness of the aluminum layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer; thus, the thickness of the aluminum layer is desirably larger than or equal to 10 μm.

The lithium ion battery of one embodiment of the present invention contains at least the above positive electrode active material and negative electrode active material, thereby achieving excellent discharge characteristics and/or excellent charge characteristics even in a low-temperature environment. More specifically, the lithium ion battery containing at least the above positive electrode active material and negative electrode active material can achieve the following low-temperature characteristic: a value of the discharge capacity obtained by subjecting the lithium ion battery to constant current charging at a charge rate of 0.1 C or 0.2 C to a voltage of 4.5 V and constant voltage charging at 4.5 V to a current value of 0.05 C in an environment of 25° C. and then constant current discharging at a discharge rate of 0.1 C to a voltage of 2.5 V in an environment of −40° C. is higher than or equal to 40% (preferably higher than or equal to 50%, further preferably higher than or equal to 60%, most preferably higher than or equal to 70%) of a value of the discharge capacity obtained by subjecting the lithium ion battery to constant current charging at a charge rate of 0.1 C or 0.2 C to a voltage of 4.5 V and constant voltage charging at 4.5 V to a current value of 0.05 C in an environment of 25° C. and then constant current discharging at a discharge rate of 0.1 C to a voltage of 2.5 V in an environment of 25° C. In this specification and the like, when the discharge capacity in an environment of T ° C. (T is given temperature other than 25° C. (° C.)) can be higher than or equal to 50% of the discharge capacity in an environment of 25° C., it can be said that the lithium ion battery can be operated at T ° C. Note that 1 C=200 mA/g (positive electrode active material weight).

The temperature at the time of charging or discharging described in this specification and the like refers to the temperature of an environment (environment temperature) for measuring a lithium ion battery. In the measurement of the battery characteristics in a variety of environment temperatures, for example, a thermostatic chamber that is stable at desired temperature is used, a battery (e.g., a test battery or a half cell) that is a target of the measurement is installed in the thermostatic chamber, and then the measurement can start after sufficient time (e.g., 1 hour or longer) break until the temperature of the test cell is substantially equal to the inner temperature of the thermostatic chamber. The method is not necessarily limited thereto.

The lithium ion battery of one embodiment of the present invention contains at least the above positive electrode active material and negative electrode active material, whereby a lithium ion battery capable of being charged and discharged even at low temperatures can be achieved. The lithium ion battery is not necessarily used alone; for example, a power storage device in which a lithium ion battery that can be charged and discharged even at low temperatures and a general lithium ion battery are adjacent to each other may be used. The power storage device having such a structure can heat the general lithium ion battery by using, as an internal heat source in a low temperature environment, heat generated by charging and discharging of the lithium ion battery capable of being charged and discharged even at low temperatures.

The contents of this embodiment can be freely combined with the contents of the other embodiments.

### Embodiment 2

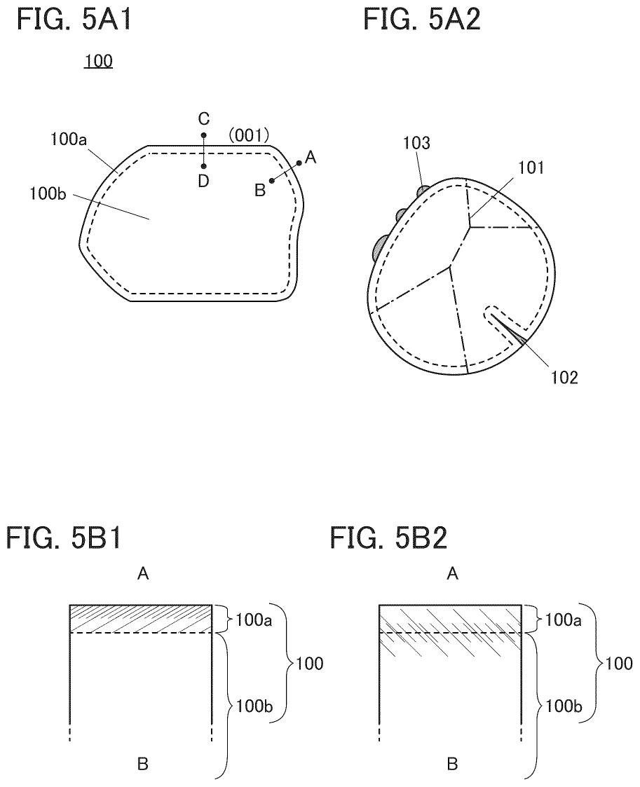

In this embodiment, a positive electrode active material that can be used in a lithium ion battery of one embodiment of the present invention (hereinafter, sometimes referred to as a “positive electrode active material that can be used as one embodiment of the present invention”) and a formation method thereof will be described with reference to FIG. 5 to FIG. 18. As described in Embodiment 1, any material can be used as the positive electrode active material that can be used in a lithium ion battery of one embodiment of the present invention as long as the material has less deterioration due to charging and discharging even when the charge voltage is high (even at high charge voltage). Thus, the positive electrode active material that can be used in a lithium ion battery disclosed in this specification and the like is not necessarily interpreted as being limited to specific materials described in this embodiment of and the like. A material known at the time of filing this application as a material with less deterioration due to charging and discharging even at a high charge voltage (e.g., 4.6 V or higher) can also be used.

### <Example of Positive Electrode Active Material>

An example of a positive electrode active material that can be used as one embodiment of the present invention is described below.

In this embodiment, a positive electrode active material 100 that can be used as one embodiment of the present invention is described with reference to FIG. 5 to FIG. 18.

FIG. 5A1 and FIG. 5A2 are each a cross-sectional view of the positive electrode active material 100 of one embodiment of the present invention. FIG. 5B1 and FIG. 5B2 show enlarged views of a portion near A-B in FIG. 5A.

As illustrated in FIG. 5A1, FIG. 5B1, and FIG. 5B2, the positive electrode active material 100 includes a surface portion 100a and an inner portion 100b. In each drawing, a dashed line denotes a boundary between the surface portion 100a and the inner portion 100b. In FIG. 5A2, a dashed-dotted line denotes part of a crystal grain boundary 101.

In this specification and the like, the surface portion 100a of the positive electrode active material 100 refers to a region that is within 50 nm, preferably within 35 nm, further preferably within 20 nm in depth from the surface toward the inner portion, and most preferably a region positioned within 10 nm in depth from the surface toward the inner portion. A plane generated by a split and/or a crack may also be referred to as a surface in this specification and the like. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

A surface of the positive electrode active material 100 refers to a surface of a composite oxide including the surface portion 100a, the inner portion 100b, a projection 103, and the like. Thus, the positive electrode active material 100 does not include a carbonate, a hydroxy group, or the like which is chemically adsorbed after formation of the positive electrode active material 100. Furthermore, an electrolyte, a binder, a conductive material, and a compound originating from any of these that are attached to the positive electrode active material 100 are not included either. The surface of the positive electrode active material 100 in, for example, a cross-sectional STEM (scanning transmission electron microscope) image is a boundary between a region where a bonding image of an electron is observed and a region where the image is not observed, and is determined as the outermost surface of a region where a bright spot derived from an atomic nucleus of a metal element that has a larger atomic number than lithium is observed. The surface in a cross-sectional STEM image or the like may be determined also on the basis of higher spatial-resolution analysis results, e.g., electron energy loss spectroscopy (EELS) analysis results.

The crystal grain boundary 101 refers to, for example, a portion where particles of the positive electrode active material 100 adhere to each other or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, i.e., a structure containing another atom between lattices, a cavity (void), or the like. The crystal grain boundary 101 can be regarded as one of plane defects. The vicinity of the crystal grain boundary 101 refers to a region within 20 nm (preferably within 15 nm, further preferably within 10 nm) from the crystal grain boundary 101.

### <Contained Element>

The positive electrode active material 100 contains lithium, cobalt, oxygen, and an additive element. The positive electrode active material 100 may contain lithium cobalt oxide (LiCoO₂) to which an additive element is added. Note that the positive electrode active material 100 described in this embodiment has a crystal structure to be described later. Thus, the composition of the lithium cobalt oxide is not strictly limited to Li:Co:O=1:1:2.

A positive electrode active material of a lithium ion battery needs to contain a transition metal which can undertake an oxidation-reduction reaction in order to maintain a neutrally charged state even when lithium ions are inserted and extracted. The positive electrode active material 100 of the lithium ion battery of one embodiment of the present invention preferably contains cobalt as a transition metal which undertakes as an oxidation-reduction reaction. Note that at least one of nickel and manganese may be contained in addition to cobalt. Using cobalt at greater than or equal to 75 at %, preferably higher than or equal to 90 at %, further preferably higher than or equal to 95 at % as the transition metal contained in the positive electrode active material 100 brings many advantages such as relatively easy synthesis, easy handling, and excellent cycling performance, which is preferable.

When cobalt is used as the transition metal contained in the positive electrode active material 100 at greater than or equal to 75 at %, preferably greater than or equal to 90 at %, further preferably greater than or equal to 95 at %, LiₓCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the orbital of the d transition metal. The influence of the Jahn-Teller effect is large in a composite oxide having a layered rock-salt crystal structure, such as lithium nickel oxide, in which octahedral coordinated low-spin nickel(III) accounts for the majority of the transition metal, and a layer having an octahedral structure formed of nickel and oxygen is likely to be distorted. Thus, there is a concern that the crystal structure might break in charge and discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

As the additive element contained in the positive electrode active material 100, one or two or more selected from magnesium, fluorine, nickel, aluminum, titanium, zirconium, vanadium, iron, manganese, chromium, niobium, arsenic, zinc, silicon, sulfur, phosphorus, boron, bromine, and beryllium is preferably used. Note that in the case where one or two or more transition metals are used as the additive element, the content of the transition metal as the additive element (in the case of using two or more transition metals, the total thereof) is preferably lower than 25 atomic %, further preferably lower than 10 atomic %, still further preferably lower than 5 atomic % when the total amount of the transition metal contained in the positive electrode active material 100 is set to 100 atomic %.

As a specific example, the positive electrode active material 100 can contain lithium cobalt oxide to which magnesium and fluorine are added; lithium cobalt oxide to which magnesium, fluorine, and titanium are added; lithium cobalt oxide to which magnesium, fluorine, and aluminum are added; lithium cobalt oxide to which magnesium, fluorine, and nickel are added; lithium cobalt oxide to which magnesium, fluorine, nickel, and aluminum are added; or the like.

Including such an additive element brings an effect of stabilizing a crystal structure of the positive electrode active material 100 described later. In this specification and the like, the additive element may be a mixture or part of a raw material.

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

When the positive electrode active material 100 does not substantially contain manganese, for example, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example. Note that in this specification and the like, “not substantially contain” refers to the case where an object is contained to such an extent that the presence or absence of operation effect is not affected even when the amount of objects measured with an analysis means is lower than or equal to the lower detection limit or the amount of objects comparable to the lower detection limit is contained.

### <Crystal Structure>

«x in LiₓCoO₂ being 1»

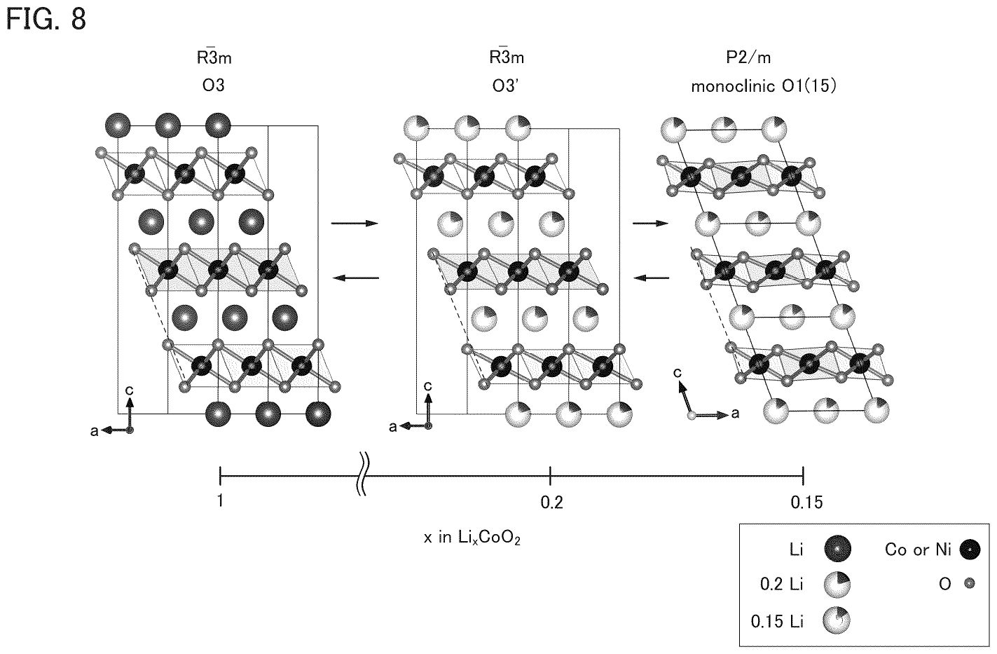

The positive electrode active material 100 that can be used as one embodiment of the present invention preferably has a layered rock-salt crystal structure belonging to the space group R-3m in a discharged state, i.e., a state where x in LiₓCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure. In FIG. 8, the layered rock-salt crystal structure is denoted by R-3m (O3).

Meanwhile, the surface portion 100a of the positive electrode active material 100 that can be used as one embodiment of the present invention preferably has a function of reinforcing the layered structure, which is formed of octahedrons of cobalt and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100b of the positive electrode active material 100 such as extraction of oxygen and/or inhibition of oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 that can be used as one embodiment of the present invention preferably has the rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted initially in charging, and is a region that tends to have a lower concentration of lithium than the inner portion 100b. Bonds between atoms are regarded as being partly cut on the surface of the positive electrode active material 100 included in the surface portion 100a. Thus, the surface portion 100a is regarded as a region that tends to be unstable and easily starts deterioration of the crystal structure. Meanwhile, when the surface portion 100a can be made sufficiently stable, the layered structure, which is formed of octahedrons of cobalt and oxygen, of the inner portion 100b is unlikely to be broken even with small x in LiₓCoO₂, e.g., with x of less than or equal to 0.24. Furthermore, a shift in layers, which are formed of octahedrons of cobalt and oxygen, of the inner portion 100b can be inhibited.

In order that the surface portion 100a can have a stable composition and a stable crystal structure, the surface portion 100a preferably contains an additive element, further preferably contains a plurality of additive elements. The surface portion 100a preferably has a higher concentration of one or more selected from the additive elements than the inner portion 100b. The one or more selected from the additive elements contained in the positive electrode active material 100 preferably have a concentration gradient. In addition, it is further preferable that the additive elements contained in the positive electrode active material 100 be differently distributed. For example, it is further preferable that the additive elements exhibit concentration peaks at different depths from a surface. The concentration peak here refers to the local maximum value of the concentration in the surface portion 100a or the concentration in a region from the surface to a depth of 50 nm or less.

For example, as shown in FIG. 5B1 by gradation, some of the additive elements such as magnesium, fluorine, nickel, titanium, silicon, phosphorus, boron, and calcium preferably have a concentration gradient in which the concentration increases from the inner portion 100b toward the surface. In this specification and the like, these additive elements are referred to as an additive element X.

Another additive element such as aluminum or manganese preferably has a concentration gradient as shown in FIG. 5B2 by gradation and/or exhibits a concentration peak in a deeper region than the additive element X. The concentration peak may be located in the surface portion 100a or located deeper than the surface portion 100a. For example, the concentration peak is preferably located in a region, extending from the surface toward the inner portion, at a depth of 5 nm to 50 nm inclusive. In this specification and the like, such an additive element is referred to as additive elements Y.

A magnesium ion, which is one of the additive elements X, for example is divalent, and the magnesium ion is more stable in lithium sites than in cobalt sites in the layered rock-salt crystal structure and thus is likely to enter the lithium sites. An appropriate concentration of magnesium in the lithium sites of the surface portion 100a can facilitate maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high concentration of magnesium in the surface portion 100a probably increases the corrosion resistance to hydrofluoric acid generated by the decomposition of the electrolyte solution.

An appropriate concentration of magnesium does not have an adverse effect on insertion and extraction of lithium in charging and discharging, and the above-described advantages can be obtained. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide or a fluoride) which is substituted for neither the lithium site nor the cobalt site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. For example, the number of magnesium atoms is preferably greater than or equal to 0.001 times and less than or equal to 0.1 times, further preferably greater than 0.01 times and less than 0.04 times, still further preferably approximately 0.02 times the number of cobalt atoms. The amount of magnesium contained in the entire positive electrode active material 100 here may be a value obtained by element analysis on the entire positive electrode active material 100 using GD-MS (glow discharge mass spectrometry), ICP-MS (inductively coupled plasma mass spectrometry), or the like, or may be a value based on the ratio of the raw materials mixed in the formation process of the positive electrode active material 100, for example.

Nickel, which is one of the additive elements X, can exist in both the cobalt site and the lithium site. Nickel preferably exists in the cobalt site because an oxidation-reduction potential can be lower than the case of cobalt, leading to an increase in discharge capacity.

In addition, when nickel is present in lithium sites, a shift in the layered structure formed of octahedrons of cobalt and oxygen can be inhibited. Moreover, a change in volume in charging and discharging is inhibited. Furthermore, an elastic modulus becomes large, i.e., hardness increases. This is probably because nickel in the lithium sites serves as a column supporting the CoO₂ layers. Thus, in particular, the crystal structure is expected to be more stable in a charged state at high temperatures, e.g., 45° C. or higher, which is preferable.

Meanwhile, excess nickel is not preferable because increasing the influence of distortion due to the Jahn-Teller effect. Moreover, excess nickel might adversely affect insertion and extraction of lithium.

Thus, the entire positive electrode active material 100 preferably contains an appropriate amount of nickel. For example, the number of nickel atoms contained in the positive electrode active material 100 is preferably greater than 0% and less than 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than 7.5%. Alternatively, it is preferably greater than or equal to 0.05% and less than or equal to 2%. Alternatively, it is preferably greater than or equal to 0.1% and less than 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials mixed in the process of forming the positive electrode active material, for example.

Aluminum, which is one of additive elements Y, can exist in the cobalt site in a layered rock-salt crystal structure. Since aluminum is a trivalent representative element and its valence does not change, lithium around aluminum is unlikely to move even in charging and discharging. Thus, aluminum and lithium therearound serve as columns to inhibit a change in the crystal structure. Furthermore, aluminum has effects of inhibiting elution of cobalt around aluminum and improving continuous charge tolerance. Moreover, an Al—O bond is stronger than a Co—O bond and thus extraction of oxygen around aluminum can be inhibited. These effects improve thermal stability. Thus, a secondary battery that includes the positive electrode active material 100 containing aluminum as the additive element can have higher level of safety. Furthermore, the positive electrode active material 100 can have a crystal structure that is unlikely to be broken even with repeated charging and discharging. Moreover, it is preferable that aluminum exist at a position slightly deeper than the outermost surface (specifically, the concentration peak of aluminum is positioned in a region deeper than a region of the concentration peak of the additive element X). Alternatively, it is preferable that the presence of aluminum be observed in a region deeper than a deepest region, from the outermost surface, where the presence of the additive element X is observed, and that the deepest region from the outermost surface exist. This is because when aluminum is substituted for lithium sites, lithium existing near the lithium sites for which aluminum is substituted is also fixed; aluminum existing at the outermost surface might block the diffusion path of lithium more than the additive element X.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

Fluorine, which is an example of the additive element X, is a monovalent anion; when fluorine is substituted for part of oxygen in the surface portion 100a, the lithium extraction energy is lowered. This is because the change in valence of cobalt ions associated with lithium extraction is from trivalent to tetravalent in the case of not containing fluorine and is from divalent to trivalent in the case of containing fluorine, and the oxidation-reduction potentials in these cases differ from each other. It can thus be said that when fluorine is substituted for part of oxygen in the surface portion 100a of the positive electrode active material 100, lithium ions near fluorine are likely to be extracted and inserted smoothly. Thus, a secondary battery including the positive electrode active material 100 can have improved charge and discharge characteristics, improved large current characteristics, or the like. When fluorine is present in the surface portion 100a, which has a surface in contact with the electrolyte solution, the corrosion resistance to hydrofluoric acid can be effectively increased. As will be described in the following embodiment, a fluoride such as lithium fluoride that has a lower melting point than another additive element source can serve as a fusing agent (also referred to as a flux) for lowering the melting point of the another additive element source.

An oxide of titanium, which is an example of the additive element X, is known to have superhydrophilicity. Accordingly, the positive electrode active material 100 that contains titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

When the surface portion 100a contains phosphorus, which is an example of the additive element X, a short circuit can be inhibited while a state with small x in LiₓCoO₂ is maintained, in some cases, which is preferable. For example, a compound containing phosphorus and oxygen preferably exists in the surface portion 100a.

The positive electrode active material 100 preferably contains phosphorus, in which case the phosphorus reacts with hydrogen fluoride generated by the decomposition of the electrolyte, which can decrease the hydrogen fluoride concentration in the electrolyte.

In the case where the electrolyte contains LiPF₆, hydrogen fluoride might be generated by hydrolysis. In some cases, hydrogen fluoride might be generated by the reaction of polyvinylidene fluoride (PVDF) used as a component of the positive electrode and alkali. The decrease in hydrogen fluoride concentration in the electrolyte can inhibit corrosion of a current collector and/or separation of a coating film 104 in some cases. Furthermore, the decrease in hydrogen fluoride concentration in the electrolyte can inhibit a reduction in adhesion properties due to gelling and/or insolubilization of PVDF in some cases.

The positive electrode active material 100 preferably contains magnesium and phosphorus, in which case the stability in a state with small x in LiₓCoO₂ is extremely high. In the case where the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The concentrations of phosphorus and magnesium described here may each be a value obtained by element analysis on the entire positive electrode active material 100 by GC-MS, ICP-MS, or the like, or may be a value based on the ratio of the raw materials mixed in the formation process of the positive electrode active material 100, for example.

In the case where the positive electrode active material 100 has a crack, crack development can be inhibited by phosphorus, more specifically, a compound containing phosphorus and oxygen, for example, being in the inner portion of the positive electrode active material having the crack on its surface, e.g., a filling portion 102.

In the case where the surface portion 100a contains both magnesium and nickel, divalent magnesium might be able to be present more stably in the vicinity of divalent nickel. Thus, elution of magnesium might be inhibited even when x in LiₓCoO₂ is small. This can contribute to stabilization of the surface portion 100a.

Additive elements that are differently distributed, such as the additive element X and the additive element Y, are preferably contained at a time, in which case the crystal structure of a wider region can be stabilized. For example, in the case where the positive electrode active material 100 contains magnesium and nickel, which are examples of the additive element X, and contains aluminum, which is an example of the additive element Y, the crystal structure of a wider region can be stabilized as compared with the case where only the additive element X or the additive element Y is contained. In the case where the positive electrode active material 100 contains both the additive element X and the additive element Y as described above, the surface can be sufficiently stabilized by the additive element X such as magnesium and nickel; thus, the additive element Y such as aluminum is not necessary for the surface. It is preferable that aluminum be widely distributed in a deep region, for example, a region that is 5 nm to 50 nm in depth from the surface, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained because a high effect of stabilizing the composition and crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, the surface portion 100a preferably contains at least cobalt, also contain lithium in a discharged state, and have the path through which lithium is inserted and extracted.

To ensure the sufficient path through which lithium is inserted and extracted, the concentration of cobalt is preferably higher than that of magnesium in the surface portion 100a. For example, the ratio of the number of magnesium (Mg) atoms to the number of cobalt (Co) atoms (Mg/Co) is preferably less than or equal to 0.62. Alternatively, the concentration of cobalt is preferably higher than that of nickel in the surface portion 100a. Alternatively, the concentration of cobalt is preferably higher than that of aluminum in the surface portion 100a. Alternatively, the concentration of cobalt is higher than that of fluorine in the surface portion 100a.

Moreover, excess nickel might hinder diffusion of lithium; thus, the concentration of magnesium is preferably higher than that of nickel in the surface portion 100a. For example, the number of nickel atoms is preferably ⅙ or less that of magnesium atoms.

It is preferable that some additive elements, in particular, magnesium, nickel, and aluminum have higher concentrations in the surface portion 100a than in the inner portion 100b and exist randomly also in the inner portion 100b to have low concentrations. When magnesium and aluminum exist in the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are contained, a synergistic effect of suppressing elution of magnesium can be expected in a manner similar to the above.

It is preferable that the crystal structure continuously change from the inner portion 100b toward the surface owing to the above-described concentration gradient of the additive element. Alternatively, it is preferable that the surface portion 100a and the inner portion 100b have the same or substantially the same crystal orientation. Alternatively, it is preferable that the surface portion 100a and the inner portion 100b be topotaxy.

In this specification and the like, topotaxy refers to having similarity in a three-dimensional structure such that crystal orientations are substantially aligned with each other, or to having the same orientations crystallographically. Epitaxy refers to similarity in structures of two-dimensional interfaces.

By the surface portion 100a and the inner portion 100b being topotaxy, distortion in a crystal structure and/or shift in atomic arrangement of crystal structure can be reduced. This can prevent the cause of a pit. Note that in this specification and the like, a pit refers to a hole formed by progress of a defect in a positive electrode active material.

For example, a crystal structure preferably changes continuously from the layered rock-salt inner portion 100b toward the surface and the surface portion 100a that have a rock-salt structure or have features of both a rock-salt structure and a layered rock-salt structure. Alternatively, the crystal orientations of the surface portion 100a with a rock-salt structure or features of both a rock-salt structure and a layered rock-salt structure are preferably substantially aligned with that of the layered rock-salt inner portion 100b.

In this specification and the like, a layered rock-salt crystal structure, which belongs to the space group R-3m, of a composite oxide containing lithium and the transition metal such as cobalt refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may be included.

Having features of both a layered rock-salt crystal structure and a rock-salt crystal structure can be judged by electron diffraction, a TEM image, a cross-sectional STEM image, and the like.

There is no distinction among cation sites in a rock-salt structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt structure and a layered rock-salt structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, for instance, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt structure and the layered rock-salt structure has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a lager atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ crystal and a monoclinic O1(15) crystal described later are presumed to form a cubic close-packed structure. Thus, when a layered rock-salt crystal and a rock-salt crystal are in contact with each other, there is a crystal plane at which orientations of cubic closest packed structures composed of anions are aligned with each other.

The description can also be made as follows. Anions on the {111} plane of a cubic crystal structure have a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the {111} plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that the space groups of the layered rock-salt crystal and the O3′ type crystal are R-3m, which is different from the space group Fm-3m (the space group of a general rock-salt crystal) of the rock-salt crystal; thus, the Miller index of the crystal plane satisfying the above conditions in the layered rock-salt crystal and the O3′ type crystal is different from that in the rock-salt crystal. In this specification and the like, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases.

The crystal orientations in two regions being substantially aligned with each other can be determined, for example, from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron microscope) image, an electron diffraction pattern, and an FFT pattern of a TEM image, a STEM image, and the like. XRD (X-ray Diffraction), electron diffraction, neutron diffraction, and the like can also be used for judging.

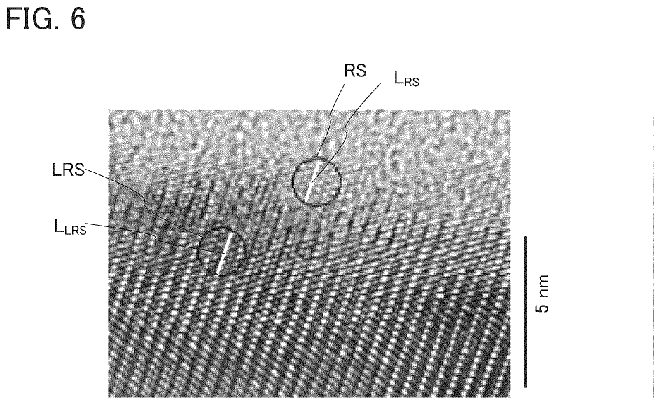

FIG. 6 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 6) is 5° or less or 2.5° or less in the TEM image, it can be judged that the crystal planes are substantially aligned with each other, that is, orientations of the crystals are substantially aligned with each other. Similarly, when the angle between the dark lines is 5° or less or 2.5° or less, it can be judged that orientations of the crystals are substantially aligned with each other.

In a HAADF-STEM image, a contrast proportional to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed in the direction perpendicular to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are contained as the additive elements of the lithium cobalt oxide.

Consequently, in the case where repetition of bright lines and dark lines is observed in two regions having different crystal structures and the angle between the bright lines is 5° or less or 2.5° or less in a HAADF-STEM image, it can be judged that arrangements of the atoms are substantially aligned with each other, that is, orientations of the crystals are substantially aligned with each other. Similarly, when the angle between the dark lines is 5° or less or 2.5° or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

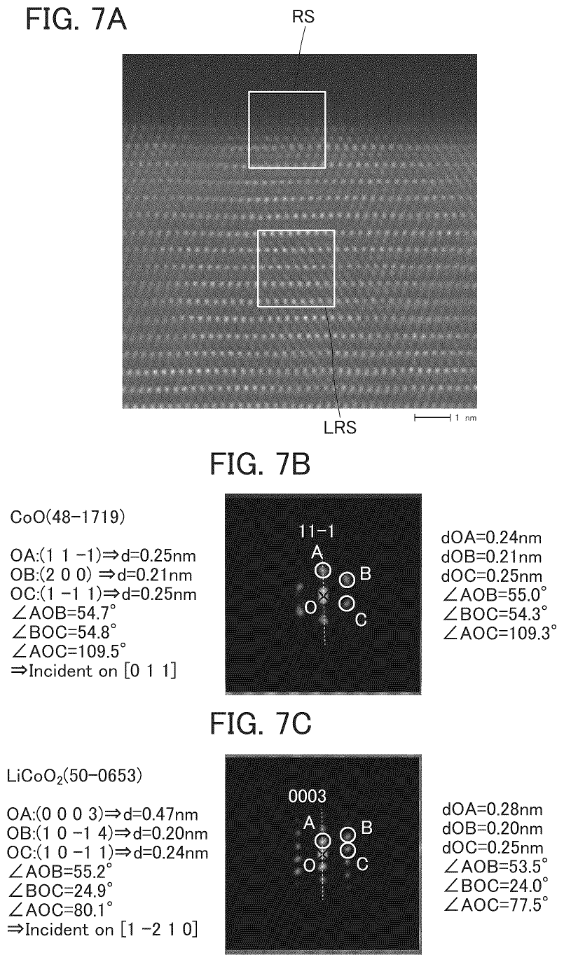

FIG. 7A shows an example of a STEM image in which orientations of the layered rock-salt crystal LRS and the rock-salt crystal RS are substantially aligned with each other. FIG. 7B shows an FFT pattern of a region of the rock-salt crystal RS, and FIG. 7C shows an FFT pattern of a region of the layered rock-salt crystal LRS. In FIG. 7B and FIG. 7C, the composition, the JCPDS card number, and d values and angles to be calculated are shown on the left. The measured values are shown on the right. A spot denoted by O is zero-order diffraction.

A spot denoted by A in FIG. 7B is derived from 11-1 reflection of a cubic structure. A spot denoted by A in FIG. 7C is derived from 0003 reflection of a layered rock-salt structure. It is found from FIG. 7B and FIG. 7C that the direction of the 11-1 reflection of the cubic structure and the direction of the 0003 reflection of the layered rock-salt structure are substantially aligned with each other. That is, a straight line that passes through AO in FIG. 7B is substantially parallel to a straight line that passes through AO in FIG. 7C. Here, the terms “substantially aligned” and “substantially parallel” mean that the angle between the two is 5° or less or 2.5° or less.

When the orientations of the layered rock-salt crystal and the rock-salt crystal are substantially aligned with each other in the above manner in FFT pattern and electron diffraction pattern, the <0003> orientation of the layered rock-salt crystal and the <11-1> orientation of the rock-salt crystal may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 7C is derived from 1014 reflection of the layered rock-salt structure. This is sometimes observed at a position where the difference in orientation from the reciprocal lattice point derived from the 0003 reflection of the layered rock-salt crystal structure (A in FIG. 7C) is greater than or equal to 52° and less than or equal to 56°(i.e., ∠AOB is greater than or equal to 52° and less than or equal to 56°) and d is greater than or equal to 0.19 nm and less than or equal to 0.21 nm. Note that these indices are just an example, and the spot does not necessarily correspond with them. For example, the spot may be a reciprocal lattice point equivalent to the indices.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 7B is derived from 200 reflection of the cubic structure. This diffraction spot is sometimes observed at a position where the difference in orientation of reflection derived from the 11-1 reflection of the cubic structure (A in FIG. 7B) is greater than or equal to 54° and less than or equal to 56° (i.e., ∠AOB is greater than or equal to 54° and less than or equal to 56°). Note that these indices are just an example, and the spot does not necessarily correspond with them. For example, the spot may be a reciprocal lattice point equivalent to the indices.

It is known that in a positive electrode active material with a layered rock-salt crystal structure, such as lithium cobalt oxide, the (0003) plane and a plane equivalent thereto and the (10-14) plane and a plane equivalent thereto are likely to be crystal planes. Thus, a sample to be observed can be processed to be thin by FIB or the like such that an electron beam of a TEM, for example, enters in [12-10], in order to easily observe the (0003) plane in careful observation of the shape of the positive electrode active material with a SEM or the like. To judge whether crystal orientations are aligned, a sample is preferably processed to be thin so that the (0003) plane of the layered rock-salt structure is easily observed.

«State where x in LiₓCoO₂ is Small»

The crystal structure in a state where x in LiₓCoO₂ is small of the positive electrode active material 100 that can be used as one embodiment of the present invention is different from that of a conventional positive electrode active material because the positive electrode active material 100 has the above-described additive element distribution and/or crystal structure in a discharged state. Note that in this specification and the like, “x is small” means that 0.1<x≤0.24.

On the basis of comparison between a conventional positive electrode active material and the positive electrode active material 100 that can be used as one embodiment of the present invention, changes in crystal structures owing to a change in x in LiₓCoO₂ will be described with reference to FIG. 8 to FIG. 12.

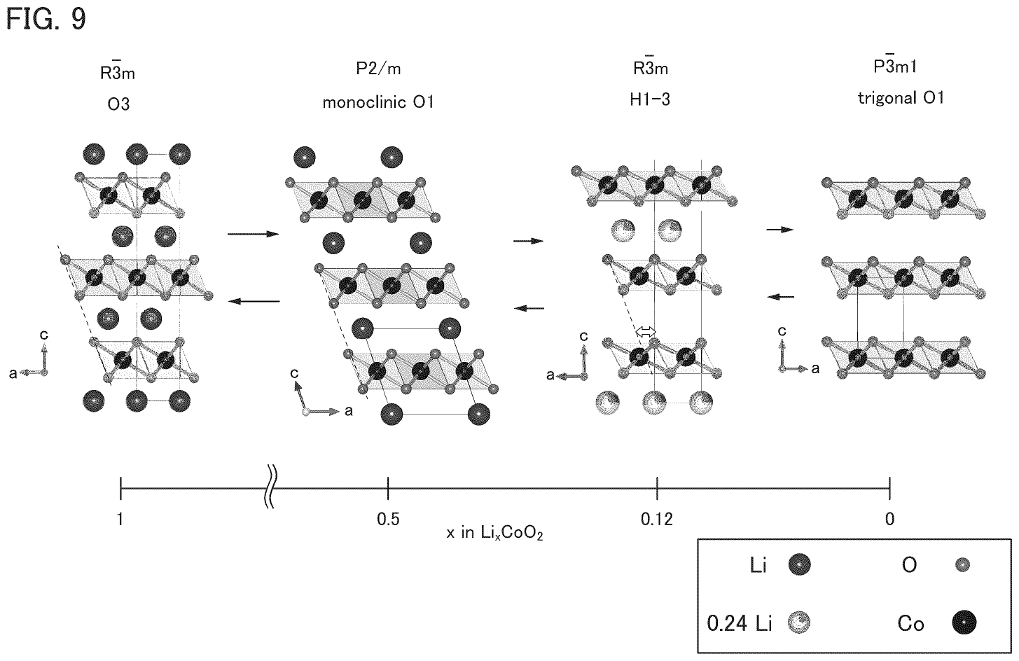

A change in the crystal structure of the conventional positive electrode active material is illustrated in FIG. 9. The conventional positive electrode active material shown in FIG. 9 is lithium cobalt oxide (LiCoO₂) without an additive element in particular. Note that in this specification and the like, “without an additive element in particular” refers to the case where the additive element is contained to such an extent that the presence or absence of operation effect is not affected even when the amount of additive elements measured with an analysis means is lower than or equal to the lower detection limit or the amount of additive elements comparable to the lower detection limit is contained.

In FIG. 9, the crystal structure of lithium cobalt oxide with x in LiₓCoO₂ of 1 is denoted by R-3m (O3). In this crystal structure, lithium occupies octahedral sites and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3 ml and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal O1 type structures and LiCoO₂ structures such as R-3m (O3) are alternately stacked. Thus, this crystal structure is referred to as an H1-3 type crystal structure in some cases. The number of cobalt atoms per unit cell in the actual H1-3 type crystal structure is twice that in other structures. However, in this specification and the like, FIG. 9, and other drawings, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O1 and O2 are each an oxygen atom. A unit cell that should be used for representing a crystal structure in a positive electrode active material can be judged by the Rietveld analysis of XRD patterns, for example. In this case, a unit cell is selected such that the value of GOF (goodness of fit) is small.

When charging that makes x in LiₓCoO₂ be 0.12 or less and discharging are repeated, the crystal structure of conventional lithium cobalt oxide repeatedly changes between the R-3m (O3) type crystal structure in a discharged state and the H1-3 type crystal structure (i.e., an unbalanced phase change).

However, there is a large shift in the CoO₂ layers between these two crystal structures. As denoted by the dotted lines and the arrow in FIG. 9, the CoO₂ layer in the H1-3 type crystal structure largely shifts from R-3m (O3) in a discharged state. Such a dynamic structural change can adversely affect the stability of the crystal structure.

A difference in volume between these two crystal structures is also large. The difference in volume per the same number of cobalt atoms between the R-3m (O3) type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.12 or less and discharging are repeated, the crystal structure of conventional lithium cobalt oxide is gradually broken. The broken crystal structure triggers deterioration of the cycle performance. This is because the broken crystal structure has a smaller number of sites where lithium can exist stably and makes it difficult to insert and extract lithium. Note that the breakdown of the crystal structure frequently occurs not only when charging that makes x be 0.12 or less and discharging are repeated but also when x is actually 0.24 or less, causing the degradation of cycle performance. Thus, the conventional lithium cobalt oxide is controlled in such a range that charging that makes x exceed 0.24 and discharging are repeated in practical use.

On the other hand, in the positive electrode active material 100 that can be used as one embodiment of the present invention shown in FIG. 8, a change in the crystal structure between a discharged state with x in LiₓCoO₂ being 1 and a state with x being 0.24 or less is smaller than that in the conventional positive electrode active material. Specifically, a shift in the CoO₂ layers between the state with x being 1 and the state with x being 0.24 or less can be small. Furthermore, a change in the volume can be small in the case where the positive electrode active materials have the same number of cobalt atoms. Thus, the positive electrode active material 100 that can be used as one embodiment of the present invention can have a crystal structure that is difficult to break even when charging that makes x be 0.24 or less and discharging are repeated, and enables excellent cycle performance. In addition, the positive electrode active material 100 that can be used as one embodiment of the present invention with x in LiₓCoO₂ being 0.24 or less can have a more stable crystal structure than the conventional positive electrode active material. Thus, in the case where the state with x in LiₓCoO₂ of 0.24 or less is maintained in the positive electrode active material 100 that can be used as one embodiment of the present invention, a short circuit is less likely to occur and the safety of the lithium ion battery is improved.

FIG. 8 shows crystal structures of the inner portion 100b of the positive electrode active material 100 in a state where x in LiₓCoO₂ is approximately 1, in a state where x in LiₓCoO₂ is approximately 0.2, and in a state where x in LiₓCoO₂ is approximately 0.15. The inner portion 100b, accounting for the majority of the volume of the positive electrode active material 100, largely contributes to charging and discharging and is accordingly a portion where a shift in CoO₂ layers and a volume change matter most.

The positive electrode active material 100 with x being 1 has the R-3m (O3) type crystal structure, which is the same as that of the conventional lithium cobalt oxide.

Meanwhile, the positive electrode active material 100 with x being 0.24 or less, e.g., approximately 0.2 and approximately 0.15, has a crystal structure different from the H1-3 type crystal structure of the conventional lithium cobalt oxide.

Specifically, the positive electrode active material 100 with x being approximately 0.2 has a trigonal crystal structure belonging to the space group R-3m. The symmetry of the CoO₂ layers of this structure is the same as that of O3. Thus, this crystal structure is called an O3′ type crystal structure. In FIG. 8, this crystal structure is denoted by R-3m (O3)′.

In the unit cell of the O3′ type crystal structure, the coordinates of cobalt and oxygen can be represented as follows: Co (0, 0, 0.5) and O (0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.68≤c≤13.88 (×10⁻¹ nm), further preferably 13.75≤c≤13.81, typically c=13.78 (×10⁻¹ nm).

When in a charged state with x in LiₓCoO₂ being greater than 0.1 and less than or equal to 0.24, typically 0.15, the positive electrode active material 100 has a monoclinic crystal structure belonging to the space group P2/m. This structure includes one CoO₂ layer in a unit cell. Here, lithium in the positive electrode active material 100 is approximately 15 atomic % of that in a discharged state. Thus, this crystal structure is referred to as a “monoclinic O1(15) type crystal structure” in this specification and the like. In FIG. 8, this crystal structure is denoted by P2/m monoclinic O1(15).

In the monoclinic O1(15) type crystal structure, the coordinates of cobalt and oxygen in a unit cell can be represented by Co1 (0.5, 0, 0.5), Co2 (0, 0.5, 0.5), O1 (X_{O1}, 0, Z_{O1}) within the range of 0.23≤X_{O1}≤0.24 and 0.61≤Z_{O1}≤0.65, and O2 (X_{O2}, 0.5, Z_{O2}) within the range of 0.75≤X_{O2}≤0.78 and 0.68≤Z_{O2}≤0.71. The unit cell has lattice constants such that a=4.880±0.05 (×10⁻¹ nm), b=2.817±0.05 (×10⁻¹ nm), c=4.839±0.05 (×10⁻¹ nm), α=90°, β=109.6±0.1°, and γ=90°.

Note that this crystal structure can be fitted even when belonging to the space group R-3m if a certain range of error is allowed. The coordinates of cobalt and oxygen in the unit cell in this case can be represented by Co (0, 0, 0.5) and O (0, 0, Z_{O}) within the range of 0.21≤Z_{O}≤0.23. The unit cell has lattice constants such that a=2.817±0.02 (×10⁻¹ nm) and c=13.68±0.1 (×10⁻¹ nm).

In both of the O3′ type crystal structure and the monoclinic O1(15) type crystal structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 8, the CoO₂ layers hardly shift between the R-3m (O3) in a discharged state, the O3′ type crystal structure, and the monoclinic O1(15) type crystal structure.

The R-3m (O3) type crystal structure in a discharged state and the O3′ type crystal structure which contain the same number of cobalt atoms have a difference in volume of 2.5% or less, specifically 2.2% or less, typically 1.8%.

The R-3m (O3) type crystal structure in a discharged state and the monoclinic O1(15) type crystal structure which contain the same number of cobalt atoms have a difference in volume of 3.3% or less, specifically 3.0% or less, typically 2.5%.

Table 1 shows a difference in volume per cobalt atom between the R-3m (O3) type structure in a discharged state, the O3′ type structure, the monoclinic O1(15) type structure, the H1-3 type structure, and the trigonal O1 type structure. For the lattice constants of the crystal structures used for calculation in Table 1, the literature values (ICSD coll. code. 172909 and 88721) and Non-Patent Document can be referred to in the case of the R-3m O3 type structure in a discharged state, the trigonal O1 type structure, and the H1-3 type structure. In the case of the O3′ type structure and the monoclinic O1(15) type structure, the lattice constants thereof can be calculated from the experimental values of XRD.

TABLE 1

| | Lattice constant | | | | Volume of | Volume per | Volume change |
|---|---|---|---|---|---|---|---|
| Crystal structure | a (Å) | b (Å) | c (Å) | β (°) | unit cell (Å³) | Co (Å³) | percentage (%) |
| R-3m O3 | 2.8156 | 2.8156 | 14.0542 | 90 | 96.49 | 32.16 | — |
| (LiCoO₂) | | | | | | | |
| O3′ | 2.818 | 2.818 | 13.78 | 90 | 94.76 | 31.59 | 1.8 |
| Monoclinic O1(15) | 4.881 | 2.817 | 4.839 | 109.6 | 62.69 | 31.35 | 2.5 |
| H1-3 | 2.82 | 2.82 | 26.92 | 90 | 185.4 | 30.90 | 3.9 |
| Trigonal O1 | 2.8048 | 2.8048 | 4.2509 | 90 | 28.96 | 28.96 | 10.0 |
| (CoO_{1.92}) | | | | | | | |

As described above, in the positive electrode active material 100 that can be used as one embodiment of the present invention, a change in the crystal structure caused when x in LiₓCoO₂ is small, i.e., when a large amount of lithium is extracted, is smaller than that in the conventional positive electrode active material. In addition, a change in the volume between the compared structures having the same number of cobalt atoms is inhibited. Thus, the crystal structure of the positive electrode active material 100 is less likely to be broken even when charging that makes x be 0.24 or less and discharging are repeated, so that a decrease in charge and discharge capacity of the positive electrode active material 100 in charge and discharge cycles is inhibited. Furthermore, the positive electrode active material 100 can stably use a larger amount of lithium than the conventional positive electrode active material and thus has high discharge capacity per weight and per volume. Thus, with use of the positive electrode active material 100, a secondary battery with high discharge capacity per weight and per volume can be fabricated.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. In addition, the positive electrode active material 100 is confirmed to have the monoclinic O1(15) type crystal structure in some cases when x in LiₓCoO₂ is greater than 0.1 and less than or equal to 0.2, typically greater than or equal to 0.15 and less than or equal to 0.17. However, the crystal structure is influenced by not only x in LiₓCoO₂ but also the number of charge and discharge cycles, a charge current and a discharge current, temperature, an electrolyte, and the like, so that the range of x is not limited to the above.

Thus, when x in LiₓCoO₂ is greater than 0.1 and less than or equal to 0.24, the positive electrode active material 100 may have only the O3′ type crystal structure, only the monoclinic O1(15) type crystal structure, or both of them. Not all particles in the inner portion 100b of the positive electrode active material 100 necessarily has the O3′ type crystal structure and/or the monoclinic O1(15) type crystal structure. The particles may have another crystal structure or may be partly amorphous.

In order to make x in LiₓCoO₂ small, charging with a high charge voltage is necessary in general. Thus, the state where x in LiₓCoO₂ is small can be rephrased as a state where charging with a high charge voltage has been performed. For example, when CC/CV (constant current/constant voltage) charging is performed at 25° C. and 4.6 V or higher with reference to the potential of a lithium metal, the H1-3 type crystal structure appears in a conventional positive electrode active material. Thus, a charge voltage of 4.6 V or higher can be regarded as a high charge voltage with reference to the potential of a lithium metal. In this specification and the like, unless otherwise specified, a charge voltage is shown with reference to the potential of a lithium metal.

Thus, the positive electrode active material 100 that can be used as one embodiment of the present invention is preferable because the crystal structure with the symmetry of R-3m (O3) can be maintained even when charging with a high charge voltage of 4.6 V or higher is performed at 25° C., for example. Moreover, the positive electrode active material 100 of one embodiment of the present invention is preferable because the O3′ type crystal structure can be obtained when charging with a higher charge voltage, e.g., a voltage higher than or equal to 4.65 V and lower than or equal to 4.7 V is performed at 25° C. Furthermore, the positive electrode active material 100 of one embodiment of the present invention is preferable because the monoclinic O1(15) type crystal structure can be obtained when charging at a much higher charge voltage, e.g., a voltage higher than 4.7 V and lower than or equal to 4.8 V is performed at 25° C.

In the positive electrode active material 100, when the charge voltage is increased, the H1-3 type crystal structure is eventually observed in some cases. As described above, the crystal structure is influenced by the number of charge and discharge cycles, a charge current and a discharge current, temperature, an electrolyte, and the like, so that the positive electrode active material 100 that can be used as one embodiment of the present invention sometimes has the O3′ type crystal structure even at a lower charge voltage, e.g., a charge voltage of higher than or equal to 4.5 V and lower than 4.6 V at 25° C. Similarly, the positive electrode active material 100 may sometimes have the monoclinic O1(15) type crystal structure at a charge voltage higher than or equal to 4.65 V and lower than or equal to 4.7 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in O3′ and monoclinic O1(15) in FIG. 8, one embodiment of the present invention is not limited thereto. Lithium may exist unevenly in only some of the lithium sites; for example, lithium may symmetrically exist as in the monoclinic O1 (Li_{0.5}CoO₂) shown in FIG. 9. Distribution of lithium can be analyzed by neutron diffraction, for example.

The O3′ type crystal structure and the monoclinic O1(15) structure can be regarded as a crystal structure that contains lithium between layers randomly but is similar to a CdCl₂ type crystal structure. The crystal structure similar to the CdCl₂ type crystal structure is close to a crystal structure of lithium nickel oxide when charged up to a charge depth of Li_{0.06}NiO₂; however, pure lithium cobalt oxide or a layered rock-salt positive electrode active material containing a large amount of cobalt is known not to have the CdCl₂ type crystal structure in general.

The additive element concentration gradient is preferably similar in a plurality of portions of the surface portion 100a of the positive electrode active material 100. In other words, it is preferable that a barrier film derived from the additive element be uniformly formed in the surface portion 100a. When the surface portion 100a partly has a barrier film, stress might be concentrated on parts that do not have a barrier film. The concentration of stress on part of the positive electrode active material 100 might cause defects such as cracks from that part, leading to breakage of the positive electrode active material and a decrease in charge and discharge capacity.

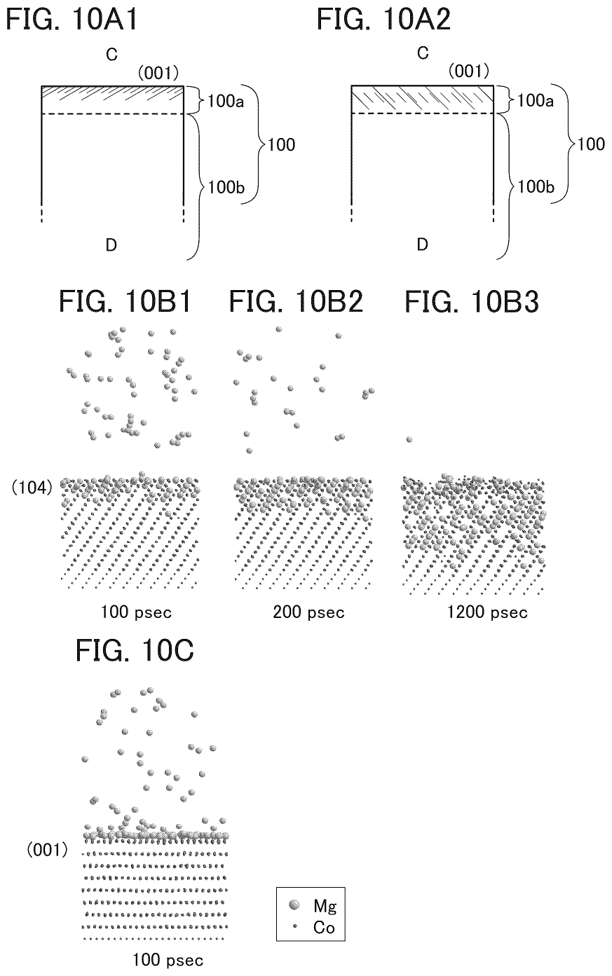

Note that the additive elements do not necessarily have similar concentration gradients throughout the surface portion 100a of the positive electrode active material 100. FIG. 10A1 and FIG. 10A2 illustrate enlarged views of a portion near the line C-D in FIG. 5A1. For example, FIG. 10A1 shows an example of distribution of the additive element X in the portion in the vicinity of C-D in FIG. 5A1 and FIG. 10A2 shows an example of distribution of the additive element Yin the portion in the vicinity of the line C-D.

Here, the portion near the line C-D has a layered rock-salt crystal structure belonging to R-3m and the surface of the portion has a (001) orientation. The distribution of the additive element at the surface having a (001) orientation may be different from that at other surfaces. For example, the surface having a (001) orientation and the surface portion 100a thereof may have limited distribution of concentration peaks, which are one or two or more selected from the additive elements X and the additive elements Y, in a shallow portion from the surface as compared to the surface having an orientation other than a (001) orientation. Alternatively, the surface with a (001) orientation and the surface portion 100a thereof may have a lower concentration of one or two or more selected from the additive elements X and the additive elements Y than a surface having an orientation other than a (001) orientation. Further alternatively, at the surface with a (001) orientation and the surface portion 100a thereof, one or two or more elements selected from the additive elements X and the additive element Y may be below the lower detection limit.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions also exists parallel to a (001) plane.

The CoO₂ layer is relatively stable and thus, the surface of the positive electrode active material 100 is more stable when having a (001) orientation. A main diffusion path of lithium ions in charging and discharging is not exposed at the (001) plane.

By contrast, a diffusion path of lithium ions is exposed at a surface having an orientation other than a (001) orientation. Thus, the surface with an orientation other than a (001) orientation and the surface portion 100a thereof easily lose stability because they are regions where extraction of lithium ions starts as well as important regions for maintaining a diffusion path of lithium ions. It is thus extremely important to reinforce the surface having an orientation other than a (001) orientation and the surface portion 100a thereof so that the crystal structure of the whole positive electrode active material 100 is maintained.

Accordingly, in the positive electrode active material 100 of another embodiment of the present invention, it is preferable that the surface having an orientation other than a (001) orientation and the surface portion 100a thereof have distribution of the additive element as illustrated in FIG. 5B1 or FIG. 5B2. By contrast, in the surface with a (001) orientation and the surface portion 100a thereof, the concentration of the additive element may be low as described above or the additive element may be absent.

In the formation method, as described in the following embodiment, in which high-purity LiCoO₂ is formed, the additive element is mixed afterwards, and heating is performed, the additive element spreads mainly through a diffusion path of lithium ions. Thus, distribution of the additive element at the surface having an orientation other than a (001) orientation and the surface portion 100a thereof can easily fall within a preferred range.

Calculation results of distribution of the additive element in the case where LiCoO₂ is formed, the additive element is mixed, and heating is performed are described with reference to FIG. 10B1 to FIG. 10C.

FIG. 10B1 shows calculation results for a surface having a (104) orientation and the surface portion 100a thereof. The classical molecular dynamics method was used for the calculation. LiCoO₂ (LCO) was put in the lower portion of the system, whereas LiF and MgF₂ were put in the upper portion of the system as a magnesium source, a lithium source, and a fluorine source. The ensemble was NVT (canonical ensemble), the density of the initial structure was 1.8 g/cm³, the temperature of the system was 2000 K, the elapsed time was 100 psec, the potential was optimized with an LCO crystal structure, combination with UFF (Universal Force Field) was used for other atoms, the number of atoms in the system was approximately 10000, and electric charges in the system were neutral. To simplify the drawing, only Co atoms and Mg atoms are shown.

Similarly, FIG. 10B2 shows results of calculation in which the elapsed time was 200 psec, and FIG. 10B3 shows results of calculation in which the elapsed time was 1200 psec.

From the above calculation, it is presumed that magnesium diffuses through a process described below. (1) Lithium is released from LCO by heat. (2) Magnesium enters a lithium layer of LCO and diffuses inward. (3) Lithium derived from LiF enters the lithium layer of LCO, compensating for the lithium released in (1).

FIG. 10B1, in which 100 psec elapsed, clearly shows diffusion of magnesium atoms into LCO. Magnesium atoms are diffused along the arranged cobalt atoms, and in FIG. 10B3 in which 1200 psec elapsed, almost all the magnesium atoms provided in the upper portion of the system are taken into LCO.

FIG. 10C shows results of calculation which is the same as the calculation in FIG. 10B1 except that a (001) orientation was employed. In FIG. 10C, magnesium atoms stay at the surface of LCO.

By the formation method in which high-purity LiCoO₂ is formed, the additive element is then mixed, and heating is performed, as described above, the additive element can have a preferable distribution in a surface having an orientation other than a (001) orientation and the surface portion 100a thereof as compared to in a surface having a (001) orientation.

Furthermore, in a formation method including initial heating described later, a release of a lithium compound or the like, which unintentionally remains on the LiCoO2 surface, owing to the initial heating can be expected; therefore, the additive element such as magnesium is likely to be further distributed in the surface portion at a high concentration.

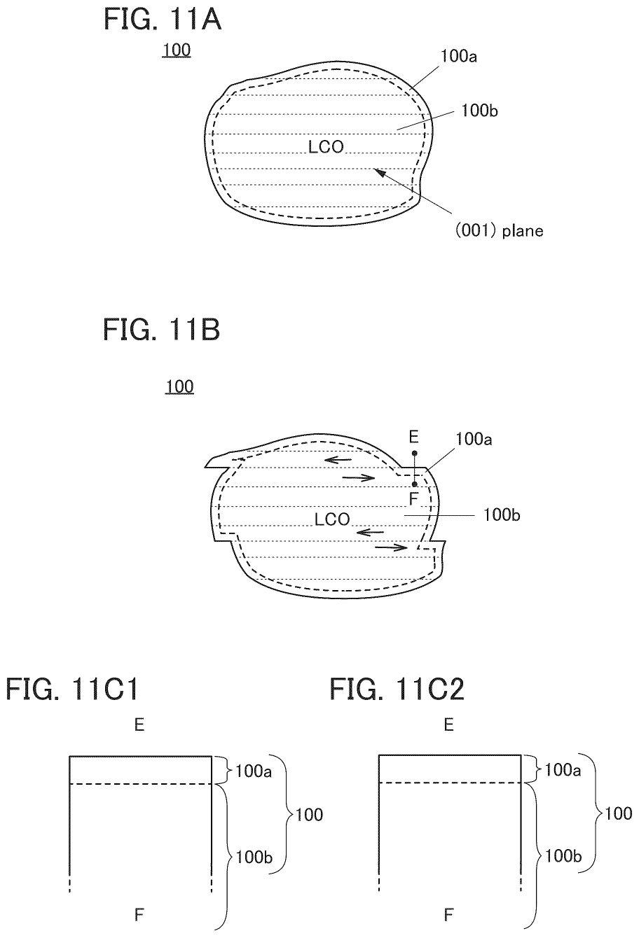

The positive electrode active material 100 preferably has a smooth surface with little unevenness; however, it is not necessary that the whole surface of the positive electrode active material 100 be in such a state. In a composite oxide having a layered rock-salt crystal structure belonging to R-3m, slipping easily occurs at a plane parallel to the (001) plane, e.g., a plane where lithium atoms are arranged. Here slipping is also referred to as a stacking fault and indicates a state where LiCoO₂ is deformed along the lattice fringe direction (a-b plane direction) by pressing. The deformation includes forward and backward shifts of lattice fringes. When lattice fringes are shifted forward and backward from each other, steps are generated on the particle surface which is in the perpendicular direction with respect to the lattice fringes (the c-axis direction). In the case where a (001) plane exists as illustrated in FIG. 11A, for example, steps such as pressing sometimes cause slipping in a direction parallel to the (001) plane as denoted by arrows in FIG. 11B, resulting in deformation.

In that case, at a surface newly formed as a result of slipping and the surface portion 100a thereof, the additive element is not present or present at a concentration lower than or equal to the lower detection limit in some cases. The line E-F in FIG. 11B denotes examples of the surface newly formed as a result of slipping and the surface portion 100a thereof. FIG. 11C1 and FIG. 11C2 illustrate enlarged views of the vicinity of the line E-F. Unlike in FIG. 5B1, FIG. 5B2, FIG. 10A1, and FIG. 10A2, neither the additive element X nor the additive element Y is distributed in FIG. 11C1 and FIG. 11C2.

However, because slipping easily occurs parallel to the (001) plane, the newly formed surface and the surface portion 100a thereof easily have a (001) orientation. In this case, since a diffusion path of lithium ions is not exposed and is relatively stable, substantially no problem is caused even when the additive element is not present or concentration of the additive element is below the lower detection limit.

Note that as described above, in a composite oxide whose composition is LiCoO₂ and which has a layered rock-salt crystal structure belonging to R-3m, cobalt atoms are arranged parallel to the (001) plane. In a HAADF-STEM image, the luminance of cobalt, which has the largest atom number in LiCoO₂, is the highest. Thus, in a HAADF-STEM image, arrangement of atoms with a high luminance may be regarded as arrangement of atoms of cobalt. Repetition of such arrangement with a high luminance can be rephrased as crystal fringes or lattice fringes.

### «Crystal Grain Boundary»

It is further preferable that the additive element contained in the positive electrode active material 100 that can be used as one embodiment of the present invention be distributed as described above and unevenly distributed at least partly at the crystal grain boundary 101 and the vicinity thereof.

For example, the magnesium concentration at the crystal grain boundary 101 of the positive electrode active material 100 and in the vicinity thereof (e.g., in the range of a region several nanometers away from the crystal grain boundary 101 regarded as a center) is preferably higher than that in the other region of the inner portion 100b. In addition, the fluorine concentration at the crystal grain boundary 101 and in the vicinity thereof is preferably higher than that in the other region of the inner portion 100b. In addition, the nickel concentration at the crystal grain boundary 101 and in the vicinity thereof is preferably higher than that in the other region of the inner portion 100b. In addition, the aluminum concentration at the crystal grain boundary 101 and in the vicinity thereof is preferably higher than that in the other region of the inner portion 100b.

The crystal grain boundary 101 is a plane defect, and thus tends to be unstable and suffer a change in the crystal structure like the surface of the particle. Thus, the concentration of the additive element in the crystal grain boundary 101 and its vicinity is increased, so that a change in the crystal structure can be further effectively inhibited.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 that can be used as one embodiment of the present invention. Thus, the positive electrode active material including a crack can also have an increased corrosion resistance to hydrofluoric acid.

### <Particle Diameter>

When the particle diameter of the positive electrode active material 100 that can be used as one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte (electrolyte solution). Thus, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

### <Analysis Method>

Whether or not a positive electrode active material is the positive electrode active material 100 that can be used as one embodiment of the present invention, which has the O3′ type crystal structure and/or monoclinic O1(15) type crystal structure when x in LiₓCoO₂ in a positive electrode active material is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

As described above, the positive electrode active material 100 that can be used as one embodiment of the present invention has a feature of a small change in the crystal structure between when x in LiₓCoO₂ is 1 and when x is less than or equal to 0.24. A material where 50% or more of the crystal structure largely changes in high-voltage charging (e.g., at 4.6 V) is not preferable because the material cannot withstand high-voltage charging and discharging.

It should be noted that the O3′ type crystal structure or the monoclinic O1(15) type crystal structure is not obtained in some cases only by addition of the additive element. For example, although the positive electrode active material has a commonality in lithium cobalt oxide containing magnesium and fluorine or lithium cobalt oxide containing magnesium and aluminum, when x in LiₓCoO₂ is less than or equal to 0.24, the positive electrode active material forms the O3′ type crystal structure and/or the monoclinic O1(15) type crystal structure at 60% or more in some cases, and forms the H1-3 type crystal structure at 50% or more in other cases, depending on the concentration and distribution of the additive element.

In addition, in the case where x is too small, e.g., 0.1 or less, or under the condition where charge voltage is higher than 4.9 V, even the positive electrode active material 100 that can be used as one embodiment of the present invention sometimes has the H1-3 type crystal structure or the trigonal O1 type crystal structure. Thus, determining whether or not a positive electrode active material is the positive electrode active material 100 that can be used as one embodiment of the present invention requires analysis of the crystal structure by XRD and other methods and data such as charge capacity or charge voltage.

A positive electrode active material with small x sometimes causes a change in the crystal structure when exposed to the air. For example, the O3′ type crystal structure and the monoclinic O1(15) type crystal structure change into the H1-3 type crystal structure in some cases. For that reason, all samples subjected to analysis of crystal structures are preferably handled in an inert atmosphere such as an argon atmosphere.

Whether the additive element contained in a positive electrode active material is in the above-described state can be judged by, for example, analysis using XPS, energy dispersive X-ray spectroscopy (EDX), EPMA (electron probe microanalysis), or the like.

The crystal structure of the surface portion 100a, the crystal grain boundary 101, or the like can be analyzed by electron diffraction of a cross section of the positive electrode active material 100, for example.

### «Charge Method»

Example of a charge method for determining whether or not a composite oxide is the positive electrode active material 100 that can be one embodiment of the present invention can include a method where charging is performed on a coin cell (CR2032 type with a diameter of 20 mm and a height of 3.2 mm) using a lithium metal for a counter electrode (negative electrode in this case). Note that the charge method described below is a condition for observing the physical properties of the positive electrode active material 100 that can be used as one embodiment of the present invention. Thus, structures other than the positive electrode active material, such as an electrolyte described below, are different from the structures of a lithium ion battery of one embodiment of the present invention.

More specifically, an example of an applicable positive electrode can be formed by application of slurry in which the positive electrode active material, a conductive material, and a binder are mixed onto a positive electrode current collector made of aluminum foil.

A lithium metal can be used as an example of a negative electrode (counter electrode). Note that when the counter electrode is formed using a material other than the lithium metal, the potential of a secondary battery differs from the potential of the positive electrode. Unless otherwise specified, the voltage and the potential in this specification and the like refer to a potential of a positive electrode in the case where a counter electrode is a lithium metal.

An example of an applicable electrolyte is such that 1 mol/L lithium hexafluorophosphate (LiPF₆) is dissolved in an organic solvent in which ethylene carbonate (EC) and diethyl carbonate (DEC) at a volume ratio of 3:7 (EC:DEC) and vinylene carbonate (VC) at 2 wt % are mixed.

As a separator, a 25-μm-thick polypropylene porous film can be used, for example.

A can formed with stainless steel (SUS) can be used for a positive electrode can and a negative electrode can, for example.

The coin cell fabricated with the above conditions is subjected to constant current charging (also referred to as CC charging) at a current value of 10 mA/g (corresponding to 0.05 C when 1 C=200 mA/g) to a freely selected voltage (e.g., 4.5 V, 4.55 V, 4.6 V, 4.65 V, 4.7 V, 4.75 V, or 4.8 V). To observe a phase change of the positive electrode active material, charging with such a small current value is preferably performed. The temperature is set to 25° C. or 45° C. After charging is performed with the above condition, the coin cell is disassembled in a glove box with an argon atmosphere to take out the positive electrode, whereby the positive electrode active material with predetermined charge capacity can be obtained. In order to inhibit a reaction with components in the external environment, the positive electrode is preferably enclosed in an argon atmosphere in performing various analyses later. For example, XRD can be performed on the positive electrode active material enclosed in an airtight container with an argon atmosphere. After charging is completed, the positive electrode is preferably taken out immediately and subjected to the analysis. Specifically, the positive electrode is preferably subjected to the analysis within an hour after the completion of charging, further preferably within 30 minutes after the completion of charging.

In the case where the crystal structure in a charged state after performing charging and discharging multiple times is analyzed, the conditions of the multiple times of charging and discharging may be different from the above-described charge conditions. For example, as the charging, constant current charging to a freely selected voltage (e.g., 4.6 V, 4.65 V, 4.7 V, 4.75 V, or 4.8 V) at a current value of 100 mA/g can be performed and then constant voltage charging can be performed until the current value becomes 10 mA/g, and as the discharging, constant current discharging can be performed at 2.5 V and 100 mA/g.

Also in the case where the crystal structure in a discharged state after charging and discharging are performed multiple times is analyzed, constant current discharging can be performed at 2.5 V and a current value of 100 mA/g, for example.

### «XRD»

The apparatus and conditions for the XRD measurement of the positive electrode active material are not particularly limited. The measurement can be performed with the apparatus and conditions as described below, for example.
XRD apparatus: D8 ADVANCE produced by Bruker AXS
X-ray source: CuKα₁ radiation
Output: 40 kV, 40 mA
Slit width: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

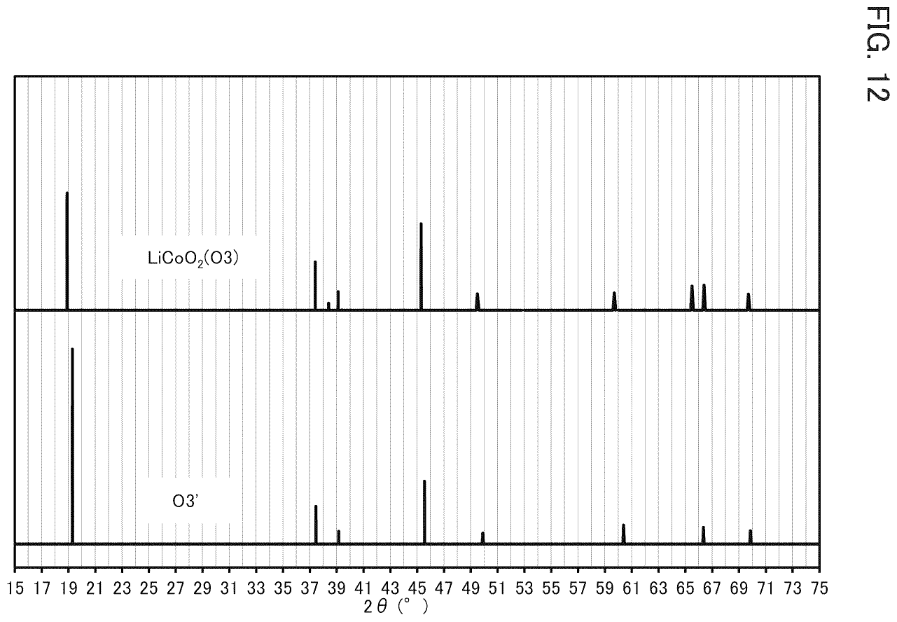

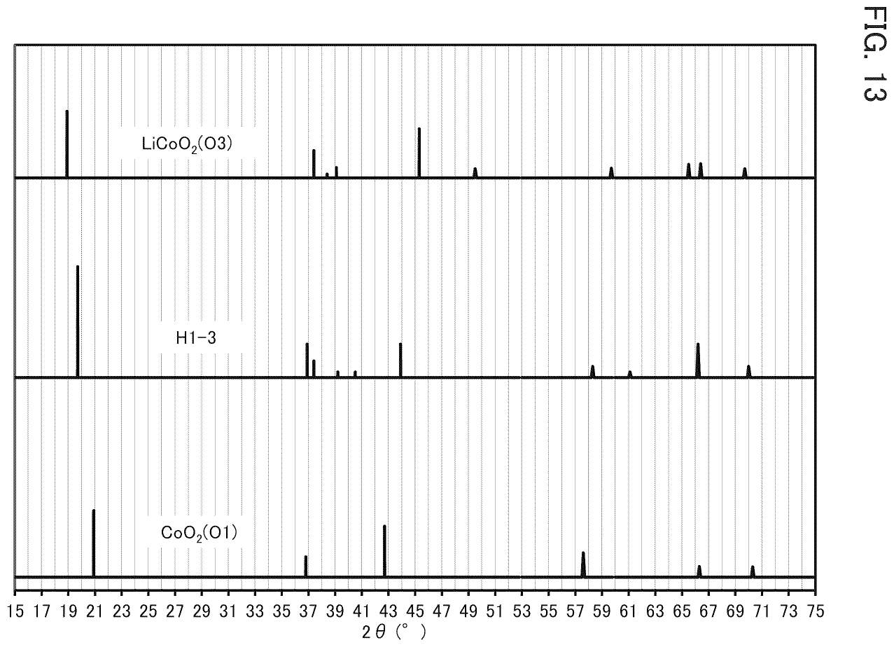

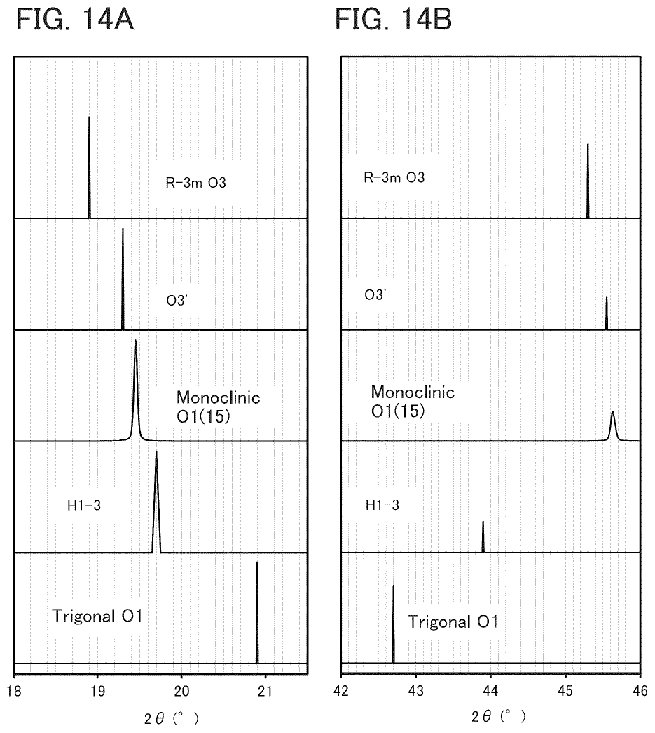

FIG. 12, FIG. 13, FIG. 14A, and FIG. 14B show ideal powder XRD patterns with CuKα1 radiation that are calculated from models of the O3′ type crystal structure, the monoclinic O1(15) type crystal structure, and the H1-3 type crystal structure. For comparison, ideal XRD patterns calculated from the crystal structure of LiCoO₂ O3 with x in LiₓCoO₂ of 1 and the crystal structure of the trigonal O1 with x of 0 are also shown. FIG. 14A and FIG. 14B each show the XRD patterns of the O3′ type structure, the monoclinic O1(15) type crystal structure, and the H1-3 type structure, and FIG. 14A and FIG. 14B are enlarged diagrams showing, respectively, a range of 2θ greater than or equal to 18° and less than or equal to 21° and a range of 2θ greater than or equal to 42° and less than or equal to 46°. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. The pattern of the H1-3 type crystal structure is similarly made from the crystal structure data disclosed in Non-Patent Document 1. The O3′ type crystal structure and the monoclinic O1(15) type crystal structure are estimated from the XRD pattern of the positive electrode active material that can be used as one embodiment of the present invention, the crystal structure is fitted with TOPAS Ver. 3 (crystal structure analysis software produced by Bruker Corporation), and the XRD patterns of the O3′ type crystal structure and the monoclinic O1(15) type crystal structure are made in a manner similar to that for other structures.

As shown in FIG. 12, FIG. 14Am and FIG. 14B, the O3′ type crystal structure exhibits diffraction peaks at 2θ of 19.25±0.12° (greater than or equal to 19.13° and less than 19.37°) and 2θ of 45.47±0.10° (greater than or equal to 45.37° and less than 45.57°).

Furthermore, the monoclinic O1(15) type crystal structure exhibits diffraction peaks at 2θ of 19.47±0.10° (greater than or equal to 19.37° and less than or equal to 19.57°) and 2θ of 45.62±0.05° (greater than or equal to 45.57° and less than or equal to 45.67°).

Meanwhile, as shown in FIG. 13, FIG. 14Am and FIG. 14B, the H1-3 type crystal structure and the trigonal O1 do not exhibit peaks at these positions. Thus, exhibiting the peak at 2θ of greater than or equal to 19.13 and less than 19.37 and/or the peak at 2θ of greater than or equal to 19.37° and less than or equal to 19.57° and the peak at 2θ of greater than or equal to 45.37° and less than 45.57° and/or the peak at 2θ of greater than or equal to 45.57° and less than or equal to 45.67° in a state with small x in LiₓCoO₂ can be the feature of the positive electrode active material 100 that can be used as one embodiment of the present invention.

It can be said that the positions of the XRD diffraction peaks exhibited by the crystal structure with x being 1 and the crystal structure with x being 0.24 or less are close to each other. More specifically, it can be said that in the 2θ range of 42° to 46°, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material 100 that can be used as one embodiment of the present invention has the O3′ type crystal structure and/or the monoclinic O1(15) type crystal structure when x in LiₓCoO₂ is small, not all particles in the positive electrode active material 100 necessarily has the O3′ type crystal structure and/or the monoclinic O1(15) type crystal structure. The positive electrode active material 100 may have another crystal structure or may be partly amorphous. Note that when the XRD patterns are subjected to the Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% can have sufficiently good cycle performance.

Furthermore, even after 100 or more cycles of charging and discharging after the measurement starts, the O3′ type crystal structure and/or the monoclinic O1(15) type crystal structure preferably account(s) for more than or equal to 35%, further preferably more than or equal to 40%, still further preferably more than or equal to 43% when the Rietveld analysis is performed.

Sharpness of a diffraction peak in an XRD pattern indicates the degree of crystallinity. It is thus preferable that the diffraction peaks after charging be sharp, in other words, have a small half width. Even peaks that are derived from the same crystal phase have different half widths depending on the XRD measurement conditions or the 2θ value. In the case of the above-described measurement conditions, the peak observed at 2θ of greater than or equal to 43° and less than or equal to 46° preferably has a small half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity efficiently contributes to stability of the crystal structure after charging.

The crystallite sizes of the O3′ type crystal structure and the monoclinic O1(15) type crystal structure included in the positive electrode active material 100 are decrease only to approximately one-twentieth that of LiCoO₂ (O3) in a discharged state. Thus, clear peaks of the O3′ type crystal structure and the monoclinic O1(15) type crystal structure can be observed when x in LiₓCoO₂ is small, even under the same XRD measurement conditions as those of a positive electrode before charging and discharging. In contrast, conventional LiCoO₂ has a small crystallite size and a broad and small peak even when it can have a structure part of which is similar to the O3′ type crystal structure and the monoclinic O1(15) type crystal structure. The crystallite size can be calculated from the half width of the XRD peak.

The influence of the Jahn-Teller effect is preferably small in the positive electrode active material 100 that can be used as one embodiment of the present invention. The positive electrode active material 100 may contain a transition metal such as nickel or manganese as the additive element in addition to cobalt as long as the influence of the Jahn-Teller effect is small.

The proportions of nickel and manganese and the range of the lattice constants in each of which the influence of the Jahn-Teller effect is presumed to be small in the positive electrode active material are examined by XRD analysis.

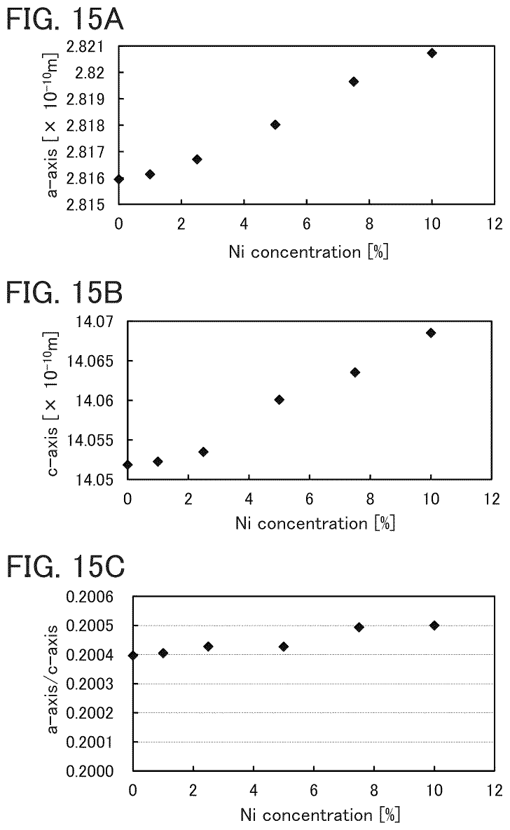

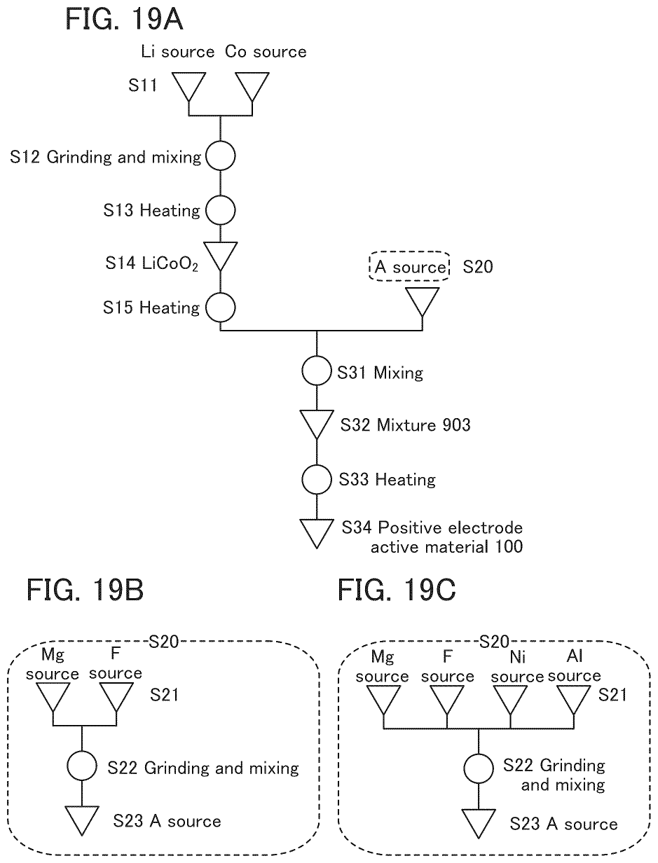

FIG. 15 shows the calculation results of the lattice constants of the a-axis and the c-axis by XRD in the case where the positive electrode active material 100 that can be used as one embodiment of the present invention has a layered rock-salt crystal structure and contains cobalt and nickel. FIG. 15A shows the results of the a-axis, and FIG. 15B shows the results of the c-axis. Note that the XRD patterns of a powder after the synthesis of the positive electrode active material before incorporation into a positive electrode are used for the calculation. The nickel concentration on the horizontal axis represents a nickel concentration with the sum of cobalt atoms and nickel atoms assumed as 100%. The positive electrode active material was formed in accordance with the formation method in FIG. 19A and FIG. 19C except that the aluminum source was not used.

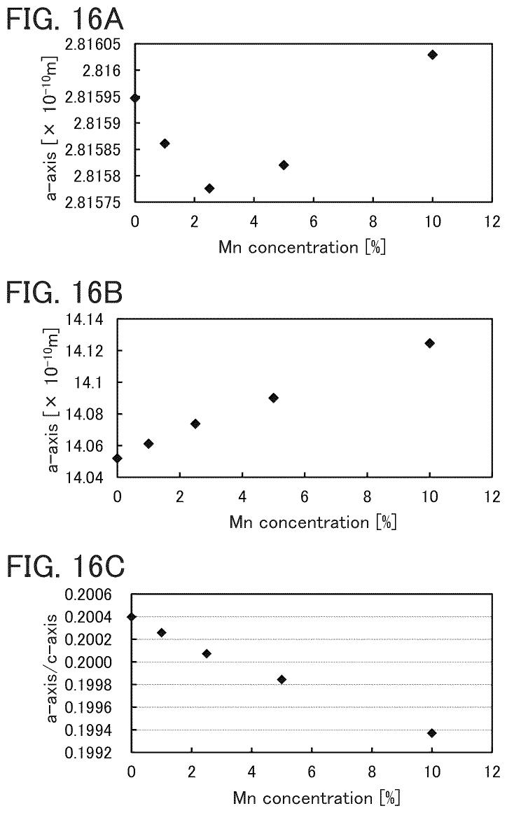

FIG. 16 shows the estimation results of the lattice constants of the a-axis and the c-axis by XRD in the case where the positive electrode active material that can be used as one embodiment of the present invention has the layered rock-salt crystal structure and includes cobalt and manganese. FIG. 16A shows the results of the a-axis, and FIG. 16B shows the results of the c-axis. Note that the lattice constants shown in FIG. 16 were obtained by XRD of a powder after the synthesis of the positive electrode active material before incorporation into a positive electrode. The manganese concentration on the horizontal axis represents a manganese concentration with the sum of cobalt atoms and manganese atoms assumed as 100%. The positive electrode active material was formed in accordance with the formation method of FIG. 19A and FIG. 19C except that a manganese source was used instead of the nickel source and the aluminum source was not used.

FIG. 15C shows values obtained by dividing the lattice constants of the a-axis by the lattice constants of the c-axis (a-axis/c-axis) in the positive electrode active material, whose results of the lattice constants are shown in FIG. 15A and FIG. 15B. FIG. 16C shows values obtained by dividing the lattice constants of the a-axis by the lattice constants of the c-axis (a-axis/c-axis) in the positive electrode active material, whose results of the lattice constants are shown in FIG. 16A and FIG. 16B.

As shown in FIG. 15C, the value of a-axis/c-axis tends to significantly change between nickel concentrations of 5% and 7.5%, and the distortion of the a-axis becomes large at a nickel concentration of 7.5%. This distortion may be the Jahn-Teller distortion. It is suggested that an excellent positive electrode active material with small Jahn-Teller distortion can be obtained at a nickel concentration of lower than 7.5%.

FIG. 16A indicates that the lattice constant changes differently at manganese concentrations of 5% or higher and does not follow the Vegard's law. This suggests that the crystal structure changes at a manganese concentration of 5% or higher. Thus, the manganese concentration is preferably 4% or lower, for example.

Note that the nickel concentration and the manganese concentration in the surface portion 100a are not limited to the above ranges. In other words, the nickel concentration and the manganese concentration in the surface portion 100a may be higher than the above concentrations in some cases.

Preferable ranges of the lattice constants of the positive electrode active material that can be used as one embodiment of the present invention are examined above. In the layered rock-salt crystal structure of the positive electrode active material 100 in a discharged state or a state where charging and discharging are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charging and discharging are not performed may be, for example, the state of a powder before the formation of a positive electrode of a secondary battery.

Alternatively, in the layered rock-salt crystal structure of the positive electrode active material 100 in the discharged state or the state where charging and discharging are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in the discharged state or the state where charging and discharging are not performed is subjected to XRD analysis, a first peak is observed at 2θ of greater than or equal to 18.50° and less than or equal to 19.30° and a second peak is observed at 2θ of greater than or equal to 38.00° and less than or equal to 38.80°, in some cases.

### «XPS»

In an inorganic oxide, a region that is approximately 2 nm to 8 nm (normally, approximately 5 nm or less) in depth from a surface can be analyzed by X-ray photoelectron spectroscopy (XPS) using monochromated aluminum Kα radiation as an X-ray source; thus, the concentrations of elements can be quantitatively analyzed. The bonding states of the elements can be analyzed by narrow scanning. Note that the quantitative accuracy of XPS is approximately ±1 at % in many cases. The lower detection limit is approximately 1 at % but depends on the element.

In the positive electrode active material 100 that can be used as one embodiment of the present invention, the concentration of one or more selected from the additive elements is preferably higher in the surface portion 100a than in the inner portion 100b. This means that the concentration of one or more selected from the additive elements in the surface portion 100a is preferably higher than the average concentration of the additive elements in the entire positive electrode active material 100. For this reason, for example, it is preferable that the concentration of one or more additive elements selected from the surface portion 100a, which is measured by XPS or the like, be higher than the average concentration of the additive elements in the entire positive electrode active material 100, which is measured by ICP-MS (an inductively coupled plasma-mass spectrometry), GD-MS (a glow discharge mass spectrometry), or the like. For example, the concentration of magnesium in at least part of the surface portion 100a, which is measured by XPS or the like, is preferably higher than the concentration of magnesium in the entire positive electrode active material 100. The concentration of nickel in at least part of the surface portion 100a is preferably higher than the concentration of nickel in the entire positive electrode active material 100. The concentration of aluminum in at least part of the surface portion 100a is preferably higher than the concentration of aluminum in the entire positive electrode active material 100. The concentration of fluorine in at least part of the surface portion 100a is preferably higher than the fluorine concentration of the entire positive electrode active material 100.

Note that the surface and the surface portion 100a of the positive electrode active material 100 that can be used as one embodiment of the present invention do not contain a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample of a positive electrode active material and a positive electrode active material layer or the like may be washed, for example, to eliminate an electrolyte solution, a binder, a conductive material, or a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The use of the ratio of the additive element to cobalt preferably enables comparison while reducing the influence of a carbonate or the like which is chemically adsorbed after formation of the positive electrode active material. For example, in the XPS analysis with respect to the surface or the surface portion of the positive electrode active material, the atomic ratio of magnesium to cobalt (Mg/Co) is preferably greater than or equal to 0.4 and less than or equal to 1.5. In the ICP-MS analysis with respect to the entire positive electrode active material, Mg/Co is preferably greater than or equal to 0.001 and less than or equal to 0.06.

Similarly, to ensure the sufficient path through which lithium is inserted and extracted, the concentrations of lithium and cobalt are preferably higher than those of the additive elements in the surface portion 100a of the positive electrode active material 100. This means that the concentrations of lithium and cobalt in the surface portion 100a are preferably higher than that of one or more selected from the additive elements contained in the surface portion 100a, which is measured by XPS or the like. For example, the concentration of cobalt in at least part of the surface portion 100a, which is measured by XPS or the like, is preferably higher than the concentration of magnesium in at least part of the surface portion 100a, which is measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than the concentration of aluminum. Similarly, the concentration of lithium is preferably higher than the concentration of aluminum. The concentration of cobalt is preferably higher than the concentration of fluorine. Similarly, the concentration of lithium is preferably higher that of fluorine.

It is further preferable that the additive element Y such as aluminum be widely distributed in a deep region, e.g., a region that is 5 nm to 50 nm in depth from the surface. Thus, the additive element Y such as aluminum is detected by analysis on the entire positive electrode active material 100 by ICP-MS, GD-MS, or the like, but the concentration of the additive element Y such as aluminum is preferably lower than or equal to the lower detection limit in XPS or the like.

Furthermore, when XPS analysis is performed on the surface or surface portion of positive electrode active material 100 that can be used as one embodiment of the present invention, the number of magnesium atoms is preferably greater than or equal to 0.4 times and less than or equal to 1.2 times, further preferably 0.65 times or more and 1.0 times or less the number of cobalt atoms. The number of nickel atoms is preferably 0.15 times or less, further preferably 0.03 times or more and 0.13 times or less the number of cobalt atoms. The number of aluminum atoms is preferably 0.12 times or less, further preferably 0.09 times or less the number of cobalt atoms. The number of fluorine atoms is preferably 0.3 times or more and 0.9 times or less, further preferably 0.1 times or more and 1.1 times or less the number of cobalt atoms.

In the XPS analysis, monochromatic aluminum Kα radiation can be used as an X-ray source, for example. An extraction angle is, for example, 45°.

For example, the measurement can be performed using the following apparatus and conditions.
Measurement device: Quantera II produced by PHI, Inc.
X-ray source: monochromatic Al Kα (1486.6 eV)
Detection area: 100 μmϕ
Detection depth: approximately 4 to 5 nm (extraction angle 45°)
Measurement spectrum: wide scanning, narrow scanning of each detected element

In addition, when the surface or surface portion of the positive electrode active material 100 that can be used as one embodiment of the present invention is analyzed by XPS, a peak indicating the bonding energy of fluorine with another element is preferably at greater than or equal to 682 eV and less than 685 eV, further preferably approximately 684.3 eV. The above value is different from 685 eV, which is the bonding energy of lithium fluoride, and 686 eV, which is the bonding energy of magnesium fluoride. That is, in the case where the positive electrode active material 100 that can be used one embodiment of the present invention contains fluorine, the fluorine is preferably in a bonding state other than lithium fluoride and magnesium fluoride.

Furthermore, when the surface or surface portion of the positive electrode active material 100 that can be used as one embodiment of the present invention is analyzed by XPS, a peak indicating the bonding energy of magnesium with another element is preferably at greater than or equal to 1302 eV and less than 1304 eV, further preferably at approximately 1303 eV. This bonding energy is different from that of magnesium fluoride (1305 eV) and is close to that of magnesium oxide. That is, the positive electrode active material 100 that can be used as one embodiment of the present invention containing magnesium is preferably in the bonding state other than magnesium fluoride.

### «EDX»

The one or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated, for example, by exposing a cross section of the positive electrode active material 100 using FIB (Focused Ion Beam) or the like and analyzing the cross section using EDX (Energy Dispersive X-ray Spectroscopy), EPMA (electron probe microanalysis), or the like.

In the EDX measurement for two-dimensional evaluation of an area by area scan is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive elements in the surface portion 100a, the inner portion 100b, the vicinity of the crystal grain boundary 101, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

EDX area analysis or EDX point analysis of the positive electrode active material 100 that can be used as one embodiment of the present invention preferably reveals that the concentration of each additive element, in particular, the additive element X in the surface portion 100a is higher than that in the inner portion 100b.

For example, EDX area analysis or EDX point analysis of the positive electrode active material 100 containing magnesium as the additive element preferably reveals that the concentration of magnesium in the surface portion 100a is higher than that in the inner portion 100b. Thus, in the EDX line analysis, a peak of the concentration of magnesium in the surface portion 100a is preferably observed in a region extending, toward the center of the positive electrode active material 100, from the surface thereof to a depth of 3 nm, further preferably 1 nm, still further preferably 0.5 nm. In addition, the concentration of magnesium preferably attenuates, at a depth of 1 nm from the point where the concentration reaches the peak, to less than or equal to 60% of the peak concentration. In addition, the concentration of magnesium preferably attenuates, at a depth of 2 nm from the point where the concentration reaches the peak, to less than or equal to 30% of the peak concentration. Here, a “peak of concentration” refers to the local maximum value of concentration.

When the positive electrode active material 100 contains magnesium and fluorine as the additive elements, the distribution of fluorine preferably overlaps with the distribution of magnesium. For example, a difference in the depth direction between a peak of the concentration of fluorine and a peak of the concentration of magnesium is preferably within 10 nm, further preferably within 3 nm, still further preferably within 1 nm.

Thus, in the EDX line analysis, a peak of the concentration of fluorine in the surface portion 100a is preferably observed in a region extending, toward the center of the positive electrode active material 100, from the surface thereof to a depth of 3 nm, further preferably 1 nm, still further preferably 0.5 nm. It is further preferable that a peak of the concentration of fluorine be exhibited slightly closer to the surface side than a peak of the concentration of magnesium is, which increases resistance to hydrofluoric acid. For example, it is preferable that a peak of the concentration of fluorine be exhibited slightly closer to the surface side than a peak of the concentration of magnesium is by 0.5 nm or more, further preferably 1.5 nm or more.

When the positive electrode active material 100 containing nickel as the additive element, a peak of the concentration of nickel in the surface portion 100a is preferably observed in a region extending, toward the center of the positive electrode active material 100, from the surface thereof to a depth of 3 nm, further preferably 1 nm, still further preferably 0.5 nm. When the positive electrode active material 100 contains magnesium and nickel, the distribution of nickel preferably overlaps with the distribution of magnesium. For example, a difference in the depth direction between a peak of the concentration of nickel and a peak of the concentration of magnesium is preferably within 10 nm, further preferably within 3 nm, still further preferably within 1 nm.

In the case where the positive electrode active material 100 contains aluminum as the additive element, the peak of the concentration of magnesium, the concentration of nickel, or the concentration of fluorine is preferably closer to the surface than the peak of the concentration of aluminum is in the surface portion 100a in the EDX line analysis. For example, the peak of the concentration of aluminum is preferably exhibited by a region that is greater than or equal to 0.5 nm and less than or equal to 50 nm in depth, further preferably greater than or equal to 5 nm and less than or equal to 50 nm in depth from the surface toward the center of the positive electrode active material 100.

EDX line, area, or point analysis of the surface or surface portion of positive electrode active material 100 preferably reveals that the atomic ratio of magnesium to cobalt (Mg/Co) at a peak of the concentration of magnesium is preferably higher than or equal to 0.05 and lower than or equal to 0.6, further preferably higher than or equal to 0.1 and lower than or equal to 0.4. The atomic ratio of aluminum to cobalt (Al/Co) at a peak of the concentration of aluminum is preferably greater than or equal to 0.05 and less than or equal to 0.6, further preferably greater than or equal to 0.1 and less than or equal to 0.45. The atomic ratio of nickel to cobalt (Ni/Co) at a peak of the concentration of nickel is preferably higher than or equal to 0 and lower than or equal to 0.2, further preferably higher than or equal to 0.01 and lower than or equal to 0.1. The atomic ratio of fluorine to cobalt (F/Co) at a peak of the concentration of fluorine is preferably higher than or equal to 0 and lower than or equal to 1.6, further preferably higher than or equal to 0.1 and lower than or equal to 1.4.

According to results of the EDX line analysis, where the surface of the positive electrode active material 100 is can be estimated in the following manner, for example. A point where the detected amount of an element which uniformly exists in the inner portion 100b of the positive electrode active material 100, e.g., oxygen or cobalt, is ½ of the detected amount thereof in the inner portion 100b is assumed to be the surface.

Since the positive electrode active material 100 is a composite oxide, the detected amount of oxygen can be used to estimate where the surface is. Specifically, an average value Oₐᵥₑ of the oxygen concentration in a region of the inner portion 100b where the detected amount of oxygen is stable is calculated first. At this time, in the case where oxygen O_{background} which is probably led from chemical adsorption or the background is detected in a region that is obviously outside the surface, O_{background} can be subtracted from the measurement value to obtain the average value Oₐᵥₑ of the oxygen concentration. The measurement point where the measurement value which is closest to ½ of the average value Oₐᵥₑ, i.e., ½Oₐᵥₑ, is obtained can be estimated to be the surface of the positive electrode active material.

The detected amount of cobalt can also be used to estimate where the surface is as in the above description. Alternatively, the sum of the detected amounts of the transition metals can be used for the estimation in a similar manner. The detected amount of the transition metal such as cobalt is less likely to be affected by chemical adsorption and is thus suitable for estimating where the surface is.

When the surface or surface portion of the positive electrode active material 100 is subjected to line analysis or area analysis, the ratio of the additive element A to cobalt Co (A/Co) in the vicinity of the crystal grain boundary 101 is preferably higher than or equal to 0.020 and lower than or equal to 0.50, further preferably higher than or equal to 0.025 and lower than or equal to 0.30, still further preferably higher than or equal to 0.030 and lower than or equal to 0.20. Note that any of the maximum values and the minimum values can be combined freely unless otherwise specified in this specification.

For example, when the surface or surface portion of the positive electrode active material 100 is analyzed by linear analysis or area analysis using magnesium as an additive element, the atomic ratio of magnesium to cobalt (Mg/Co) in the vicinity of the crystal grain boundary 101 is preferably higher than or equal to 0.020 and lower than or equal to 0.50, further preferably higher than or equal to 0.025 and lower than or equal to 0.30, still further preferably higher than or equal to 0.030 and lower than or equal to 0.20.

### «EPMA»

Quantitative analysis of elements can be conducted also by EPMA (electron probe microanalysis). In area analysis, distribution of each element can be analyzed.

EPMA area analysis of a cross section of the positive electrode active material 100 that can be used as one embodiment of the present invention preferably reveals that one or more selected from the additive elements have a concentration gradient, as in the EDX analysis results. For example, it is further preferable that the additive elements exhibit concentration peaks at different depths from a surface. The preferred ranges of the concentration peaks of the additive elements are the same as those of the case of EDX.

Note that in EPMA, a region from a surface to a depth of approximately 1 μm is analyzed. Thus, the quantitative value of each element is sometimes different from measurement results obtained by other analysis methods. For example, when area analysis is performed by EPMA on the positive electrode active material 100, the concentrations of the additive elements present in the surface portion 100a might be lower than the results obtained in XPS.

«Charge Curve and dQ/dV with Respect to Voltage V»

The positive electrode active material 100 that can be used as one embodiment of the present invention sometimes shows a characteristic voltage change along with charging. A voltage change can be read from a dQ/dVvsV curve, which can be obtained by differentiating capacitance (Q) in a charge curve with voltage (V) (dQ/dV). There should be an unbalanced phase change and a significant change in the crystal structure between before and after a peak in the dQ/dVvsV curve. Note that in this specification and the like, an unbalanced phase change refers to a phenomenon that causes a nonlinear change in physical quantity.

The positive electrode active material 100 that can be used as one embodiment of the present invention sometimes shows a broad peak at around 4.55 V in a dQ/dV vs V curve. The peak at around 4.55 V reflects a change in voltage at the time of the phase change from the 03 type structure to the O3′ type structure. This means that when this peak is broad, a change in the energy necessary for extraction of lithium is smaller or in other words, a change in the crystal structure is smaller, than when the peak is sharp. These changes are preferably small, in which case the influence of a shift in CoO₂ layers and that of a change in volume are little.

Specifically, when the maximum value appearing at greater than or equal to 4.5 V and less than or equal to 4.6 V in a dQ/dVvsV curve of a charge curve is a first peak, the first peak preferably has a full width at half maximum of greater than or equal to 0.10 V to be sufficiently broad. In this specification and the like, the half width of the first peak refers to the difference between HWHM₁ and HWHM₂, where HWHM₁ is an average value of the first peak and a first minimum value, which is the minimum dQ/dV value appearing at greater than or equal to 4.3 V and less than or equal to 4.5 V, and HWHM₂ is an average value of the first peak and a second minimum value, which is the minimum dQ/dV value appearing at greater than or equal to 4.6 V and less than or equal to 4.8 V.

The charging at the time of obtaining a dQ/dVvsV curve can be, for example, constant current charging to 4.9 V at 10 mA/g. In obtaining a dQ/dV value of the initial charging, the above charging is preferably started after discharging to 2.5 V at 100 mA/g before measurement.

Data acquisition at the time of charging can be performed in the following manner, for example: a voltage and a current are acquired at intervals of 1 second or at every 1-mV voltage change. The value obtained by adding the current value and time is charge capacity.

The difference between the n-th data and the n+1-th data of the above charge capacity is the n-th value of a capacity change dQ. Similarly, the difference between the n-th data and the n+1-th data of the above voltage is the n-th value of a voltage change dV.

Note that minute noise has considerable influence when the above data is used; thus, the dQ/dV value may be calculated from the moving average for a certain number of class intervals of the differences in the voltage and the moving average for a certain number of class intervals of the differences in the charge capacity. The number of class intervals can be 500, for example.

Specifically, the average value of the n-th to n+500-th dQ values is calculated and in a similar manner, the average value of the n-th to n+500-th dV values is calculated. The dQ/dV value can be dQ (the average of 500 dQ values)/dV (the average of 500 dV values). In a similar manner, the moving average value of the 500 class intervals can be used for the voltage on the horizontal axis of a dQ/dVvsV graph. In the case where the above-described moving average value of the 500 class intervals is used, the 501^{st} data from the last to the last data are largely influenced by noise and thus are not preferably used for the dQ/dVvsV graph.

In the case where a dQ/dVvsV curve after charging and discharging are performed multiple times is analyzed, the conditions of the charging and discharging performed multiple times may be different from the above-described charge conditions. For example, the charging can be performed in the following manner: constant current charging is performed at 100 mA/g to a freely selected voltage (e.g., 4.6 V, 4.65 V, 4.7 V, 4.75 V, or 4.8 V) and then, constant voltage charging is performed until the current value becomes 10 mA/g. As the discharging, constant current discharging can be performed at 2.5 V and 100 mA/g.

Note that the O3 type structure at the time of the phase change to the O3′ type structure at around 4.55 V has x in LiₓCoO₂ of approximately 0.3. This O3 type structure has the same symmetry as the O3 type structure with x of 1 illustrated in FIG. 9, but is slightly different in the distance between the CoO₂ layers. In this specification and the like, when O3 type structures with different x are distinguished from each other, the O3 type structure with x of 1 is referred to as O3 (2θ=18.85) and the O3 type structure with x of approximately 0.3 is referred to as O3 (2θ=18.57). This is because the position of the peak appearing at 2θ of approximately 19° in XRD measurement corresponds to the distance between the CoO₂ layers.

«Discharge Curve and dQ/dVvsV Curve»

Moreover, when the positive electrode active material 100 of one embodiment of the present invention is discharged at a low current of, for example, 40 mA/g or lower after high-voltage charging, a characteristic change in voltage appears just before the end of discharging, in some cases. This change can be clearly observed by the fact that at least one peak appears within the range to 3.5 V at a voltage lower than that of a peak which appears around 3.9 V in dQ/dVnsV curve calculated from a discharge curve.

### «ESR»

The positive electrode active material 100 that can be used as one embodiment of the present invention preferably contains cobalt, and nickel and magnesium as the additive elements. It is preferable that Ni³⁺ be substituted for part of Co³⁺ and Mg²⁺ be substituted for part of Li⁺ accordingly. Accompanying the substitution of Mg²⁺ for Li⁺, the Ni³⁺ might be reduced to be Ni²⁺. Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material 100 preferably contains one or more of Ni Ni³⁺, Co²⁺, and Co⁴⁺. Moreover, the spin density attributed to one or more of Ni²⁺, Ni³⁺, Co²⁺, and Co⁴⁺ per weight of the positive electrode active material 100 is preferably greater than or equal to 2.0×10¹⁷ spins/g and less than or equal to 1.0×10²¹ spins/g. The positive electrode active material 100 preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by an electron spin resonance (ESR) method, for example.

### «Surface Roughness and Specific Surface Area»

The positive electrode active material 100 that can be used as one embodiment of the present invention preferably has a smooth surface with little unevenness. A smooth surface with little unevenness indicates that an effect of a fusing agent described later adequately functions and the surfaces of the additive element source and the lithium cobalt oxide melt (dissolved). Thus, a smooth surface with little unevenness indicates favorable distribution of the additive element in the surface portion 100a.

The smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with the protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. This surface roughness refers to the surface roughness in at least 400 nm of the particle periphery of the positive electrode active material.

On the surface of the particle of the positive electrode active material 100 of this embodiment, root-mean-square surface roughness (RMS), which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area S_{R} measured by a constant-volume gas adsorption method to an ideal specific surface area Sᵢ.

The ideal specific surface area Sᵢ is calculated on the assumption that all the particles of the positive electrode active material have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100 that can be used as one embodiment of the present invention, the ratio of the actual specific surface area S_{R} to the ideal specific surface area Sᵢ obtained from the median diameter D50 (S_{R}/Sᵢ) is preferably lower than or equal to 2.1.

The level of the surface smoothness of the positive electrode active material 100 can be quantified from its cross-sectional SEM image by the following method, for example.

First, a surface SEM image of the positive electrode active material 100 is obtained. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with use of image processing software (e.g., “ImageJ”). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The quantified value is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the positive electrode active material 100 that can be used as one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

### <Other Features>

The positive electrode active material 100 has a depression, a crack, a concave, a V-shaped cross section, or the like in some cases. These are examples of defects, and when charging and discharging are repeated, dissolution of cobalt, breakage of a crystal structure, cracking of the positive electrode active material, extraction of oxygen, or the like might be derived from these defects. Thus, the filling portion 102 containing the additive element is provided as illustrated in FIG. 5A2, which can inhibit dissolution of cobalt or the like. Thus, the positive electrode active material 100 can have high reliability and excellent cycle performance.

The positive electrode active material 100 may include a projection 103, which is a region where the additive element is unevenly distributed.

As described above, an excess amount of the additive element in the positive electrode active material 100 might adversely affect insertion and extraction of lithium. The use of such a positive electrode active material for a secondary battery might cause an internal resistance increase, a charge and discharge capacity decrease, and the like. Meanwhile, when the amount of the additive element is insufficient, the additive element is not distributed throughout the surface portion 100a, which might diminish the effect of inhibiting degradation of a crystal structure. The additive element is thus required to be contained in the positive electrode active material 100 at an appropriate concentration; however, the adjustment of the concentration is not easy.

For this reason, in the positive electrode active material 100, when the region where the additive element is unevenly distributed is included, some excess atoms of the additive element are removed from the inner portion 100b, so that the additive element concentration can be appropriate in the inner portion 100b. This can inhibit an internal resistance increase, a charge and discharge capacity decrease, and the like when a secondary battery is fabricated. A feature of inhibiting an internal resistance increase in a secondary battery is extremely preferable especially in charging and discharging with a large amount of current such as charging and discharging at 400 mA/g or more.

In the positive electrode active material 100 including the region where the additive element is unevenly distributed, mixing of excess additive elements to some extent in the formation process is acceptable. This is preferable because the margin of production can be increased.

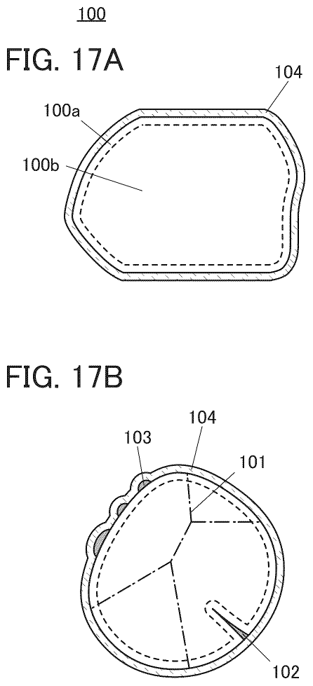

The positive electrode active material 100 may include a coating film on at least part of its surface. FIG. 17A and FIG. 17B show an example of the positive electrode active material 100 including the coating film 104.

The coating film 104 is preferably formed by deposition of a decomposition product of an electrolyte solution due to charging and discharging, for example. A coating film originating from an electrolyte solution, which is formed on the surface of the positive electrode active material 100, is expected to produce an effect of improving charge and discharge cycle performance particularly when charging that makes x in LiₓCoO₂ be 0.24 or less is repeated. This is because an increase in impedance of the surface of the positive electrode active material is inhibited or dissolution of cobalt is inhibited, for example. The coating film 104 preferably contains carbon, oxygen, and fluorine, for example. The coating film can have high quality easily when part of the electrolyte solution contains LiBOB and/or SUN (suberonitrile), for example. Accordingly, the coating film 104 containing one or more selected from boron, nitrogen, sulfur, and fluorine is preferable because of having high quality in some cases. The coating film 104 does not necessarily cover the positive electrode active material 100 entirely.

When a positive electrode active material undergoes charging and discharging under conditions, including charging at 4.5 V or more, or at a high temperature, e.g., 45° C. or higher, a progressive defect that progresses deeply from the surface toward the inner portion might be generated. Progress of a defect in a positive electrode active material to form a hole can be referred to as pitting corrosion, and the hole generated by this phenomenon is also referred to as a pit in this specification and the like.

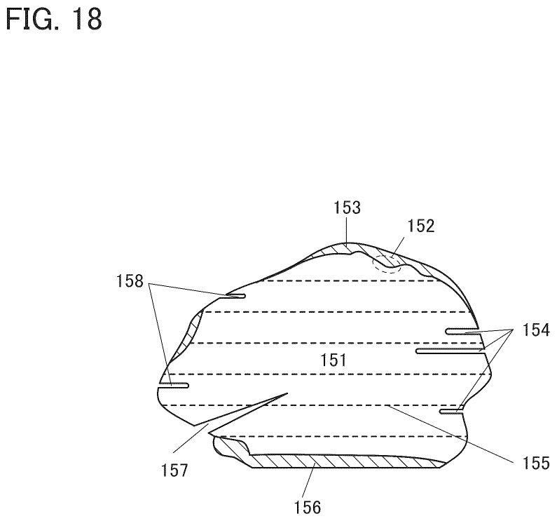

FIG. 18 shows a schematic cross-sectional view of a positive electrode active material 151 including the pit. A crystal plane 155 parallel to the arrangement of cations is also shown. Although a pit 154 and a pit 158 are illustrated as holes since FIG. 18 is a cross-sectional view, their opening shapes are not circular but a wide groove-like shape. Unlike a depression 152, the pit 154 and the pit 158 are likely to be generated parallel to the arrangement of lithium ions as illustrated in the drawing.

In the positive electrode active material 151, surface portions where the additive elements exist are denoted by reference numerals 153 and 156. A surface portion where a pit is generated contains a smaller amount of the additive element than the surface portions 153 and 156 or contains the additive element at a concentration lower than or equal to the lower detection limit, and thus probably has a poor function of a barrier film. Presumably, the crystal structure of the lithium cobalt oxide in the vicinity of a portion where a pit is formed is broken and differs from a layered rock-salt crystal structure. The breakage of the crystal structure inhibits diffusion and release of lithium ions that are carrier ions; thus, a pit is probably a cause of degradation of cycle performance.

A source of a pit can be a point defect. It is considered that a pit is generated when a point defect included in a positive electrode active material changes due to repetitive charging and discharging, and the positive electrode active material undergoes chemical or electrochemical erosion or degradation due to the electrolyte or the like surrounding the positive electrode active material. This degradation does not occur uniformly in the surface of the positive electrode active material but occurs locally in a concentrated manner.

In addition, like a crack 157 illustrated in FIG. 18, a defect such as a crack (also referred to as crevice) is sometimes generated by expansion and contraction of the positive electrode active material due to charging and discharging. In this specification and the like, a crack and a pit are different from each other. Immediately after formation of a positive electrode active material, a crack can exist but a pit does not exist. A pit can also be regarded as a hole formed, for example, by extraction of some layers of cobalt and oxygen due to charging and discharging under a high-voltage condition at 4.5 V or higher or at a high temperature (45° C. or higher), i.e., a portion from which cobalt has been eluted. A crack refers to, for example, a surface newly generated by application of physical pressure or a crevice generated because of the crystal grain boundary 101. A crack might be caused by expansion and contraction of a positive electrode active material due to charging and discharging. A pit might be generated from a void inside a positive electrode active material and/or a crack.

### <Example 1 of Method for Forming Positive Electrode Active Material>

An example of a method for forming the positive electrode active material that can be used as one embodiment of the present invention (Example 1 of method for forming positive electrode active material) is be described with reference to FIG. 19A to FIG. 19C. Note that the formation method described here is an example of a method for forming the positive electrode active material 100 having characteristics that have been already described in this embodiment.

### <Step S11>

In Step S11 shown in FIG. 19A, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, tricobalt tetraoxide, cobalt hydroxide, or the like can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the cobalt source preferably has high crystallinity, and preferably includes single crystal particles, for example. To evaluate the crystallinity of the transition metal source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal source.

### <Step S12>

Next, in Step S12 shown in FIG. 19A, the lithium source and the cobalt source are ground and mixed to form a mixed material. The grinding and mixing can be performed by a dry method or a wet method. A wet method is preferable because it can crush a material into a smaller size. When the grinding and mixing are performed by a wet method, a solvent is prepared. As the solvent, it is preferable to use an aprotic solvent that hardly reacts with lithium, e.g., ketone such as acetone, alcohol such as ethanol or isopropanol, ether, dioxane, acetonitrile, or N-methyl-2-pyrrolidone (NMP). In this embodiment, dehydrated acetone with a purity higher than or equal to 99.5% is used. It is preferable that the lithium source and the transition metal source be mixed into dehydrated acetone whose moisture content is less than or equal to 10 ppm and which has a purity of higher than or equal to 99.5% in the grinding and mixing. With use of dehydrated acetone with the above-described purity, impurities that might be mixed can be reduced.

A ball mill, a bead mill, or the like can be used for the mixing and the like. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, the materials mixed in the above manner are heated in Step S13 shown in FIG. 19A. The heating is preferably performed at higher than or equal to 800° C. and lower than or equal to 1100° C., further preferably at higher than or equal to 900° C. and lower than or equal to 1000° C., still further preferably at approximately 950° C. and lower than or equal to 1000° C. An excessively low temperature might lead to insufficient decomposition and melting of the lithium source and the transition metal source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. Thus, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature raising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. For example, one method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa, and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

As a crucible used at the time of the heating, a crucible made of aluminum oxide is preferable. The crucible made of aluminum oxide has a material property that hardly allows the entry of impurities. In this embodiment, a crucible made of aluminum oxide with a purity of 99.9% is used. The heating is preferably performed with the crucible covered with a lid, in which case volatilization of a material can be prevented.

The heated material is ground as needed and may be made to pass through a sieve. Before collection of the heated material, the material may be moved from the crucible to a mortar. As the mortar, an aluminum oxide mortar can be suitably used. A mortar made of aluminum oxide has a material property that hardly allows the entry of impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 19A.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, as Step S15 shown in FIG. 19A, the lithium cobalt oxide is heated. The heating in Step S15 is the first heating performed on the composite oxide and thus, this heating is sometimes referred to as the initial heating. Alternatively, the heating is performed before Step S20 described below and thus is sometimes referred to as preheating or pretreatment.

As described above, by the initial heating, a lithium compound or the like unintentionally remaining on a surface of lithium cobalt oxide is extracted. In addition, an effect of increasing the crystallinity of the inner portion 100b can be expected. The lithium source and/or the cobalt source prepared in Step S11 and the like might contain impurities. The initial heating can reduce impurities in the lithium cobalt oxide completed in Step S14. The effect of increasing the crystallinity of the internal portion 100b is, for example, an effect of reducing distortion, a shift, or the like derived from differential shrinkage or the like of the lithium cobalt oxide formed in Step S13.

Furthermore, through the initial heating, the surface of the lithium cobalt oxide becomes smooth. A smooth surface refers to a state where the lithium cobalt oxide has little unevenness and is rounded as a whole, and its corner portion is rounded. Alternatively, a smooth surface also refers to a surface to which few foreign matters are attached. Foreign matters are deemed to cause unevenness and are preferably not attached to a surface.

For the initial heating, a lithium compound source, an additive element source, or a material functioning as a fusing agent is not necessarily separately prepared.

When the heating time in this step is too short, sufficient effect is not obtained, but when the heating time in this step is too long, the productivity is lowered. For example, any of the heating conditions described for Step S13 can be selected. The heating temperature in Step S15 is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature higher than or equal to 700° C. and lower than or equal to 1000° C. for longer than or equal to 2 hours and shorter than or equal to 20 hours.

The heating in Step S13 might cause a temperature difference between the surface and the inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, it is deemed that Step S15 reduces the differential shrinkage caused in the lithium cobalt oxide to make the surface of the composite oxide smooth.

Such differential shrinkage might cause a micro shift in the lithium cobalt oxide such as a shift in a crystal. To reduce the shift, the heating in Step S15 is preferably performed. Performing Step S15 can distribute a shift uniformly in the composite oxide (reduce the shift in a crystal or the like which is caused in the composite oxide or align crystal grains). As a result, the surface of the composite oxide may become smooth.

In a secondary battery including lithium cobalt oxide with a smooth surface as a positive electrode active material, degradation by charging and discharging is inhibited and a crack in the positive electrode active material can be prevented.

Note that pre-synthesized lithium cobalt oxide may be used in Step S14. In that case, Step S11 to Step S13 can be omitted. When Step S15 is performed on the pre-synthesized lithium cobalt oxide, lithium cobalt oxide with a smooth surface can be obtained.

### <Step S20>

Next, as shown in Step S20 to Step S33, the additive element A from an A source is preferably added to the lithium cobalt oxide that has been subjected to the initial heating. When the additive element A is added to the lithium cobalt oxide that has been subjected to the initial heating, the additive element A can be uniformly added. Thus, the initial heating (Step S15) is preferably performed not after the addition of the additive element A but before the addition of the additive element A. Next, details of Step S20 of preparing the additive element A as the A source is described with reference to FIG. 19B and FIG. 19C.

### <Step S21>

Step S20 shown in FIG. 19B includes Step S21 to Step S23. In Step S21, the additive element A is prepared. As the additive element A, the additive element X and the additive element Y described in the above embodiment can be used. Specifically, one or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or more selected from bromine and beryllium can be used. FIG. 19B shows an example of the case where a magnesium source and a fluorine source are prepared. Note that in Step S21, a lithium source may be separately prepared in addition to the additive element A.

When magnesium is selected as the additive element A, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element A, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed such that LiF:MgF₂ is approximately 65:35 (molar ratio), the effect of lowering the melting point is maximized. Meanwhile, when the proportion of lithium fluoride increases, the cycling performance might be degraded because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 and the neighborhood thereof). Note that in this specification and the like, the expression “an approximate value of a given value” means greater than 0.9 times and less than 1.1 times the given value, unless otherwise specified.

### <Step S22>

Next, in Step S22 shown in FIG. 19B, the magnesium source and the fluorine source are ground and mixed. Any of the conditions for grinding and mixing that are described for Step S12 can be selected to perform this step.

Here, a heating step may be performed after Step S22 as needed. Any of the heating conditions described for Step S13 can be selected to perform the heating step. The heating time is preferably longer than or equal to 2 hours and the heating temperature is preferably higher than or equal to 800° C. and lower than or equal to 1100° C.

### <Step S23>

Next, in Step S23 shown in FIG. 19B, the materials ground and mixed in the above step are collected to obtain the additive element A source (A source). Note that the additive element A source in Step S23 contains a plurality of starting materials and can be referred to as a mixture.

As for the particle diameter of the mixture, the D50 (median diameter) is preferably greater than or equal to 600 nm and less than or equal to 20 μm, further preferably greater than or equal to 1 μm and less than or equal to 10 μm. Also when one kind of material is used as the additive element source, the D50 (median diameter) is preferably greater than or equal to 600 nm and less than or equal to 20 μm, further preferably greater than or equal to 1 μm and less than or equal to 10 μm.

Such a pulverized mixture (which may contain only one kind of the additive element) is easily attached to the surface of lithium cobalt oxide uniformly in a later step of mixing with the lithium cobalt oxide. The mixture is preferably attached uniformly to the surface of the lithium cobalt oxide, in which case the additive element is easily distributed or dispersed uniformly in the surface portion 100a of the composite oxide after heating.

### <Step S21>

A process different from that in FIG. 19B is described with reference to FIG. 19C. Step S20 shown in FIG. 19C includes Step S21 to Step S23.

In Step S21 shown in FIG. 19C, four kinds of additive element sources to be added to the lithium cobalt oxide are prepared. In other words, FIG. 19C is different from FIG. 19B in the kinds of the additive element sources. A lithium source may be separately prepared in addition to the additive element sources.

As the four kinds of added element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 19B. As a nickel source, nickel oxide, nickel hydroxide, or the like can be used. As an aluminum source, aluminum oxide, aluminum hydroxide, or the like can be used.

### <Step S22 and Step S23>

Next, Step S22 and Step S23 shown in FIG. 19C are similar to the steps described with reference to FIG. 19B.

### <Step S31>

Next, in Step S31 shown in FIG. 19A, the lithium cobalt oxide and the additive element source (A source) are mixed. The atomic ratio of cobalt Co in the lithium cobalt oxide to magnesium Mg contained in the additive element A source (A source) is preferably Co:Mg=100:y (0.1≤y≤6), further preferably M:Mg=100:y (0.3≤y≤3).

The condition of the mixing in Step S31 is preferably milder than that of the mixing in Step S12 not to damage the lithium cobalt oxide shape. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 of FIG. 19A, the materials mixed in the above manner are collected to obtain a mixture 903. At the time of the collection, the materials may be crushed as needed and made to pass through a sieve.

Note that although FIG. 19A to FIG. 19C show the formation method in which addition of the additive element is performed only after the initial heating, the present invention is not limited to the above-described method. The addition of the additive element may be performed at another timing or may be performed a plurality of times. The timing of the addition may be different between the elements.

For example, the additive element may be added to the lithium source and the transition metal source in Step S11, i.e., at the stage of the starting materials of the composite oxide. Then, lithium cobalt oxide containing the additive element can be obtained in Step S13. In that case, there is no need to separately perform Step S11 to Step S14 and Step S21 to Step S23. This method can be regarded as being simple and highly productive.

Alternatively, lithium cobalt oxide that contains some of the additive elements in advance may be used. When lithium cobalt oxide to which magnesium and fluorine are added is used, for example, Step S11 to Step S14 and part of Step S20 can be skipped. This method can be regarded as being simple and highly productive.

Alternatively, after the heating in Step S15 is performed, to lithium cobalt oxide to which magnesium and fluorine are added in advance, a magnesium source and a fluorine source, or a magnesium source, a fluorine source, a nickel source, and an aluminum source may be further added as in Step S20.

### <Step S33>

Then, in Step S33 shown in FIG. 19A, the mixture 903 is heated. Any of the heating conditions described for Step S13 can be selected. The heating time is preferably longer than or equal to 2 hours. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements included in lithium cobalt oxide and the additive element source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Note that the reaction more easily proceeds at a temperature higher than or equal to the temperature at which one or more selected from the materials contained in the mixture 903 are melted. For example, in the case where LiF and MgF₂ are included in the added element source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC). Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably higher than that in Step S13.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a flux in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and formation of the positive electrode active material having favorable characteristics.

However, since LiF in a gas phase has a specific gravity less than that of oxygen, heating might volatilize or sublimate LiF and in that case, LiF in the mixture 903 decreases. As a result, the function of a fusing agent deteriorates. Thus, heating needs to be performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is preferably controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

When the median diameter (D50) of the lithium cobalt oxide in Step S14 in FIG. 19A is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than or equal to 10 hours and shorter than or equal to 50 hours.

In the case where the lithium cobalt oxide in Step S14 has a median diameter (D50) of approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 19A, in which crushing is performed as needed; thus, the positive electrode active material 100 is obtained. Here, the collected positive electrode active material 100 is preferably made to pass through a sieve. Through the above steps, the positive electrode active material 100 having the features described in this embodiment can be formed.

### <Example 2 of Method for Forming Positive Electrode Active Material>

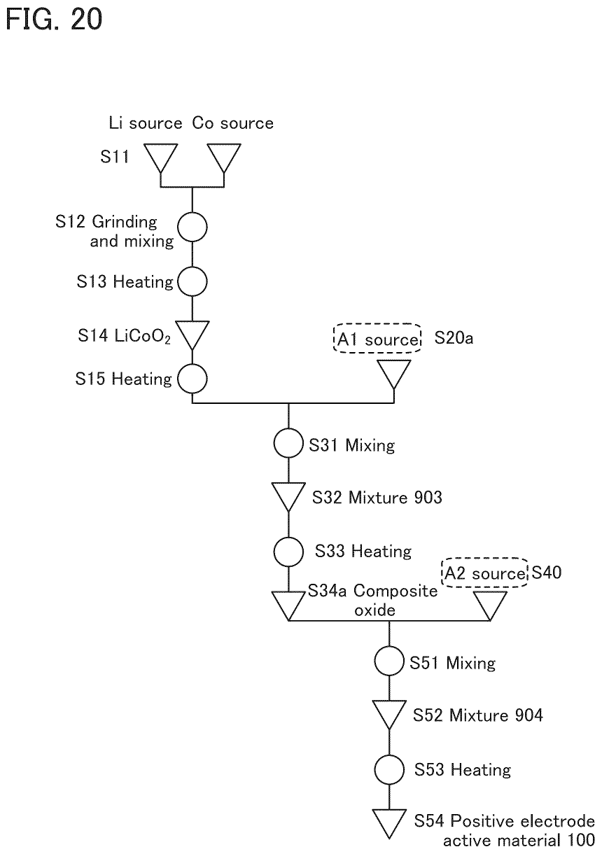

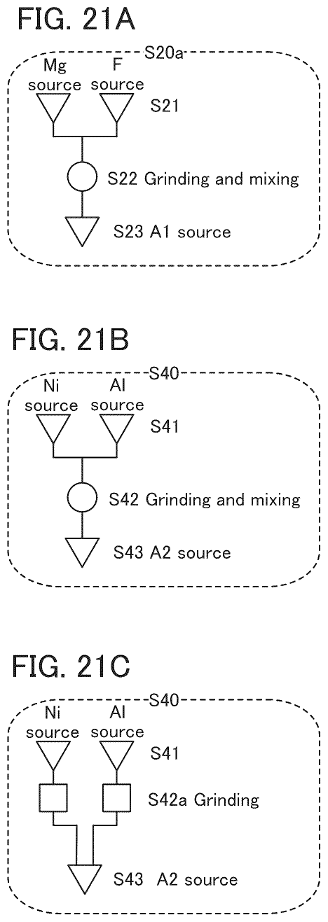

Another example of a method for forming the positive electrode active material that can be used as one embodiment of the present invention (Example 2 of method for forming positive electrode active material) is described with reference to FIG. 20 to FIG. 21. Although Example 2 of method for forming positive electrode active material is different from Example 1 of method for forming positive electrode active material described above in the number of times of adding the additive element and a mixing method, for the description except for the above, the description of Example 1 of method for forming positive electrode active material can be referred to.

Steps S11 to S15 in FIG. 20 are performed as in FIG. 19A to prepare lithium cobalt oxide that has been subjected to the initial heating.

### <Step S20a>

Next, as shown in Step S20a to Step S33, an additive element A1 is preferably added to the lithium cobalt oxide that has been subjected to the initial heating. Step S20a is a step of preparing a first additive element source (A1 source) used to add the additive element A1, and is described with reference to FIG. 21A.

### <Step S21>

In Step S21 to Step S23 shown in FIG. 21A, the first additive element source (A1 source) is prepared. The additive element A1 can be selected from the additive elements A described for Step S21 with reference to FIG. 19B to be used. For example, one or more selected from magnesium, fluorine, and calcium can be used as the additive element A1. FIG. 21A shows an example of the case where a magnesium source (Mg source) and a fluorine source (F source) that are ground and mixed are used as the A1 source.

Step S21 to Step S23 shown in FIG. 21A can be performed under the same conditions as those in Step S21 to Step S23 shown in FIG. 19B. As a result, the first additive element source (A1 source) can be obtained in Step S23.

Steps S31 to S33 shown in FIG. 20 can be performed under the same conditions as those of Steps S31 to S33 shown in FIG. 19A.

### <Step S34a>

Next, the material heated in Step S33 is collected to form lithium cobalt oxide containing the additive element A1. Here, this lithium cobalt oxide is called a second composite oxide to be distinguished from the composite oxide (a first composite oxide) in Step S14.

### <Step S40>

In Step S40 to Step S53 shown in FIG. 20, an additive element A2 is added to the second composite oxide. Step S40 is a step of preparing a second additive element source (A2 source) used to add the additive element A2, and is described with reference to FIG. 21B and FIG. 21C.

### <Step S41>

In Step S41 to Step S43 shown in FIG. 21B, the second additive element source (A2 source) is prepared. The additive element A2 can be selected from the above-described additive elements A described for Step S21 shown in FIG. 19B. For example, one or more selected from nickel, titanium, boron, zirconium, and aluminum can be suitably used as the additive element A2. FIG. 21B an example of the case where a nickel source and an aluminum source that are ground and mixed are used as the A2 source.

Step S41 to Step S43 shown in FIG. 21B can be performed under the same conditions as those in Step S21 to Step S23 shown in FIG. 19B. As a result, the second additive element source (A2 source) can be obtained in Step S43.

FIG. 21C showing Step S41 to Step S43 is a variation example of FIG. 21B. A nickel source (Ni source) and an aluminum source (A1 source) are prepared in Step S41 shown in FIG. 21C and are separately ground in Step S42a. Accordingly, a plurality of the second additive element sources (A2 sources) are prepared in Step S43. FIG. 21C is different from FIG. 21B in separately grinding the additive elements in Step S42a.

### <Step S51 to Step S53>

Next, Step S51 to Step S53 shown in FIG. 20 can be performed under the same conditions as those in Step S31 to Step S33 shown in FIG. 19A. The heating in Step S53 can be performed under such condition as a lower temperature and a shorter time than those of the heating in Step S33.

### <Step S54>

Next, the heated material is collected in Step S54 shown in FIG. 20, in which crushing is performed as needed; thus, the positive electrode active material 100 is obtained. Through the above steps, the positive electrode active material 100 having the features described in this embodiment can be formed.

As shown in FIG. 20 and FIG. 21, in the formation method 2, introduction of the additive element to the lithium cobalt oxide is divided into introduction of the first additive element A1 and that of the second additive element A2. When the elements are separately introduced, the additive elements can have different profiles in the depth direction. For example, the first additive element can have a profile such that the concentration is higher in the surface portion than in the inner portion, and the second additive element can have a profile such that the concentration is higher in the inner portion than in the surface portion.

The contents of this embodiment can be freely combined with the contents of the other embodiments.

### Embodiment 3

This embodiment describes examples of shapes of several types of secondary batteries including a positive electrode or a negative electrode formed by the formation method described in the above embodiment.

### [Coin-Type Secondary Battery]

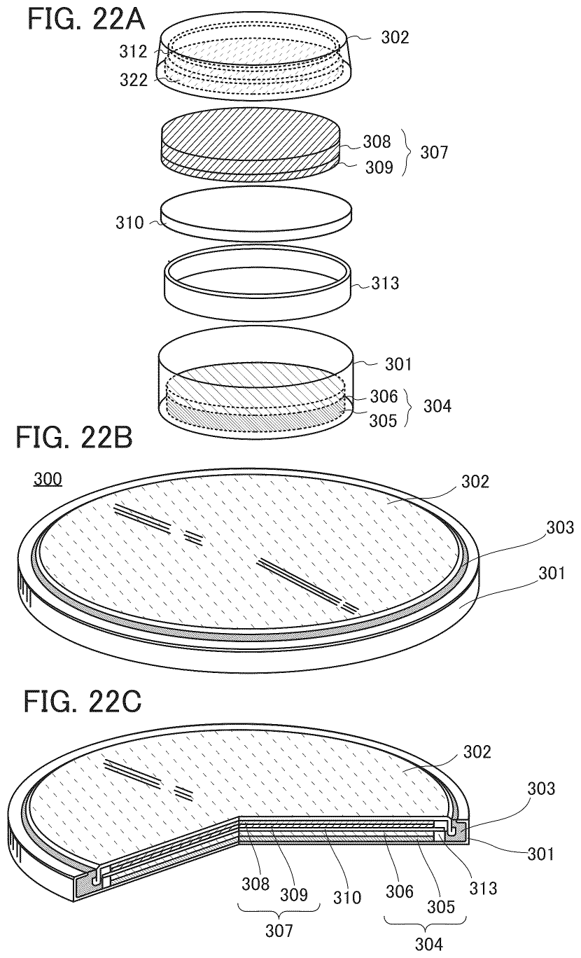

An example of a coin-type secondary battery is described. FIG. 22A is an exploded perspective view of a coin-type (single-layer flat type) secondary battery, FIG. 22B is an external view thereof, and FIG. 22C is a cross-sectional view thereof. Coin-type secondary batteries are mainly used in small electronic devices.

For easy understanding, FIG. 22A is a schematic view illustrating overlap (a vertical relation and a positional relation) between components. Thus, FIG. 22A and FIG. 22B do not completely correspond with each other.

In FIG. 22A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 22A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 22B is a perspective view of a completed coin-type secondary battery.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 22C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above-described structure, the coin-type secondary battery 300 can have high capacity, high charge and discharge capacity, and excellent cycle performance.

### [Cylindrical Secondary Battery]

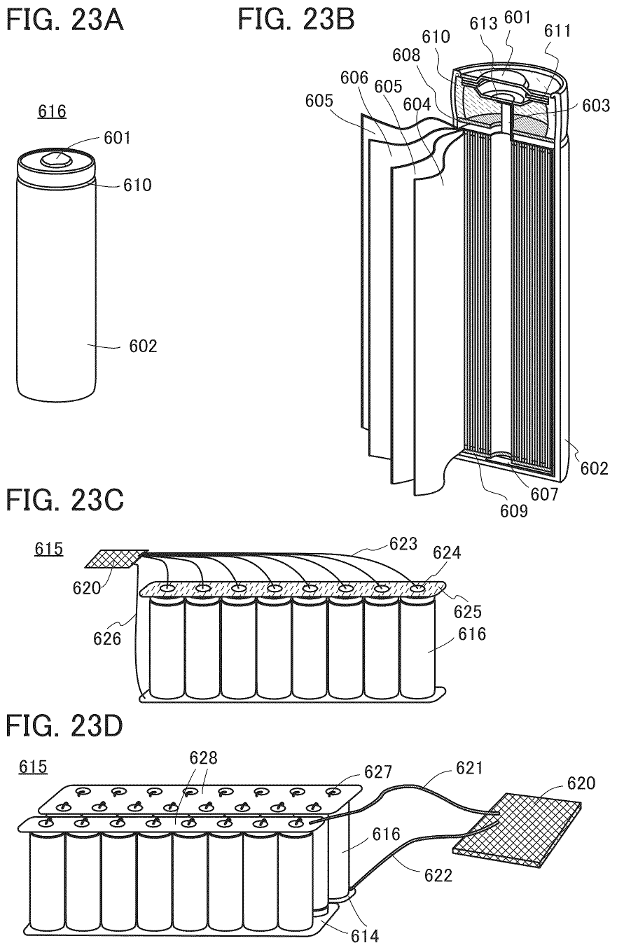

An example of a cylindrical secondary battery is described with reference to FIG. 23A. As illustrated in FIG. 23A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 23B schematically illustrates a cross section of a cylindrical secondary battery. The cylindrical secondary battery illustrated in FIG. 23B includes the positive electrode cap (battery cap) 601 on the top surface and the battery can (outer can) 602 on the side surface and bottom surface. The positive electrode cap 601 and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a central axis. One end of the battery can 602 is close and the other end thereof is open. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not shown) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector.

The positive electrode active material 100 obtained in Embodiments 1, 2, and the like is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 23C illustrates an example of a power storage system 615. The power storage system 615 includes a plurality of the secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like or a protection circuit for preventing overcharging and/overdischarging can be used.

FIG. 23D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 23D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

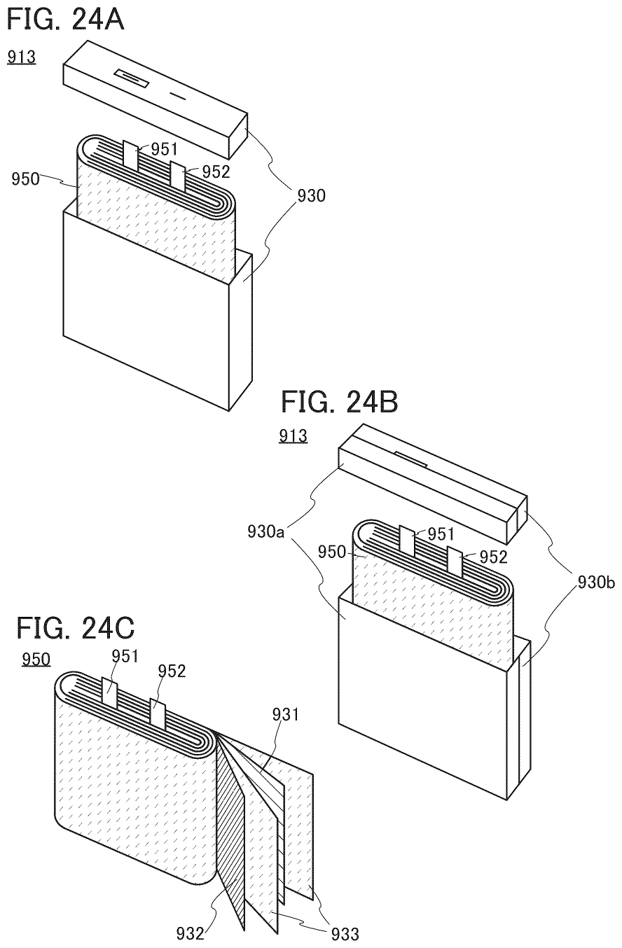

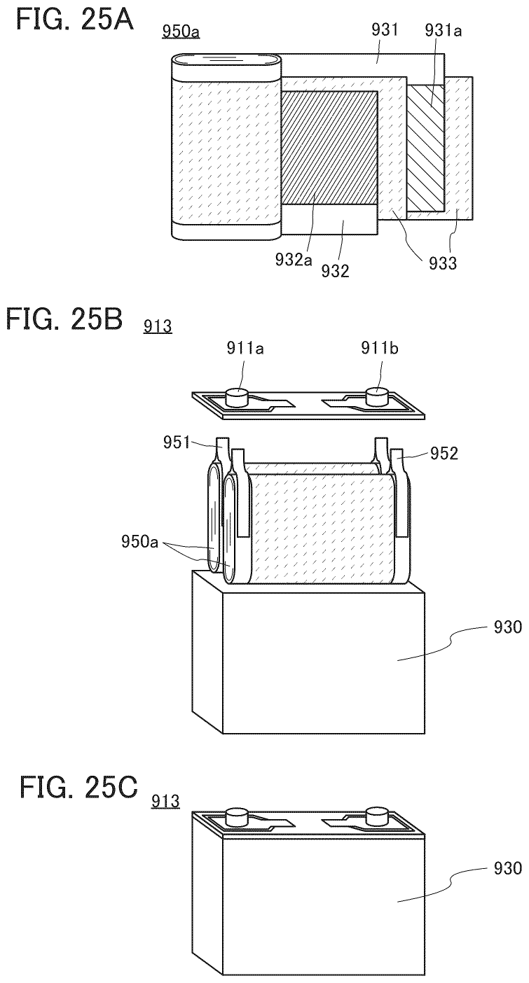

Structure examples of secondary batteries are described with reference to FIG. 24 and FIG. 25.

A secondary battery 913 illustrated in FIG. 24A includes a wound body 950 provided with a terminal 951 and a terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 24A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 24B, the housing 930 in FIG. 24A may be formed using a plurality of materials. For example, in the secondary battery 913 illustrated in FIG. 24B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 24C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 25, the secondary battery 913 may include a wound body 950a. The wound body 950a illustrated in FIG. 25A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiments 1, 2, and the like is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 25B, the negative electrode 931 is electrically connected to a terminal 951 by ultrasonic bonding, welding, or pressure bonding. The terminal 951 is electrically connected to a terminal 911a. The positive electrode 932 is electrically connected to a terminal 952 by ultrasonic bonding, welding, or pressure bonding. The terminal 952 is electrically connected to a terminal 911b.

As illustrated in FIG. 25C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 25B, the secondary battery 913 may include a plurality of wound bodies 950a. The use of the plurality of wound bodies 950a enables the secondary battery 913 to have higher discharge capacity. The description of the secondary battery 913 illustrated in FIG. 24A to FIG. 24C can be referred to for the other components of the secondary battery 913 illustrated in FIG. 25A and FIG. 25B.

### <Laminated Secondary Battery>

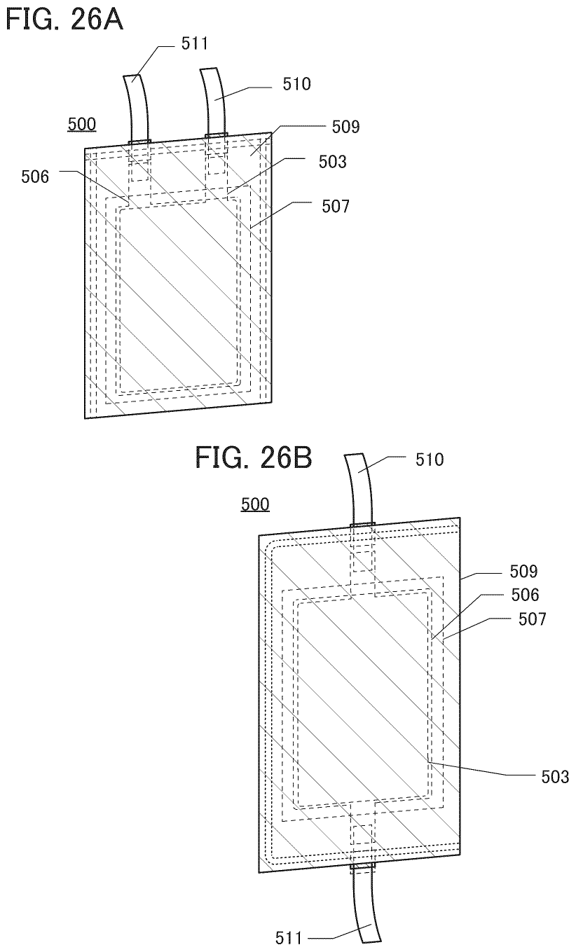

Next, examples of the appearance of a laminated secondary battery are illustrated in FIG. 26A and FIG. 26B. FIG. 26A and FIG. 26B each include a positive electrode 503, a negative electrode 506, a separator 507, an exterior body 509, a positive electrode lead electrode 510, and a negative electrode lead electrode 511.

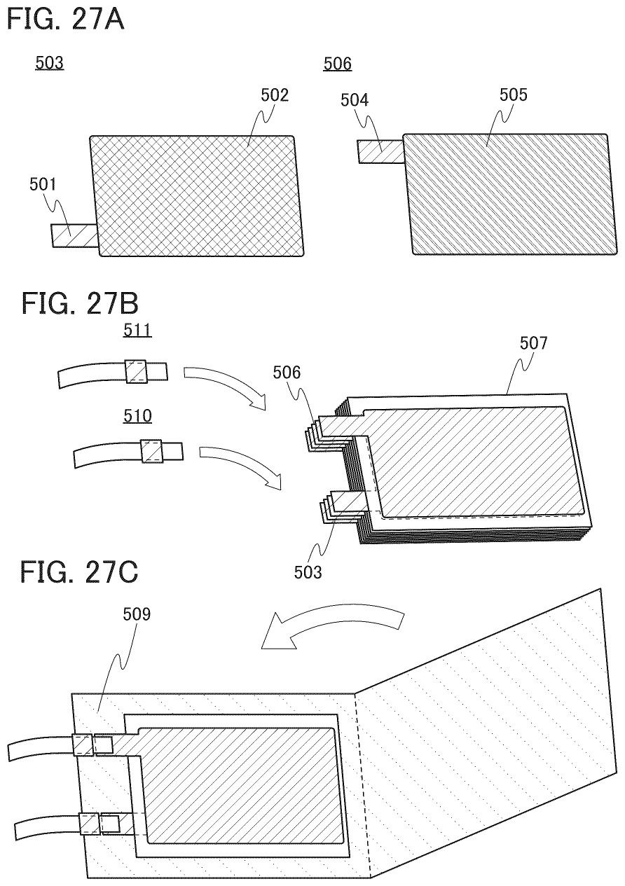

FIG. 27A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to the examples shown in FIG. 27A.

### <Fabrication Method of Laminated Secondary Battery>

An example of a method for fabricating the laminated secondary battery whose external view is illustrated in FIG. 26A is described with reference to FIG. 27B and FIG. 27C.

First, the negative electrode 506, the separator 507, and the positive electrode 503 are stacked. FIG. 27B illustrates the negative electrodes 506, the separators 507, and the positive electrodes 503 that are stacked. Here, an example in which five negative electrodes and four positive electrodes are used is shown. The stacked negative electrodes, separators, and positive electrodes can be referred to as a stack. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 27C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The positive electrode active material 100 obtained in Embodiments 1, 2, and the like is used for the positive electrode 503, whereby the secondary battery 500 can have high capacity, high charge and discharge capacity, and excellent cycle performance.

### [Examples of Battery Pack]

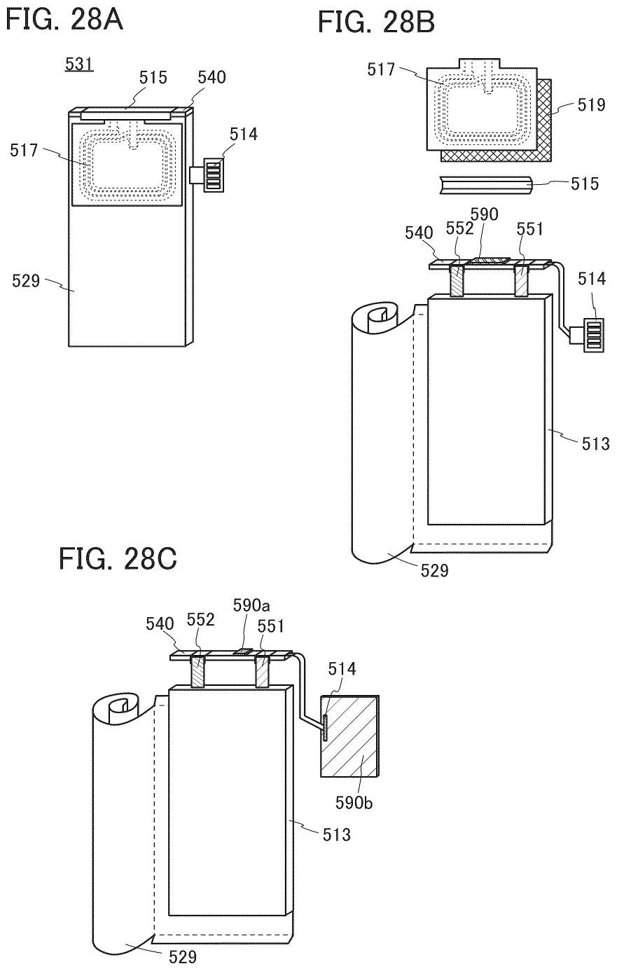

Examples of a secondary battery pack of one embodiment of the present invention that is capable of wireless charging using an antenna is described with reference to FIG. 28.

FIG. 28A is a diagram illustrating the appearance of a secondary battery pack 531 that has a rectangular solid shape with a small thickness (also referred to as a flat plate shape with a certain thickness). FIG. 28B illustrates a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 28B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 28C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents of this embodiment can be freely combined with the contents of the other embodiments.

### Embodiment 4

In this embodiment, a structure example of a bendable battery (also referred to as a flexible battery) and examples of a fabricating method thereof will be described.

### [Bendable Secondary Battery]

One embodiment of the present invention is a bendable battery. For an exterior body of the battery, a film in the shape of a periodic wave in one direction is used. The use of the wave shape for the exterior body relieves stress when the exterior body is bent because the form of the exterior body changes such that the period and amplitude of the wave are changed, preventing the exterior body from being damaged.

An electrode stack included in a battery of one embodiment of the present invention is characterized in that a portion to which a tab or the like is connected is fixed and the relative positions of electrodes are shifted in the other portion. When the exterior body of the battery is bent, the electrode stack can change its shape with the fixed point used as a support such that the relative positions of the electrodes are shifted.

One embodiment of the present invention further includes a space in an area surrounded by the exterior body and between an end portion of the electrode stack that is not fixed and an inner wall of the exterior body. The space allows the electrode stack to shift when the battery is bent, preventing the portion of the electrode stack and the inner wall of the exterior body from coming in contact with each other. One embodiment of the present invention can prevent the exterior body from being broken by the contact between the electrode stack and the exterior body accompanying the change in the form of the electrode stack, regardless of the thickness of the electrode stack. For example, even in the case where the thickness of the battery is larger than 400 μm, larger than or equal to 500 μm, or larger than or equal to 1 mm, changing the form, such as bending, can be safely repeated. It is needless to say that one embodiment of the present invention can also be used for a very thin battery with a thickness of greater than or equal to 1 μm and less than or equal to 400 μm.

There is no limitation on the thickness of the battery as long as it is determined in accordance with the capacity required for an electronic device into which the battery is incorporated, the shape of the device, or the like so that the thickness is suitable for a use. For example, the thickness is smaller than or equal to 10 mm, preferably smaller than or equal to 5 mm, further preferably smaller than or equal to 4 mm, still further preferably smaller than or equal to 3 mm.

To form a larger space between the inner wall of the exterior body and the electrode stack, the phases of waves of a pair of portions of the exterior body between which the electrode stack is sandwiched are preferably different from each other. Specifically, it is preferred that wave crest lines of one of the pair of portions between which the electrode stack is located not overlap with wave trough lines of the other portion. It is particularly preferred that the phases of the waves of the pair of portions of the exterior body between which the electrode stack is located be different from each other by 180° so that wave crest lines overlap with each other and wave trough lines overlap with each other. In that case, a space that ensures the largest distance between the electrode stack and the exterior body can be formed. In contrast, it is not preferred that the phases of the waves of the pair of portions be coordinate so that wave crest lines of one of the portions overlap with wave trough lines of the other portion. In that case, a space is formed to be distorted and the distance between the electrode stack and the exterior body is the shortest.

One embodiment of the present invention can be fabricated, for example, in such a manner that a film is folded in half in the direction parallel to wave crest lines and wave trough lines with an electrode stack therebetween and bonding is performed by application of pressure and heat such that at least two sides perpendicular to the folded portion become flat. Furthermore, it is preferred that the film be folded in half such that the phases of waves of opposite portions of the film are at least different from each other. It is particularly preferred that the film be folded such that the phases of the waves are different from each other by 180°.

Here, the phases of the waves of the pair of portions of the exterior body between which the electrode stack is sandwiched might be changed after the bonding. Even in that case, at least a region adjacent to the folded portion preferably includes a portion in which the phases of the waves of the pair of portions are different from each other, after the bonding.

The bonding makes the two sides of the film between which the electrode stack is located longer than the natural length before the bonding. This generates tensile force in the direction perpendicular to wave crest lines and wave trough lines in a portion overlapping with the electrode stack. Meanwhile, reaction in the direction opposite to that of the tensile force occurs in the portion overlapping with the electrode stack so that the wave shape is maintained. The reaction decreases as the distance from the folded portion decreases; thus, the exterior body changes its shape such that the wave thereof is stretched as the distance from the folded portion decreases. Specifically, the exterior body changes its shape such that the length of the wave period increases and the wave amplitude decreases as the distance from the folded portion decreases. Through such a mechanism, the bonding is performed such that a bonding portion becomes sufficiently flat, whereby a space can be formed between the folded portion and the electrode stack.

The shape of the wave of the film is important for formation of an enough space between the inner wall of the exterior body and the electrode stack. A larger space can be formed as the length of the wave period of the film decreases and the wave amplitude increases. For example, a film in the wave shape is preferably used for the exterior body, in which the ratio of the length of the film when it is stretched to the natural length thereof is 1.02 or more, preferably 1.05 or more, further preferably 1.1 or more, and 2 or less. Any of a variety of shapes such as a sine-wave shape, a triangular-wave shape, an arc shape, and a rectangular shape can be used as the wave shape as long as the wave shape has at least repeated projections and depressions in one direction. A large wave amplitude might increase the volume of the battery; thus, the length of the wave period is preferably set small so that the ratio of the length of the film when it is stretched to the natural length thereof is high.

Conditions for the bonding are also important for formation of an enough space. Insufficient bonding might result in a wavy shape of the bonding portion instead of a flat shape, failing to form an enough space. Moreover, insufficient bonding might form a gap in the bonding portion when the battery changes its form, because the bonding is performed with the phases of the waves different from each other. However, the use of an optimized bonding method can avoid such problems. Preferred conditions for the bonding depend on a material of the film, a material of an adhesive used for the bonding, or the like; for example, in the case where polypropylene is used for a heat-sealing layer, pressure that enables planarization of an embossed wave shape is applied at a temperature higher than or equal to the melting point of polypropylene. Furthermore, it is preferred that the bonding be performed by applying a high pressure to a portion of the bonding portion in the direction perpendicular to the embossed wave shape (side sealing portion) compared with a portion of the bonding portion in the direction parallel to the embossed wave shape (top sealing portion).

Since one embodiment of the present invention allows the shape of a secondary battery to be freely designed, when a secondary battery having a curved surface is used, for example, the design flexibility of the whole electronic device is increased, and electronic devices having a variety of designs can be provided. Furthermore, when the secondary battery is provided along the inner surface of an electronic device having a curved surface, a space in the electronic device can be effectively used with no waste.

Furthermore, one embodiment of the present invention can increase the capacity of a secondary battery; accordingly, an electronic device can be used for a long time with a low frequency of charging.

Thus, an electronic device having a novel structure can be provided.

More specific structure examples and a fabrication method example will be described below with reference to drawings.

### [Structure Example]

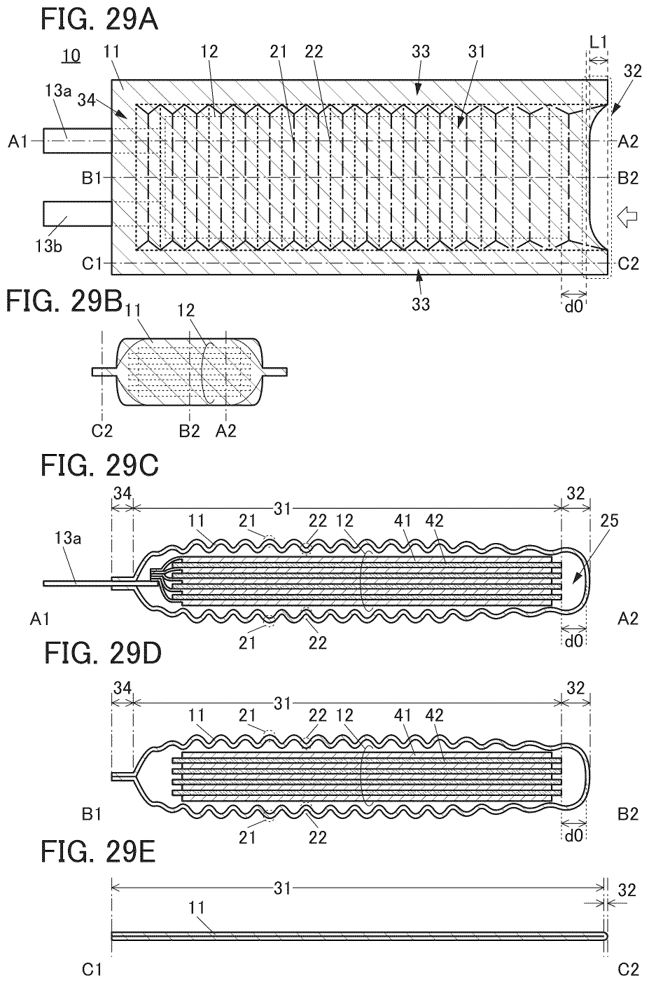

FIG. 29A is a plan view of a battery 10 described below as an example. FIG. 29B is a view of the battery 10 seen from the direction shown by an arrow in FIG. 29A. FIG. 29C, FIG. 29D, and FIG. 29E are schematic cross-sectional views taken along A1-A2, B1-B2, and C1-C2 in FIG. 29A, respectively.

The battery 10 includes an exterior body 11, a stack 12 held in the exterior body 11, and an electrode 13a and an electrode 13b that are electrically connected to the stack 12 and extend to the outside of the exterior body 11. In addition to the stack 12, an electrolyte is enclosed in the exterior body 11.

The exterior body 11 has a film-like shape and is folded in half so as to sandwich the stack 12. The exterior body 11 includes a pair of portions 31 between which the stack is sandwiched, a folded portion 32, a pair of bonding portions 33, and a bonding portion 34. The pair of bonding portions 33 is belt-like portions extending in the direction substantially perpendicular to the folded portion 32 and is provided with a portion 31 therebetween. The bonding portion 34 is a belt-like portion located opposite to the folded portion 32 with the portion 31 therebetween. The portion 31 can also be referred to as a region surrounded by the folded portion 32, the pair of bonding portions 33, and the bonding portion 34. Here, the electrode 13a and the electrode 13b are partly sandwiched by the bonding portion 34 in FIG. 29A and the like.

At least a surface of the portion 31 of the exterior body 11 has a wave shape in which projections and depressions are repeated in the direction in which the pair of bonding portions 33 extends. In other words, the portion 31 has a wave shape in which crest lines 21 and trough lines 22 are alternately repeated. In FIG. 29A and the like, the crest lines 21 connecting top portions of the projections are shown by dashed-dotted lines, and the trough lines 22 connecting bottom portions of the troughs are shown by dashed lines.

In the plan view of the exterior body 11, the length of each bonding portion 33 in the extension direction is longer than the total length of the bonding portion 34, the portion 31, and the folded portion 32 in the direction parallel to the extension direction of the bonding portion 33. As illustrated in FIG. 29A, a portion of the folded portion 32 that is located closest to the bonding portion 34 is closer to the bonding portion 34 by a distance L1 from a line connecting end portions of the pair of bonding portions 33 on the folded portion 32 side.

The stack 12 at least has a structure where positive electrodes and negative electrodes are alternately stacked. The stack 12 can also be called an electrode stack. Furthermore, separators may be provided between the positive electrodes and the negative electrodes. Here, as the number of layers in the stack 12 increases, the capacity of the battery 10 can increase. The details of the stack 12 will be described later.

Here, the thickness of the stack 12 is, for example, larger than or equal to 200 μm and smaller than or equal to 9 mm, preferably larger than or equal to 400 μm and smaller than or equal to 3 mm, further preferably larger than or equal to 500 μm and smaller than or equal to 2 mm, and is typically approximately 1.5 mm.

As illustrated in FIG. 29A, FIG. 29C, and FIG. 29D, in the exterior body 11, a space 25 (also referred to as a gap or a hollow) is provided between an end portion of the stack 12 that is closest to the folded portion 32 and an interior surface of the exterior body 11 that is located in the folded portion 32. Here, the length of the space 25 in the direction parallel to the extending direction of the bonding portions 33 is represented by a distance d0. The distance d0 can also be referred to as the distance between the end portion of the stack 12 that is closest to the folded portion 32 and the interior surface of the exterior body 11 that is located in the folded portion 32.

The stack 12 is bonded to the electrode 13a (and the electrode 13b) extending inside and outside the area surrounded by the exterior body 11 through the bonding portion 34. Thus, it can also be said that the relative positions of the stack 12 and the exterior body 11 are fixed by the bonding portion 34. The electrode 13a is bonded to the plurality of positive electrodes or the plurality of negative electrodes in the stack 12, and the electrode 13b is connected to the plurality of positive electrodes or the plurality of negative electrodes to which the electrode 13a is not bonded.

Furthermore, as illustrated in FIG. 29A, FIG. 29C, and FIG. 29D, it is preferred that the portion 31 of the exterior body 11 include a region in which the length of the wave period increases and the wave amplitude decreases as the distance from the folded portion 32 decreases. When the battery 10 is fabricated to have such a structure, the space 25 can be formed in the area surrounded by the exterior body 11.

As illustrated in FIG. 29C and FIG. 29D, it is best the pair of portions 31 between which the stack 12 is sandwiched face each other such that the phases of the waves of the portions 31 are different from each other by 180°. In other words, it is preferred that the exterior body 11 be folded with the stack 12 therebetween such that the crest lines 21 overlap with each other and the trough lines 22 overlap with each other. In that case, the space 25 with a favorable shape can be provided.

### [Space]

Next, the bent form of the battery provided with the space 25 will be described.

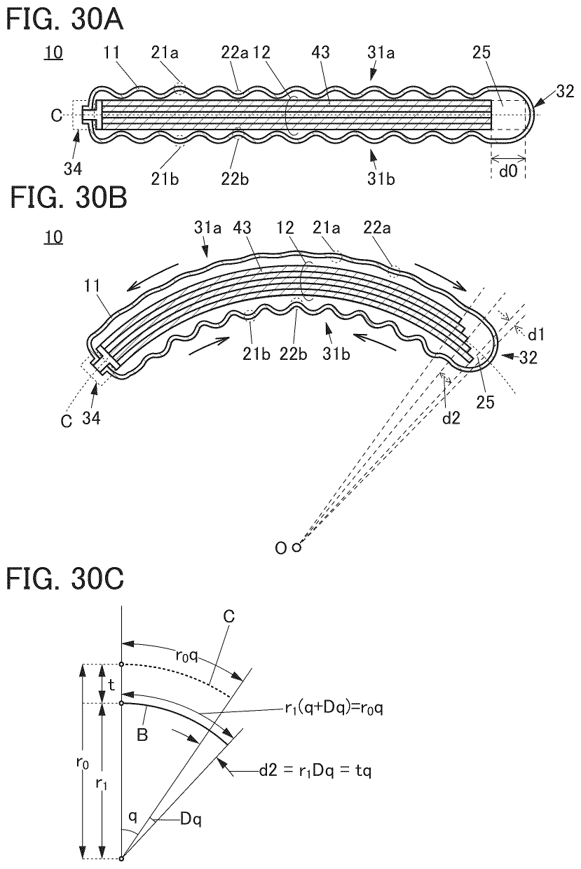

FIG. 30A is a simple schematic cross-sectional view of the structure of the battery 10 that is partly illustrated.

Here, the pair of portions 31 of the exterior body 11 is distinguished from each other and shown as a portion 31a and a portion 31b. Similarly, respective crest lines and respective trough lines of the portion 31a and the portion 31b are shown as a crest line 21a and a crest line 21b, and a trough line 22a and a trough line 22b.

In FIG. 30A, the stack 12 has a structure in which five electrodes 43 are stacked. The electrode 43 corresponds to the electrode 41 or the electrode 42 in FIG. 29A. The relative positions of the plurality of electrodes 43 are fixed at an end portion on the bonding portion 34 side. The relative positions of the stack 12 and the exterior body 11 are fixed by the bonding portion 34.

In the area surrounded by the exterior body 11, the space 25 is provided in the vicinity of the folded portion 32. Here, the distance between the inner wall of the exterior body 11 and the end portion of the electrode 43 on the folded portion 32 side when the exterior body 11 is not bent is assumed to be the distance d0.

The neutral plane of the battery 10 is referred to as a neutral plane C. Here, the neutral plane C corresponds to the neutral plane of the electrode 43 that is located in the middle of the five electrodes 43 included in the stack 12.

FIG. 30B is a schematic cross-sectional view of the battery 10 in the state of being bent with a point O at the center to have an arc shape. Here, the battery 10 is bent such that the portion 31a faces outward and the portion 31b faces inward.

As illustrated in FIG. 30B, the portion 31a that is positioned on the outer side changes its form such that the wave amplitude becomes smaller and the length of the wave period becomes larger. In other words, the distance between the crest lines 21a of the portion 31a that is positioned on the outer side and the distance between the trough lines 22b increase. By contrast, a portion 31b that is positioned on the inner side changes its form such that the wave amplitude becomes larger and the length of the wave period becomes shorter. In other words, the distance between the crest lines 21b and the distance between the trough lines 22b of the portion 31b that is positioned on the inner side and is in the state of being bent decrease. In such a manner, the portion 31a and the portion 31b change their forms, whereby stress applied to the exterior body 11 is relieved, and the battery 10 can be bent without any damage to the exterior body 11.

As illustrated in FIG. 30B, the stack 12 changes its form such that the relative positions of the plurality of electrodes 43 are shifted. This relieves stress applied to the stack 12, allowing the battery 10 to be bent without any damage to the stack 12. It is assumed in FIG. 30B that the electrodes 43 themselves do not stretch due to a bend. When the thickness of the electrode 43 is set sufficiently small with respect to the curvature radius with which the battery 10 is bent, less stress is applied to the electrodes 43 themselves.

The end portions of the electrodes 43 included in the stack 12 that are located outward from the neutral plane C shift to the bonding portion 34 side.

In contrast, the end portions of the electrodes 43 located inward from the neutral plane C shift to the folded portion 32 side. Here, the distance between the inner wall of the exterior body 11 and the end portion of the innermost electrode 43 on the folded portion 32 side decreases from the distance d0 to a distance d1. Here, the amount of relative deviation between the electrode 43 located on the neutral plane C and the innermost electrode 43 is assumed to be a distance d2. The distance d1 corresponds to a value obtained by subtracting the distance d2 from the distance d0.

In the case where the distance d0 before bending is smaller than the distance d2 after bending, the electrodes 43 of the stack 12 that are located inward from the neutral plane C come in contact with the inner wall of the exterior body 11. Thus, a required value of the distance d0 will be described below.

Description will be given below with reference to FIG. 30C. In FIG. 30C, a curve corresponding to the neutral plane C is shown by a dashed line, and a curve corresponding to the innermost surface of the stack 12 is shown as a curve B by a solid line.

A curve C is the arc of a radius r₀, and the curve B is the arc of a radius r₁. The difference between the radius r₀ and the radius r₁ is assumed to be t. Here, t corresponds to half of the thickness of the stack 12. The arc lengths of the curve C and the curve B are equal to each other. The arc angle of the curve C is assumed to be θ, and the arc angle of the curve B is assumed to be θ+Δθ.

The distance d2, which is the amount of difference between the edge of the curve C and that of the curve B, is calculated from the above relation as follows.

$$\begin{matrix}d 2 = {r}_{1} \times Δ θ \\ = t \times θ\end{matrix} \qquad [ Formula 1 ]$$

This indicates that the distance d2 can be estimated from the thickness of the stack 12 and the bending angle and does not depend on the length of the stack 12 and the bending curvature radius, for example.

Setting the distance d0 of the space 25 larger than or equal to the distance d2 as described above can prevent the stack 12 and the exterior body 11 from coming in contact with each other when the battery 10 is bent. Thus, in the case where the battery 10 including the stack 12 with a thickness of 2t is used while being bent and the maximum angle at which the battery 10 is bent is θ°, the distance d0 between the stack 12 and the inner wall of the exterior body 11 in the space 25 is set to a value greater than or equal to t×θ.

For example, when the battery is used while being bent at 30°, the distance d0 of the space 25 is set to a value greater than or equal to πt/6. Similarly, when the battery is used while being bent at 60°, the distance d0 is set to a value greater than or equal to πt/3; when the battery is used while being bent at 90°, the distance d0 is set to a value greater than or equal to πt/2; and when the battery is used while being bent at 180°, the distance d0 is set to a value greater than or equal to πt.

For example, in the case where the battery 10 is not used in the state of being wound, the maximum bending angle of the battery 10 is estimated to be 180°. Thus, when the battery 10 is used in such a manner, the distance d0 is set to a value larger than or equal to πt, preferably larger than πt, whereby the battery 10 can be used for all devices. The battery 10 can be incorporated into a variety of electronic devices in which the battery 10 is used in the state of being bent to have a V shape or a U shape, for example, the battery 10 is used in the state of being folded in half. In the case where the battery 10 is wound so as to circle around a cylindrical object once, the distance d0 of the space 25 is set to a value larger than or equal to 2πt so that the battery 10 can be bent at 360°. In the case where the battery 10 is wound so as to circle around a cylindrical object more than once, the distance d0 of the space 25 is set to an appropriate value accordingly. In the case where the battery 10 is changed in form to have a bellows shape, the distance d0 of the space 25 is set to an appropriate value depending on the direction, the angle, and the number of bending portions of the battery 10.

The above is the description of the space 25.

### [Fabrication Method Example]

An example of a method for fabricating the battery 10 will be described below.

First, a flexible film to be the exterior body 11 is prepared.

For the film, a material with high water resistance and high gas resistance is preferably used. As the film used as the exterior body, a layered film in which a metal film and an insulator film are stacked is preferably used. The metal film can be formed using any of the metals that can have the form of a metallic foil, such as aluminum, stainless steel, nickel steel, gold, silver, copper, titanium, chromium, iron, tin, tantalum, niobium, molybdenum, zirconium, and zinc, or an alloy thereof. As the insulator film, a single-layer film selected from a plastic film made of an organic material, a hybrid material film containing an organic material (e.g., an organic resin or fiber) and an inorganic material (e.g., ceramics), and a carbon-containing inorganic film (e.g., a carbon film or a graphite film), or a layered film including two or more of the above films can be used. A metal film is easily embossed. Forming projections by embossing increases the surface area of the metal film exposed to outside air, achieving efficient heat dissipation.

Then, the flexible film is processed by, for example, embossing to form the exterior body 11 having a wave shape.

The projections and depressions of the film can be formed by pressing (e.g., embossing). In the projections and depressions formed on of the film by embossing, an enclosed space whose inner volume is variable is formed with the film serving as part of a wall of a sealing structure. This enclosed space can be said to be formed because the film has an accordion structure or a bellows structure. The sealing structure using the film can prevent entry of water and dust. Note that embossing, which is a kind of pressing, is not necessarily employed and any method that allows formation of a relief on part of the film may be employed. A combination of methods, for example, embossing and any other pressing, may be performed on one film. Alternatively, embossing may be performed on one film more than once.

The projections of the film can have a hollow semicircular shape, a hollow semi-oval shape, a hollow polygonal shape, or a hollow irregular shape. In the case of a hollow polygonal shape, it is preferable that the polygon have more than three corners, in which case stress concentration at the corners can be reduced.

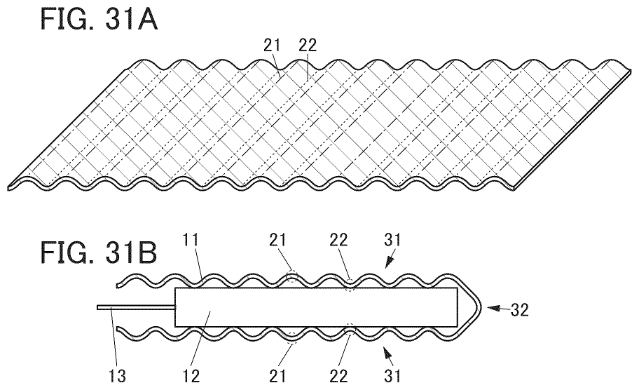

FIG. 31A is an example of a schematic perspective view of the exterior body 11 formed in such a manner. The exterior body 11 has a wave shape in which the plurality of crest lines 21 and the plurality of trough lines 22 are alternately arranged on its surface which is the outer side of the battery 10. Here, the crest lines 21 adjacent to each other and the trough lines 22 adjacent to each other are preferably arranged at regular intervals.

Subsequently, the exterior body 11 is partly folded such that the stack 12 prepared in advance is sandwiched (FIG. 31B). At this time, the length of the exterior body 11 is preferably adjusted such that an electrode 13 (the electrode 13a or the electrode 13b) connected to the stack 12 is exposed to the outside. Furthermore, the width of portions of the exterior body 11 that protrudes beyond the stack 12 is set sufficiently long in consideration of the thickness of the stack 12 because the protruding portions serve as the bonding portion 33 and the bonding portion 34 later.

FIG. 31B illustrates an example of the case where the pair of portions 31 between which the stack 12 is sandwiched are provided such that the phases of the waves of the portions 31 are different from each other by 180°. In other words, FIG. 31B illustrates the case where the exterior body 11 is folded such that the crest lines 21 overlap with each other and the trough lines 22 overlap with each other in the pair of portions 31.

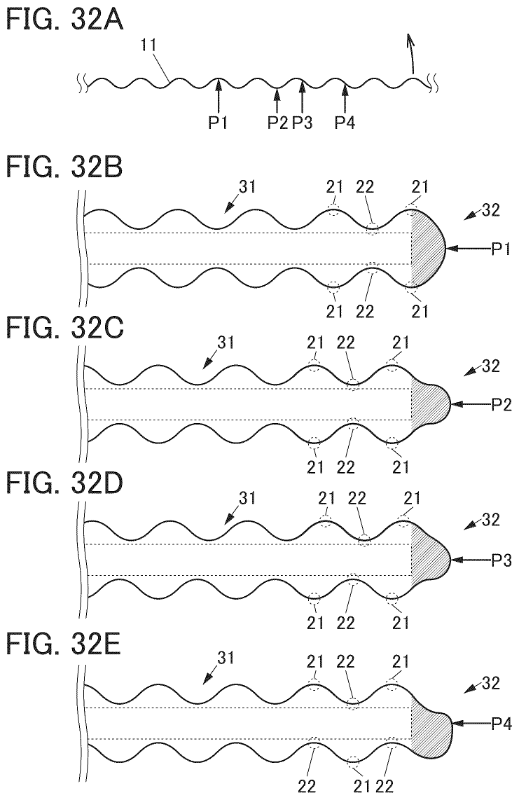

Here, the position and the shape of the folded portion 32 of the exterior body 11 will be described. FIG. 32A is a schematic cross-sectional view of the exterior body 11. FIG. 32B to FIG. 32E each illustrate a cross-sectional shape of the folded portion 32 when the folding position is points P1 to P4 in FIG. 32A. Note that the case where the exterior body 11 is folded in the direction shown by an arrow in FIG. 32A will be described below, and the surface facing downward corresponds to the outer surface of the battery 10. In FIG. 32A, a portion protruding upward is shown as the trough line 22 and a portion protruding downward is shown as the crest line 21.

In FIG. 32B to FIG. 32E, a region surrounded by the folded portion 32 is hatched. Here, a region sandwiched between two positions at which the wave periodicity of the exterior body 11 is lost, as boundaries, is the folded portion 32. Note that in FIG. 32B to FIG. 32E, the shape of the folded portion 32 is exaggerated; thus, its perimeter is not shown correctly in some cases.

The point P1 coincides with the trough line 22. As illustrated in FIG. 32B, the exterior body 11 is folded at the point P1, whereby the folded portion 32 can have a substantially arc shape. In addition, folding the exterior body 11 at the point P1 allows the phases of the opposite waves to be different from each other by 180°.

The point P2 coincides with the crest line 21. As illustrated in FIG. 32C, also when the exterior body 11 is folded at the point P2, the folded portion 32 can have a substantially arc shape. In addition, folding the exterior body 11 at the point P2 allows the phases of the opposite waves to be different from each other by 180°.

The point P3 is a point located between the crest line 21 and the trough line 22 and closer to the crest line 21 than to the midpoint of the crest line 21 and the trough line 22. As illustrated in FIG. 32D, the point P3 coincides with neither the crest line 21 nor the trough line 22, whereby the shape of the folded portion 32 is distorted instead of being vertically symmetrical. In addition, when the exterior body 11 is folded at the point P3, coincidence of the crest lines, the trough lines, and the crest line and the trough line of the opposite waves can be avoided.

The point P4 coincides with the midpoint of the crest line 21 and the trough line 22. As illustrated in FIG. 32E, in the case where the exterior body 11 is folded at the point P4, the shape of the folded portion 32 is significantly distorted. Specifically, the folded portion 32 is more likely to protrude upward or downward. Therefore, it is difficult to ensure a large distance between the stack 12 and the inner wall of the exterior body 11 on the side opposite to the protruding portion.

Here, FIG. 32B, FIG. 32C, and FIG. 32D are the same in that one crest line 21 is located between the folded portion 32 and the trough line 22 of the portion 31 that is closest to the folded portion 32. In particular, FIG. 32B illustrates an example of the case where boundaries of the folded portion 32 coincide with the crest lines 21 of the waves. The exterior body 11 is folded with the crest lines 21 of the two waves or the vicinities thereof regarded as boundaries in this manner, whereby a space that is large in the thickness direction can be ensured on the inner side of the folded portion 32 and the vicinity thereof. As described above, it is important to keep a distance between the inner wall of the exterior body 11 and the outermost electrode of the stack when the battery 10 is folded, and the shape illustrated in FIG. 32B allows the distance to be large.

In contrast, in FIG. 32E, there is no crest line 21 between the folded portion 32 and the trough line 22 of the portion 31 that is closest to the folded portion 32, on the lower surface side. Thus, a space that is large in the thickness direction is unlikely to be formed at the folded portion 32 and the vicinity thereof.

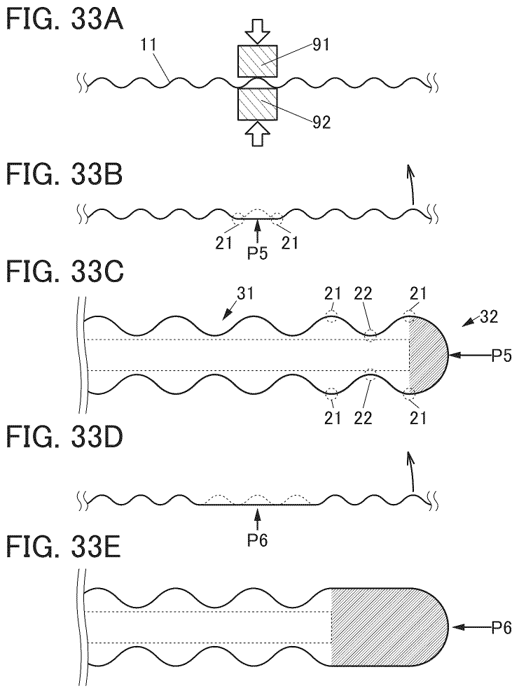

Here, a portion of the exterior body 11 that is to be the folded portion 32 preferably has a flat shape instead of a wave shape. For example, as illustrated in FIG. 33A, the exterior body 11 is partly planarized by being sandwiched between a mold 91 and a mold 92 each with a flat surface and pressurized or by being pressurized while being heated.

FIG. 33B is a schematic cross-sectional view of the exterior body 11 partly planarized in this manner. Here, the exterior body 11 is partly planarized such that the crest lines 21 are connected.

FIG. 33C is a schematic cross-sectional view of the exterior body 11 folded at a point P5 at the center of the formed flat portion. As illustrated in FIG. 33C, when the planarized exterior body 11 is used for the folded portion 32, a space larger than that in FIG. 32B can be formed.

FIG. 33D and FIG. 33E each illustrate an example of the case where planarization is performed in a region larger than that in FIG. 33C. As in FIG. 33B, the exterior body 11 is partly planarized such that the crest lines 21 are connected. The exterior body 11 is planarized in a region larger than the thickness of the stack 12 in such a manner, whereby a large space that is uniform in the thickness direction can be formed.

The above is the description of the relation between the position and the shape of the folded portion.

The exterior body 11 is folded such that the stack 12 is sandwiched, in the above manner, and then, portions of the exterior body 11 that are to be the bonding portions 33 are bonded by being pressurized while being heated.

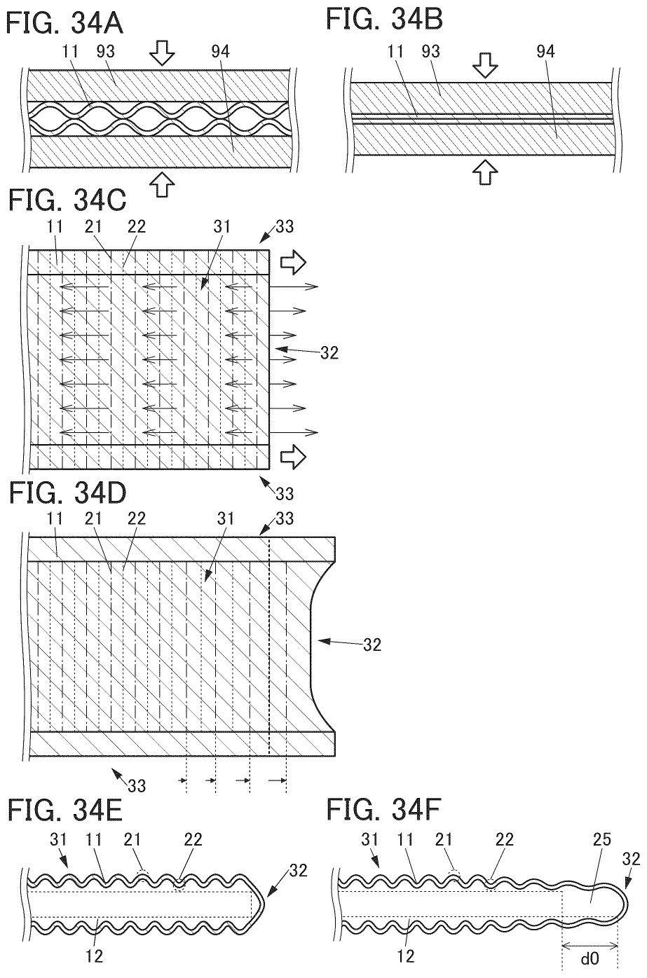

As illustrated in FIG. 34A, pressure bonding can be performed in such a manner that the exterior body 11 is sandwiched between a pair of molds 93 and 94 each with a flat surface. Then, pressure bonding is performed in the direction perpendicular to the surfaces of the mold 93 and the mold 94, whereby the portions of the exterior body 11 that are to be the bonding portions 33 are bonded so as to be flat as illustrated in FIG. 34B. At this time, clearance is preferably provided to keep a certain distance between the mold 93 and the mold 94. In that case, for example, the following problem can be avoided: the thickness of the bonding portion is reduced by more than a certain value, so that a conductive material (e.g., aluminum foil) contained in the film is exposed, leading to loss or a decrease of the insulating property.

Pressure bonding is preferably performed at a pressure higher than that for subsequent formation of the bonding portion 34, for example, so that the bonding portions 33 become sufficiently flat. The pressure depends on a material and the thickness of the exterior body; for example, in the case where a film with a thickness of approximately 110 μm, the pressure for pressure bonding is higher than or equal to 100 kPa/cm² and lower than or equal to 1000 kPa/cm², and can typically be approximately 600 kPa/cm². In addition, any temperature is acceptable as long as it is higher than or equal to the melting point of a material used as a fusing layer; for example, in the case where polypropylene is used, the temperature is preferably approximately 175° C.

Furthermore, the thickness of each of the bonding portions 33 after pressure bonding is preferably smaller than the total thickness of two exterior bodies 11 before pressure bonding. For example, in the case where a layered film including a fusing layer is used as the exterior body, the thickness of the fusing layer of the bonding portion 33 after pressure bonding is preferably 30% or more and 95% or less, further preferably 50% or more and 90% or less, still further preferably 60% or more and 80% or less of the total thickness of two fusing layers of portions of the exterior body 11 that is not subjected to pressure bonding (e.g., the portion 31 or the folded portion 32 of the battery 10).

When the bonding portion 33 is formed under the above conditions, even repeated changes in the form of the battery 10, such as bends, do not break sealing, and leakage of an electrolytic solution and the like enclosed in the exterior body 11 can be prevented. This allows the battery 10 to have extremely high reliability and safety. In particular, the bonding portion 33 can be formed in which a gap is not formed because of a change in the form of the battery 10 even in the case where the phases of the waves of facing portions of the exterior body 11 are different from each other by 180° as illustrated in FIG. 34A.

In FIG. 34C, force applied to each portion of the exterior body 11 in bonding is schematically shown by arrows. Here, greater force is shown by longer arrows.

Part of the exterior body 11 having a wave shape before bonding is stretched in the extending direction (shown by thick arrows) due to its planarization by bonding. The stretch generates tensile force to the folded portion 32 side in the portion 31 of the exterior body 11. This force increases as the distance from the bonding portion 33 decreases, and decreases as the distance from the bonding portion 33 increases.

On the other hand, since the portion 31 has a wave shape, reaction occurs in the direction opposite to that of the force described above. This reaction increases as the distance from the folded portion 32 increases, and decreases as the distance from the folded portion 32 decreases.

Application of the above two kinds of force to the portion 31 and the folded portion 32 stretches the portion 31 such that the wave period gradually increases as the distance from the folded portion 32 decreases, as illustrated in FIG. 34D. The stretch amount increases as the distance from the bonding portion 33 decreases, and decreases as the distance from the bonding portion 33 increases; thus, a center portion of the folded portion 32 is depressed to the portion 31 side.

FIG. 34E and FIG. 34F are schematic cross-sectional views before and after formation of the bonding portions 33. Even in the case where the stack 12 is in contact with the inner wall of the exterior body 11 before bonding as illustrated in FIG. 34E, a stretch of the portion 31 of the exterior body 11 in formation of the bonding portions 33 enables the space 25 to be formed as illustrated in FIG. 34F.

The bonding portions 33 are formed to be flat in the aforementioned manner, whereby the space 25 can be formed between the folded portion 32 and the stack 12.

Subsequently, an electrolytic solution is introduced from a portion to be the bonding portion 34. In reduced pressure or an inert atmosphere, a desired amount of electrolyte solution is dripped into the exterior body 11 having a bag-like shape.

After that, a portion to be the bonding portion 34 is bonded by a method similar to the above method, so that the bonding portion 34 is formed. In forming the bonding portion 34, an insulating sealing layer may be provided between the exterior body 11 and the electrodes 13a and 13b. The sealing layer melts at the time of pressure bonding, whereby the electrodes 13a and 13b and the film-like exterior body 11 are fixed.

The battery 10 illustrated in FIG. 29A and the like can be fabricated in the aforementioned manner.

The above is the description of the example of the method for fabricating the battery.

### [Battery Shape]

As described above, the space 25 can be formed due to a stretch of part of the exterior body 11 in formation of the bonding portions 33. That is to say, the distance d0 between the stack 12 and the exterior body 11 in the space 25 changes in accordance with the stretch amount of the exterior body 11 in the bonding portion 33. To increase the distance d, a film with the above ratio of the length of the film with a wave form that is stretched to the natural length of the film is preferably used as the exterior body 11.

Furthermore, in the portion 31, as the distance from the bonding portion 33 increases, the stretch amount decreases, and thus, the distance d decreases. In contrast, as the stretch amount of the bonding portion 33 increases, tensile force of the portion 31 increases; accordingly, the distance d can be increased even in the position apart from the bonding portion 33. Here, in the case where the same film is used, the stretch amount of the bonding portion 33 increases in proportion to the length of the bonding portion 33 in the extending direction.

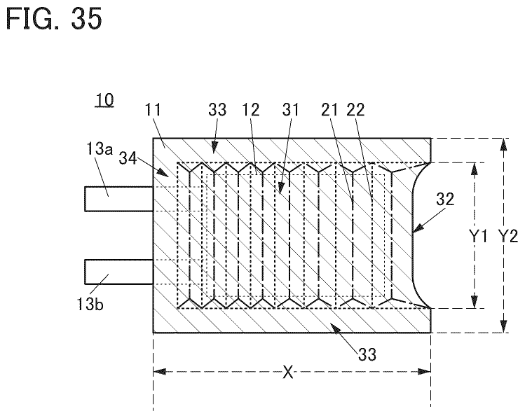

FIG. 35 is a schematic top view of the battery 10 with an aspect ratio different from that in FIG. 29. The battery 10 is preferably designed such that the ratio of X to Y1 is higher than or equal to 1, where the length of the bonding portion 33 in the extending direction is X and the distance between the pair of bonding portions 33 (that is, the width of the portion 31) is Y1. For example, the ratio of X to Y1 is higher than or equal to 1.2, higher than or equal to 1.5, higher than or equal to 1.7, higher than or equal to 2, or higher than or equal to 3. Although there is no upper limit on the ratio of X to Y1, the ratio is preferably, for example, lower than 100 or lower than 50 in consideration of productivity.

The ratio of X to Y2 is preferably, for example, 4/3 or 16/9 assuming that the width of the battery 10 including the bonding portions 33 is Y2, in which case an electronic device into which the battery 10 is incorporated can be easily designed and the battery 10 is more widely used. In the case where the battery 10 is incorporated into a narrow object such as a watch band, the ratio of X to Y2 can be, for example, higher than or equal to 1.5, higher than or equal to 2, or higher than or equal to 3.

### [Film Processing Method]

Next, a film processing method that can be used for the exterior body 11 will be described.

First, a sheet made of a flexible material is prepared. As the sheet, a stack in which a heat-seal layer is provided on one or both surfaces of a metal film is used. As the heat-seal layer, a heat-seal resin film containing polypropylene, polyethylene, or the like is used. In this embodiment, a metal sheet in which the surface of aluminum foil is provided with a nylon resin and the back surface of the aluminum foil is provided with a stack of an acid-proof polypropylene film and a polypropylene film is used as the sheet. The sheet is cut to obtain a film with a desired size.

Then, the film is embossed. As a result, the film with unevenness can be formed. The film includes a plurality of uneven portions, thereby having a wave pattern that can be visually recognized. Although an example in which the sheet is cut and then embossing is performed is described here, there is no particular limitation on the order; embossing may be performed before cutting the sheet and then the sheet may be cut. Alternatively, the sheet may be cut after thermocompression bonding is performed with the sheet folded.

Embossing, which is a kind of pressing, will be described below.

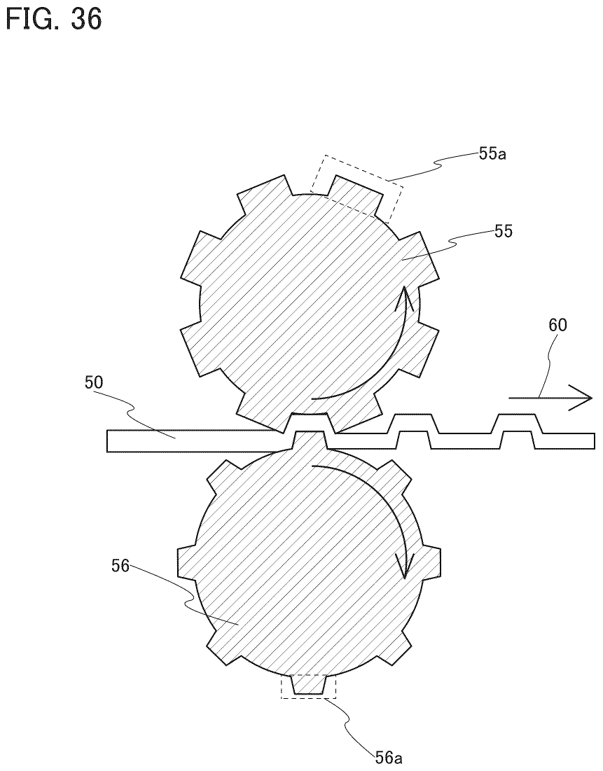

FIG. 36 is a cross-sectional view illustrating an example of embossing. Note that embossing, which is a kind of pressing, refers to processing for forming projections and depressions corresponding to projections and depressions of an embossing roll on a film by bringing the embossing roll whose surface has projections and depressions into contact with the film with pressure. Note that the embossing roll is a roll whose surface is patterned.

FIG. 36 illustrates an example where both surfaces of a film are embossed. FIG. 36 illustrates a method for forming a film having projections whose top portions are on one surface.

FIG. 36 illustrates the state where the film 50 is sandwiched between an embossing roll 55 in contact with one surface of the film and an embossing roll 56 in contact with the other surface and the film 50 is being transferred in the direction of movement 60. The surface of the film is patterned by pressure or heat. The surface of the film may be patterned by pressure and heat.

The embossing rolls can be formed of metal rolls, ceramic rolls, plastic rolls, rubber rolls, organic resin rolls, lumber rolls, or the like, as appropriate.

In FIG. 36, embossing is performed using the male embossing roll 56 and the female embossing roll 55. The male embossing roll 56 has a plurality of projections 56a. The projections correspond to projections formed on a film to be processed. The female embossing roll 55 has a plurality of projections 55a. Between adjacent projections 55a, a depression is positioned into which a projection formed on the film by the projection 56a of the male embossing roll 56 fits.

Successive embossing by which the film 50 partly stands out and debossing by which the film 50 is partly indented can forma projection and a flat portion successively. In this manner, a pattern can be formed on the film 50.

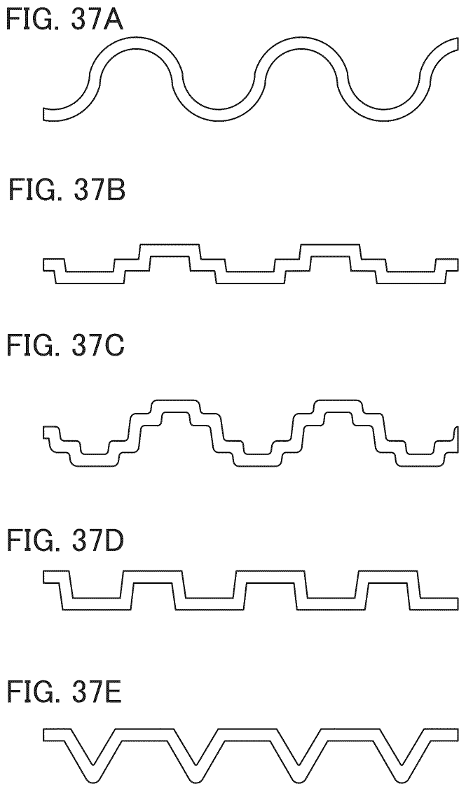

Next, a film having a plurality of projections with a shape different from that in FIG. 36 is described with reference to FIG. 37A to FIG. 37E. The shape of projections of the embossing roll 55 and the embossing roll 56 in FIG. 36 are changed to a shape different from that in FIG. 36, whereby embossing with various cross-sectional shapes illustrated in FIG. 37A to FIG. 37E can be performed.

FIG. 37A is a schematic cross-sectional view of an embossment having a wave shape illustrated in FIG. 31A and the like, and FIG. 37B to FIG. 37E are modification examples of FIG. 37A. FIG. 37B and FIG. 37C are diagrams illustrating examples of forming a stepwise wave shape, FIG. 37D is a diagram illustrating an example of forming a rectangular wave shape, and FIG. 37E is a diagram illustrating an example of forming a wave shape with acute troughs and trapezoidal crests.

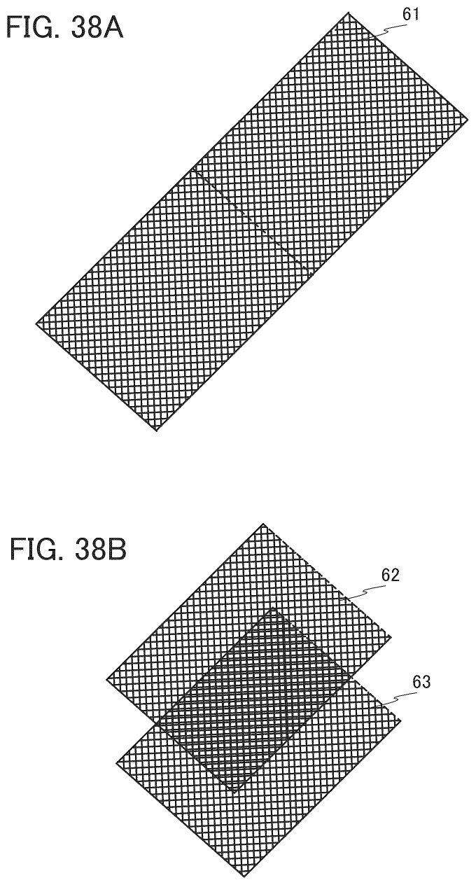

FIG. 38A and FIG. 38B are bird's eye views illustrating the completed shapes obtained by performing the embossing illustrated in FIG. 36 to FIG. 37E twice with different orientations of the film 50. Specifically, embossing is performed on the film 50 in the first direction, and then embossing is performed on the film 50 in the second direction that is rotated 90° with respect to the first direction, whereby a film 61 having an embossed shape (that can be referred to as an alternating wave shape) illustrated in FIG. 38A and FIG. 38B can be obtained. Note that when a secondary battery is fabricated using one film 61, the film 61 having an alternating wave shape has an external shape illustrated in FIG. 38A and can be used by being folded in two along a dashed line portion. When a secondary battery is fabricated using two films (a film 62 and a film 63), the plurality of films (the film 62 and the film 63) each having an alternating wave shape have an external shape illustrated in FIG. 38B, and the film 62 and the film 63 overlap with each other to be used.

Since processing is performed using the embossing rolls in the aforementioned manner, an apparatus can be small. Furthermore, a film before being cut can be processed, achieving excellent productivity. Note that a film processing method is not limited to processing using embossing rolls; a film may be processed by pressing a pair of embossing plates having a surface with unevenness against the film. In that case, one of the embossing plates may be flat and the film may be processed in a plurality of steps.

In the above-described structure example of the secondary battery, the example is described in which the exterior body on one surface of the secondary battery and the exterior body on the other surface thereof have the same embossed shape; however, the structure of the secondary battery of one embodiment of the present invention is not limited thereto. For example, a secondary battery one surface of which is provided with an exterior body having an embossed shape and the other surface of which is provided with an exterior body not having an embossed shape can be used. Alternatively, the exterior body on one surface of the secondary battery and the exterior body on the other surface thereof may have different embossed shapes.

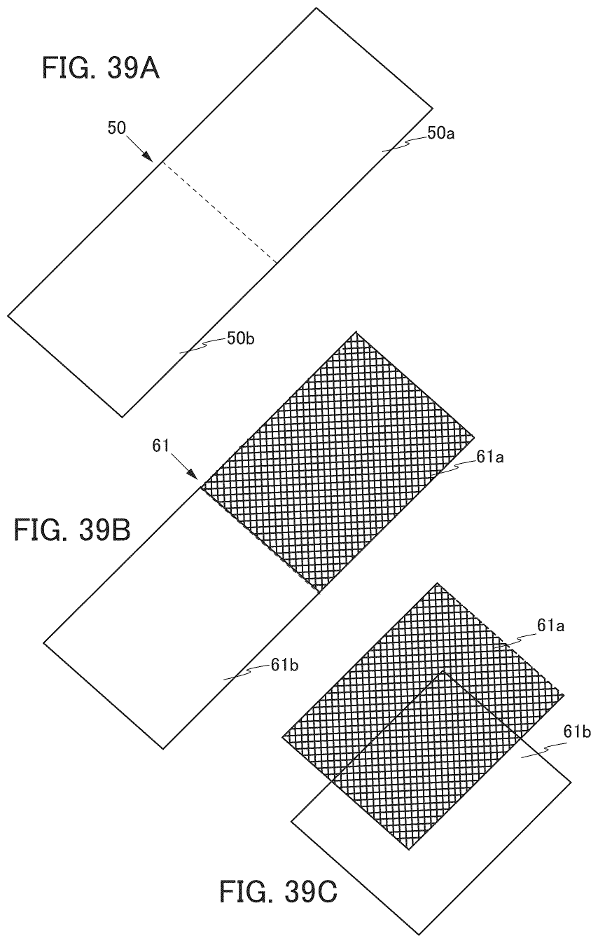

A secondary battery one surface of which is provided with an exterior body having an embossed shape and the other surface of which is provided with an exterior body not having an embossed shape will be described with reference to FIG. 39 to FIG. 41.

First, a sheet made of a flexible material is prepared. As the sheet, a stack in which an adhesive layer (also referred to as a heat-seal layer) is provided on one or both surfaces of a metal film is used. As the adhesive layer, a heat-seal resin film containing polypropylene, polyethylene, or the like is used. In this embodiment, a metal sheet in which the surface of aluminum foil is provided with a nylon resin and the back surface of the aluminum foil is provided with a stack of an acid-proof polypropylene film and a polypropylene film is used as the sheet. This sheet is cut to prepare the film 50 illustrated in FIG. 39A.

Then, part of the film 50 (a film 50a) is embossed and a film 50b is not embossed. As a result, the film 61 illustrated in FIG. 39B is formed. As illustrated in FIG. 39B, projections and depressions are formed to provide a film 61a a surface of which is provided with a visually recognizable pattern and a film 61b a surface of which is not provided with projections and depressions. There is a boundary between the film 61a provided with projections and depressions and the film 61b not provided with projections and depressions. In FIG. 39B, the film 61a is an embossed portion of the film 61, and the film 61b is a non-embossed portion. Note that embossing for the film 61a may be performed to provide the same projections and depressions on the entire surface, or may be performed to provide two or more types of different projections and depressions depending on the portions of the film 61a. In the case of providing two or more types of different projections and depressions, a boundary is formed between any two different types of projections and depressions.

Alternatively, the entire film 50 in FIG. 39A may be embossed to form the film 61 as illustrated in FIG. 38A. Note that embossing for the film 61 may be performed to provide the same projections and depressions on the entire surface, or may be performed to provide two or more types of different projections and depressions depending on the portions of the film 61. In the case of providing two or more types of different projections and depressions, a boundary is formed between any two different types of projections and depressions. Alternatively, as illustrated in FIG. 39C, the film 61a whose surface has projections and depressions and the film 61b whose surface does not have projections and depressions may be prepared.

Although an example in which the sheet is cut and then embossing is performed is described here, there is no particular limitation on the order; embossing may be performed before cutting the sheet and then the sheet is cut so as to be in the state illustrated in FIG. 39B. Alternatively, the sheet may be cut after thermocompression bonding is performed with the sheet folded.

In this embodiment, projections and depressions are provided on part of the film 50 (the film 50a) so that the film 61 having patterns and illustrated in FIG. 39B is formed, and the film 61 is folded at the center such that two end portions overlap with each other, and is sealed on three sides with an adhesive layer. Here, the film 61 is referred to as the exterior body 11.

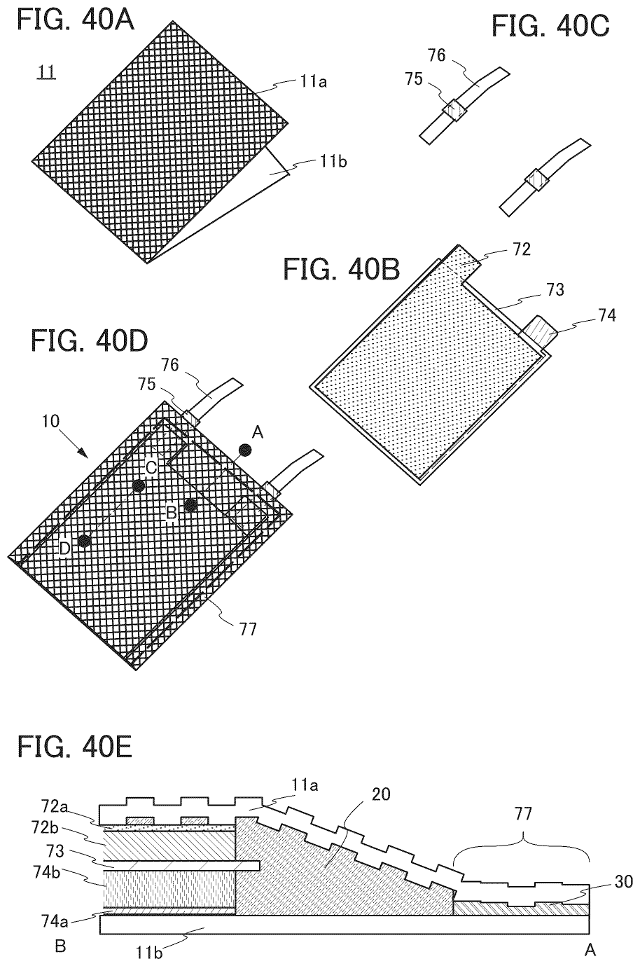

First, the exterior body 11 is folded such that a first portion 11a of the exterior body 11 and a second portion 11b of the exterior body 11 that have the same size overlap with each other as illustrated in FIG. 40A. Note that the first portion 11a has unevenness formed by embossing, and the second portion 11b does not have unevenness.

As illustrated in FIG. 40B, a stack including a positive electrode 72, a separator 73, and a negative electrode 74 is prepared. Here, for simple description, an example is described in which one positive electrode 72, one separator 73, and one negative electrode 74 are held in the exterior body; alternatively, to increase the capacity of the secondary battery, a plurality of positive electrodes 72, a plurality of separators 73, and a plurality of negative electrodes 74 may be stacked and held in the exterior body.

In addition, two lead electrodes 76 including sealing layers 75 illustrated in FIG. 40C are prepared. The lead electrodes 76 are each also referred to as a lead terminal and provided to lead a positive electrode or a negative electrode of a secondary battery to the outside of an exterior film. Aluminum and nickel-plated copper are used for a positive electrode lead and a negative electrode lead, respectively.

Then, the positive electrode lead is electrically connected to a protruding portion of the positive electrode current collector of the positive electrode 72 by ultrasonic welding or the like. The negative electrode lead is electrically connected to a protruding portion of the negative electrode current collector of the negative electrode 74 by ultrasonic welding or the like.

Then, two sides of the exterior body 11 are sealed by thermocompression bonding, and one side is left open for introduction of an electrolyte solution (hereinafter, the shape of a film in this state also referred to as a bag-like shape). In thermocompression bonding, the sealing layers 75 provided over the lead electrodes are also melted, thereby fixing the lead electrodes and the exterior body 11 to each other. After that, in reduced pressure or an inert atmosphere, a desired amount of electrolyte solution is dripped into the exterior body 11 having a bag-like shape. Lastly, the outer edge of the exterior body 11 that has not been subjected to thermocompression bonding and is left open is sealed by thermocompression bonding.

In this manner, the secondary battery 10 illustrated in FIG. 40D can be fabricated.

In the obtained secondary battery 10, the surface of the film 50 serving as an exterior body has a pattern of projections and depressions. A region between a dotted line and an edge in FIG. 40D is a thermocompression-bonded region 77, and its surface also has a pattern of projections and depressions. Although the projections and depressions in the thermocompression-bonded region 77 are smaller than those in a center portion, they can relieve stress applied when the secondary battery is bent.

FIG. 40E illustrates an example of a cross section taken along the dashed-dotted line A-B in FIG. 40D.

As illustrated in FIG. 40E, projections and depressions of the exterior body 11a are different between a region overlapping with the positive electrode current collector 72a and the thermocompression-bonded region 77. As illustrated in FIG. 40E, a stack including the positive electrode current collector 72a, the positive electrode active material layer 72b, the separator 75, the negative electrode active material layer 74b, and the negative electrode current collector 74a in this order is sandwiched between the facing portions of the folded exterior body 11, an end portion is sealed with an adhesive layer 30, and the other space inside the folded exterior body 11 includes an electrolyte solution 20.

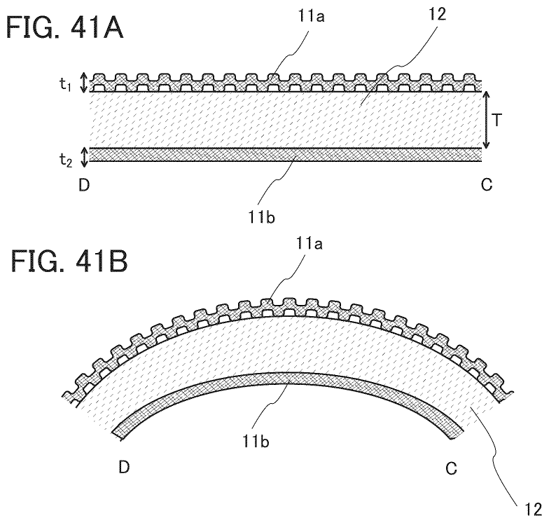

The proportion of the volume of the battery portion to the total volume of the secondary battery is preferably greater than or equal to 50%. FIG. 41A and FIG. 41B show cross-sectional views of the secondary battery in FIG. 40D taken along the line C-D. FIG. 41A illustrates the stack 12 in the battery, the first portion 11a of the exterior body 11 that covers the top surface of the battery and is embossed, and the second portion 11b of the exterior body 11 that covers the bottom surface of the battery and is not embossed. For simplification of the drawings, the electrolyte solution and the stacked-layer structure of the positive electrode current collector provided with the positive electrode active material layer, the separator, the negative electrode current collector provided with the negative electrode active material layer, and the like are collectively illustrated as the stack 12 in the battery. In addition, T represents the thickness of the stack 12 in the battery, t₁ represents the total of the depth of the embossment and the thickness of the first portion 11a that covers the top surface of the battery and is embossed, t₂ represents the film thickness of the second portion 11b that covers the bottom surface of the battery and is not embossed. At this time, the total thickness of the secondary battery is T+t₁+t₂. Thus, T>t₁+t₂ needs to be satisfied to make the proportion of the volume of the stack 12 portion in the battery to the total volume of the secondary battery greater than or equal to 50%.

The adhesive layer 30, which is only partly illustrated in FIG. 40E, is formed in the following manner: a layer made of polypropylene is provided on the surface of the layer on the side where the film is attached, and only a thermocompression-bonded portion becomes the adhesive layer 30.

FIG. 40E illustrates an example in which the bottom side of the exterior body 11 is fixed and pressure bonding is performed. In this case, the top side is greatly bent and a step is formed; thus, when a plurality of the above-described stacks, e.g., eight or more stacks, are provided between the facing portions of the first portion 11a of the folded exterior body 11, the step is large and stress might be excessively applied to the top side of the exterior body 11a. Furthermore, the edge of the top side of the film might be greatly misaligned with the edge of the bottom side of the film. In that case, to prevent misalignment of the edges, a step may be provided on the bottom side of the film and pressure bonding may be performed at the center so that stress is equalized.

In the case where the misalignment is large, there is a region where part of the edge of one film does not overlap with the other film. To correct the misalignment of the edges of the top and bottom sides of the film, such a region may be cut off.

### [Example of Method for Fabricating Secondary Battery]

An example of a fabrication method particularly when a secondary battery is used as a battery 10 will be described below. Note that points similar to those described above are not described in some cases.

Here, a method in which the film-like exterior body 11 having a wave shape is folded in half so that two end portions overlap with each other and three sides are sealed using an adhesive layer is employed.

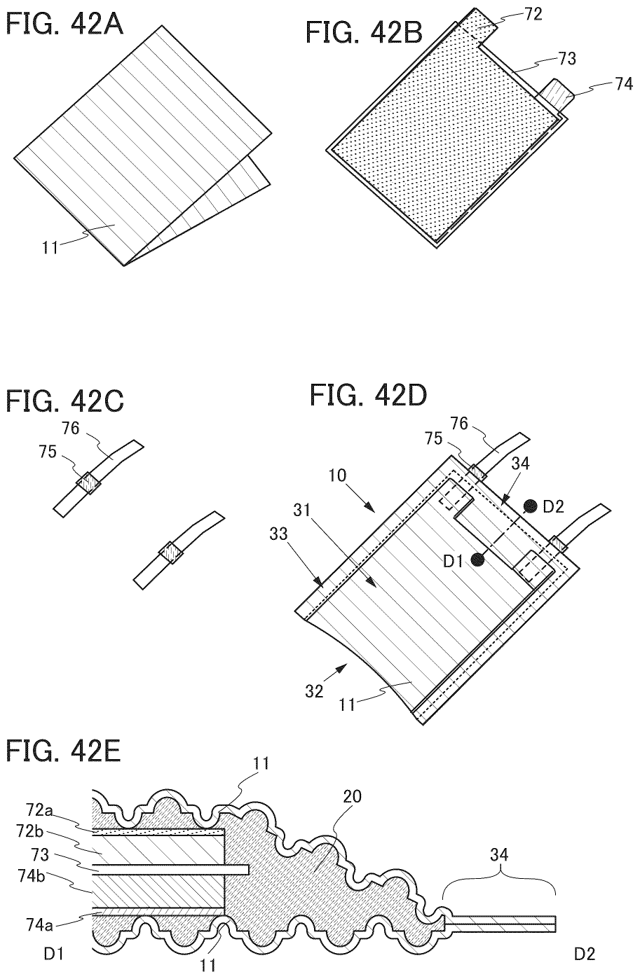

The exterior body 11 including a film processed to have a wave shape is bent to be in the state illustrated in FIG. 42A.

As illustrated in FIG. 42B, a stack that includes the positive electrode 72, the separator 73, and the negative electrode 74 included in a secondary battery is prepared. Here, for simple description, an example is described in which the stack combination of one positive electrode 72 provided with the positive electrode active material layer, one separator 73, and one negative electrode 74 is held in the exterior body; alternatively, to increase the capacity of the secondary battery, a plurality of positive electrodes 72, a plurality of separators 73, and a plurality of negative electrodes 74 may be stacked in the exterior body.

In addition, two lead electrodes 76 including sealing layers 75 illustrated in FIG. 42C are prepared. The lead electrodes 76 are each also referred to as a lead terminal or a tab and provided to lead a positive electrode or a negative electrode of a secondary battery to the outside of an exterior film. Aluminum and nickel-plated copper are used for a positive electrode lead and a negative electrode lead, respectively, of the lead electrodes 76.

Then, the positive electrode lead is electrically connected to a protruding portion of the positive electrode current collector of the positive electrode 72 by ultrasonic welding or the like. The negative electrode lead is electrically connected to a protruding portion of the negative electrode current collector of the negative electrode 74 by ultrasonic welding or the like.

Then, two sides of the film-like exterior body 11 are subjected to thermocompression bonding by the above-described method and one side is left open for introduction of an electrolyte solution, whereby a bonding portion 33 is formed. After that, in reduced pressure or an inert atmosphere, a desired amount of electrolyte solution is dripped into the film-like exterior body 11 having a bag-like shape. Lastly, the outer edge of the film that has not been subjected to thermocompression bonding and is left open is subjected to thermocompression bonding, whereby the bonding portion 34 is formed. In thermocompression bonding, the sealing layers 75 provided over the lead electrodes are also melted, thereby fixing the lead electrodes and the film-like exterior body 11 to each other.

In this manner, the battery 10 illustrated in FIG. 42D, which is a secondary battery, can be fabricated.

The film-like exterior body 11 of the battery 10, which is the obtained secondary battery, has a pattern of waves. A region between a dotted line and the edge in FIG. 42D is the bonding portion 33 or the bonding portion 34, and the region is processed to be flat.

FIG. 42E illustrates an example of a cross section taken along the dashed-dotted line D1-D2 in FIG. 42D.

As illustrated in FIG. 42E, a stack in which the positive electrode current collector 72a, a positive electrode active material layer 72b, the separator 73, a negative electrode active material layer 74b, and the negative electrode current collector 74a are stacked in this order is sandwiched between the facing portions of the folded film-like exterior body 11, the folded film-like exterior body 11 is sealed by the bonding portion 34 at its end portions, and the other space is provided with the electrolyte solution 20. That is, the space inside the film-like exterior body 11 is filled with the electrolyte solution 20. As the positive electrode current collector 72a, the positive electrode active material layer 72b, the separator 73, the negative electrode active material layer 74b, the negative electrode current collector 74a, and the electrolyte solution 20, the positive electrode current collector, the positive electrode active material layer, the separator, the negative electrode active material layer, the negative electrode current collector, and the electrolyte solution described in Embodiment 1 can be respectively used.

Note that the adhesive layer is formed in the following manner: a layer made of polypropylene is provided on the surface of the film on the side where the film is attached, and only a thermocompression-bonded portion becomes the adhesive layer.

FIG. 42E illustrates an example in which the bottom side of the film-like exterior body 11 is fixed and pressure bonding is performed. In this case, the top side is greatly bent and a step is formed; thus, when a plurality of the above-described stacks, e.g., eight or more stacks, are provided between the facing portions of the folded film-like exterior body 11, the step is large and stress might be excessively applied to the top side of the film-like exterior body 11. Furthermore, the edge of the top side of the film might be greatly misaligned with the edge of the bottom side of the film. In that case, to prevent misalignment of the edges, a step may be provided on the bottom side of the film and pressure bonding may be performed at the center so that stress is equalized.

In the case where the misalignment is large, there is a region where part of the edge of one film does not overlap with the other film. To correct the misalignment of the edges of the top and bottom sides of the film, such a region may be cut off.

### [Example of Electrode Stack]

A structure example of a stack including a plurality of electrodes will be described below.

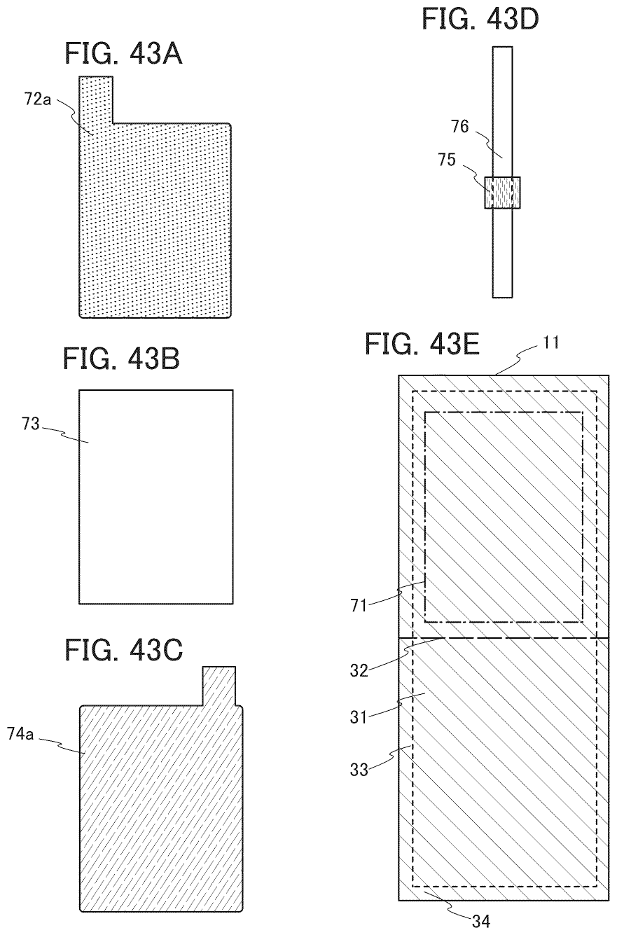

FIG. 43A shows a top view of the positive electrode current collector 72a, FIG. 43B shows a top view of the separator 73, FIG. 43C shows a top view of the negative electrode current collector 74a, FIG. 43D shows a top view of the sealing layer 75 and the lead electrode 76, and FIG. 43E shows a top view of the film-like exterior body 11.

The dimensions in the drawings of FIG. 43 are substantially the same, and a region 71 surrounded by a dashed-dotted line in FIG. 43E has substantially the same dimensions as the separator in FIG. 43B. A region between a dashed line and the edge in FIG. 43E becomes the bonding portion 33 and the bonding portion 34.

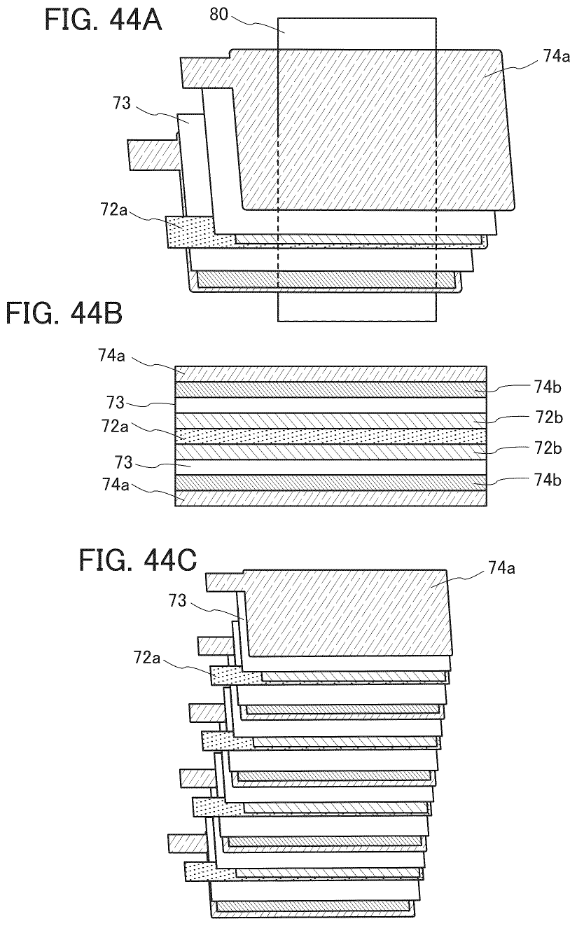

FIG. 44A is an example in which the positive electrode active material layer 72b is provided on both surfaces of the positive electrode current collector 72a. Specifically, the negative electrode current collector 74a, the negative electrode active material layer 74b, the separator 73, the positive electrode active material layer 72b, the positive electrode current collector 72a, the positive electrode active material layer 72b, the separator 73, the negative electrode active material layer 74b, and the negative electrode current collector 74a are stacked in this order. FIG. 44B illustrates a cross-sectional view of the stacked-layer structure taken along a plane 80.

Although FIG. 44A illustrates an example in which two separators are used, a structure may be employed in which one separator is folded and both ends are sealed to form a bag-like shape, and the positive electrode current collector 72a is held therein. The positive electrode active material layer 72b is formed on both surfaces of the positive electrode current collector 72a held in the separator having a bag-like shape.

The negative electrode active material layer 74b can be provided on both surfaces of the negative electrode current collector 74a. FIG. 44C illustrates an example of a secondary battery in which three negative electrode current collectors 74 each provided with the negative electrode active material layers 74b on both surfaces, four positive electrode current collectors 72a each provided with the positive electrode active material layers 72b on both surfaces, and eight separators 73 are sandwiched between two negative electrode current collectors 74a each provided with the negative electrode active material layer 74b on one surface. In this case, four separators each having a bag-like shape may be used instead of eight separators.

The capacity of the secondary battery can be increased by increasing the number of stacks. In addition, when the positive electrode active material layers 72b are provided on both surfaces of the positive electrode current collector 72a and the negative electrode active material layers 74b are provided on both surfaces of the negative electrode current collector 74a, the thickness of the secondary battery can be made small.

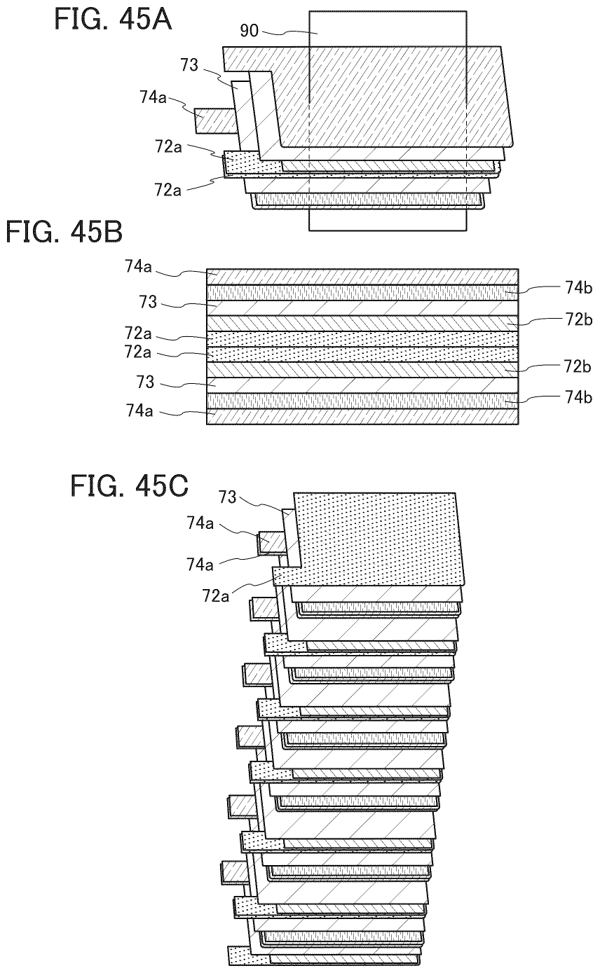

FIG. 45A shows a diagram of a secondary battery in which the positive electrode active material layer 72b is provided on one surface of the positive electrode current collector 72a and the negative electrode active material layer 74b is provided on one surface of the negative electrode current collector 74a. Specifically, the negative electrode active material layer 74b is provided on one surface of the negative electrode current collector 74a and the separator 73 is stacked in contact with the negative electrode active material layer 74b. The positive electrode active material layer 72b provided on one surface of the positive electrode current collector 72a is in contact with the surface of the separator 73 that is not in contact with the negative electrode active material layer 74b. Another positive electrode current collector 72a whose one surface is provided with the positive electrode active material layer 72b is in contact with the surface of the positive electrode current collector 72a. In that case, the positive electrode current collectors 72a are provided such that the surfaces not provided with the positive electrode active material layers 72b face each other. Then, another separator 73 is formed, and the negative electrode active material layer 74b provided on one surface of the negative electrode current collector 74a is stacked in contact with the separator. FIG. 45B shows a cross-sectional view of the stacked-layer structure in FIG. 45A taken along a plane 90.

Although two separators are used in FIG. 45A, a structure may be employed in which one separator is folded and both ends are sealed to form a bag-like shape, and two positive electrode current collectors 72a each provided with the positive electrode active material layer 72b on one surface are provided between the facing portions of the separator.

In FIG. 45C, a plurality of the stacked-layer structures each of which is illustrated in FIG. 45A are stacked. In FIG. 45C, the negative electrode current collectors 74a are provided such that the surfaces not provided with the negative electrode active material layers 74b face each other. FIG. 45C illustrates a state where twelve positive electrode current collectors 72a, twelve negative electrode current collectors 74a, and twelve separators 73 are stacked.

A secondary battery with a structure in which the positive electrode active material layer 72b is provided on one surface of the positive electrode current collector 72a and the negative electrode active material layer 74b is provided on one surface of the negative electrode current collector 74a has a larger thickness than a secondary battery with a structure in which the positive electrode active material layers 72b are provided on both surfaces of the positive electrode current collector 72a and the negative electrode active material layers 72b are provided on both surfaces of the negative electrode current collector 74a. However, the surface of the positive electrode current collector 72a on which the positive electrode active material layer 72b is not provided faces the surface of another positive electrode current collector 72a on which the positive electrode active material layer 72b is not provided; as a result, metals are in contact with each other. Similarly, the surface of the negative electrode current collector 74a on which the negative electrode active material layer 74b is not provided faces the surface of another negative electrode current collector 74a on which the negative electrode active material layer 74b is not provided; as a result, metals are in contact with each other. Since the metals are in contact with each other, surfaces where the metals are in contact with each other easily slide on each other owing to the low friction. The metals in the secondary battery slide on each other at the time of bending the secondary battery; thus, the secondary battery is easily bent.

The protruding portion of the positive electrode current collector 72a and the protruding portion of the negative electrode current collector 74a are also referred to as tab portions. The tab portions of the positive electrode current collector 72a and the negative electrode current collector 74a are easily cut when the secondary battery is bent. This is because the tab portions have long and narrow shapes and the stress is likely to be applied to the roots of the tab portions.

The structure in which the positive electrode active material layer 72b is provided on one surface of the positive electrode current collector 72a and the negative electrode active material layer 74b is provided on one surface of the negative electrode current collector 74a has a surface where the positive electrode current collectors 72a are in contact with each other and a surface where the negative electrode current collectors 74a are in contact with each other. The surface where the current collectors are in contact with each other has low friction resistance and thus easily reduces the stress due to the difference in curvature radius that occurs when the battery is changed in shape. Furthermore, the total thickness of each tab portion is large in the structure in which the positive electrode active material layer 72b is provided on one surface of the positive electrode current collector 72a and the negative electrode active material layer 74b is provided on one surface of the negative electrode current collector 74b; thus, the stress is distributed as compared with the structure in which the positive electrode active material layers 72b are provided on both surfaces of the positive electrode current collector 72a and the negative electrode active material layers 74b are provided on both surfaces of the negative electrode current collector 74a; as a result, the tab portion is less likely to be cut.

In the case of thus stacking layers, ultrasonic welding is performed to fix and electrically connect all the positive electrode current collectors 72a at a time. Furthermore, when ultrasonic welding is performed with the positive electrode current collectors 72a overlapping with a lead electrode, they can be electrically connected to each other efficiently.

Ultrasonic welding can be performed in the following manner: ultrasonic waves are applied to the tab portion placed to overlap with a tab portion of another positive electrode current collector while pressure is applied thereto.

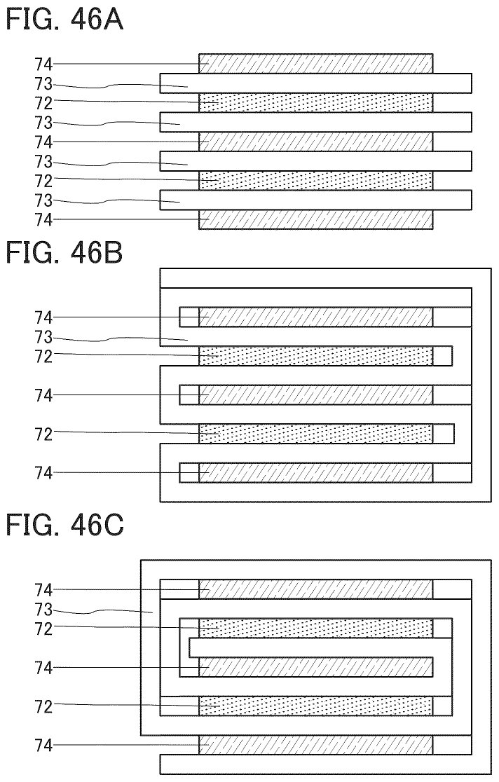

The separators 73 preferably have a shape that helps prevent an electrical short circuit between the positive electrode 72 and the negative electrode 74. For example, the width of each of the separators 73 is preferably larger than those of the positive electrode 72 and the negative electrode 74 as illustrated in FIG. 46A, in which case the positive electrode 72 and the negative electrode 74 are less likely to come in contact with each other even when the relative positions thereof are shifted because of a change in shape such as bending. As illustrated in FIG. 46B, one separator 73 is preferably folded into an accordion-like shape, or as illustrated in FIG. 46C, one separator 73 is preferably wrapped around the positive electrodes 72 and the negative electrodes 74 alternately, in which case the positive electrode 72 and the negative electrode 74 do not come in contact with each other even when the relative positions thereof are shifted. FIG. 46B and FIG. 46C each illustrate an example in which the separator 73 is provided to partly cover the side surface of a stacked-layer structure of the positive electrodes 72 and the negative electrodes 74.

Note that although the positive electrode current collector and the positive electrode active material layer included in the positive electrode 72 and the negative electrode current collector and the negative electrode active material layer included in the negative electrode 74 are not illustrated in each drawing in FIG. 46A to FIG. 46C, the above description can be referred to for formation methods thereof.

In this embodiment, one rectangle film is folded in half and two end portions are made to overlap with each other for sealing; however, the shape of the film is not limited to a rectangle. A polygon such as a triangle, a square, or a pentagon or any symmetric shape other than a rectangle, such as a circle or a star, may be employed.

The contents of this embodiment can be freely combined with the contents in the other embodiments.

### Embodiment 5

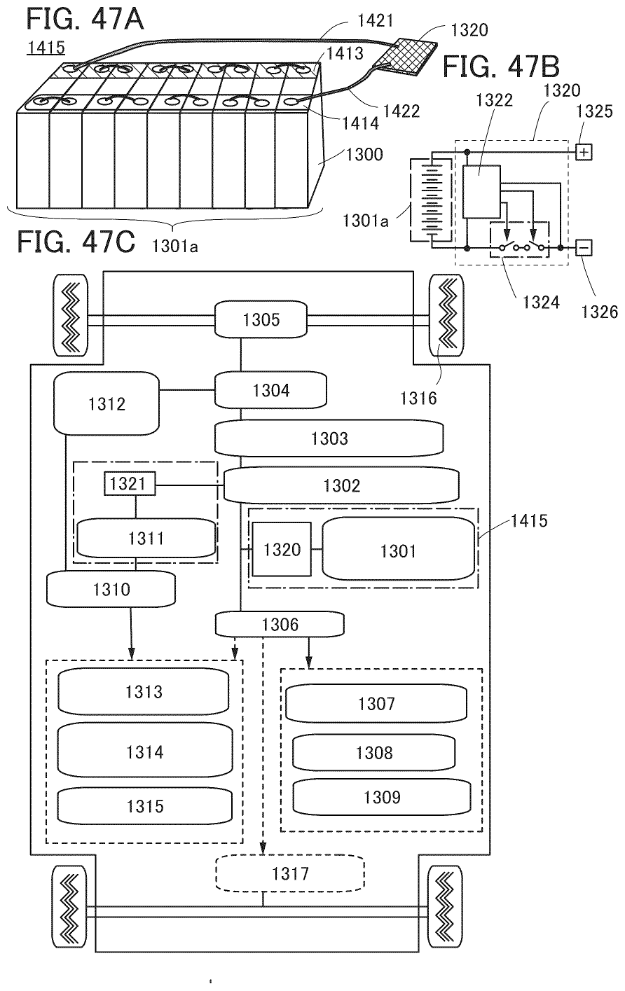

In this embodiment, an example different from the cylindrical secondary battery in FIG. 23D will be described. An example of application to an electric vehicle (EV) will be described with reference to FIG. 47C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 24C or FIG. 25A or the stacked-layer structure illustrated in FIG. 26A or FIG. 26B. Alternatively, an all-solid-state battery in Embodiment 6 may be used as the first battery 1301a. The use of the all-solid-state battery in Embodiment 6 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

Next, the first battery 1301a is described with reference to FIG. 47A.

FIG. 47A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 or a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the “CAC-OS” has a composition in which materials are separated into first regions and second regions to form a mosaic pattern, and the first regions are distributed in the film (this composition is hereinafter also referred to as a cloud-like composition). That is, the CAC-OS is a composite metal oxide having a composition in which the first regions and the second regions are mixed. Note that a clear boundary between the first region and the second region is not easily observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Iₒₙ), high field-effect mobility (μ), and excellent switching operation can be achieved.

An oxide semiconductor has various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion is used in combination with a secondary battery including a positive electrode using the positive electrode active material 100 obtained in Embodiments 1, 2, and the like, the synergy on safety can be obtained. The secondary battery whose positive electrode uses the positive electrode active material 100 obtained in Embodiments 1, 2, and the like and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to resolve causes of instability of the secondary battery, such as a micro-short circuit. Examples of functions of resolving the causes of instability of a secondary battery include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A “micro-short circuit” refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: charging and discharging performed a plurality of times cause an uneven distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharging, an output transistor of a charge circuit and an interruption switch can be turned off substantially at the same time.

FIG. 47B shows an example of a block diagram of the battery pack 1415 illustrated in FIG. 47A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors or p-channel transistors. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. Lead storage batteries have disadvantages compared with lithium ion batteries in that they have a larger amount of self-discharge and are more likely to deteriorate due to a phenomenon called sulfation. There is an advantage that the second battery 1311 can be maintenance-free when a lithium ion battery is used; however, in the case of long term use, for example three years or more, anomaly that is difficult to determine at the time of fabrication might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium ion battery is used as both the first battery 1301a and the second battery 1311 is described. As the second battery 1311, a lead storage battery, an all-solid-state battery, or an electric double layer capacitor may be used. For example, the all-solid-state battery in Embodiment 6 may be used. The use of the all-solid-state battery in Embodiment 6 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet with 50 kW, for example. Furthermore, charging can be performed with electric power supplied from external charge equipment by a contactless power feeding method or the like.

For fast charging, secondary batteries that can withstand high-voltage charging have been desired to perform charging in a short time.

Moreover, it is possible to achieve a secondary battery in which graphene is used as a conductive additive, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above secondary battery in this embodiment, the use of the positive electrode active material 100 described in Embodiments 1, 2, and the like can increase the operating voltage of the secondary battery, and the increase in charge voltage can increase the available capacity. Moreover, using the positive electrode active material 100 described in Embodiments 1, 2, and the like in the positive electrode can provide an automotive secondary battery having excellent cycle performance.

Next, examples in which the secondary battery of one embodiment of the present invention is mounted on a vehicle, typically a transport vehicle, are described.

Mounting the secondary battery illustrated in any of FIG. 23D, FIG. 25C, and FIG. 47A on vehicles can achieve next-generation clean energy vehicles such as hybrid vehicles (HVs), electric vehicles (EVs), and plug-in hybrid vehicles (PHVs). The secondary battery can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

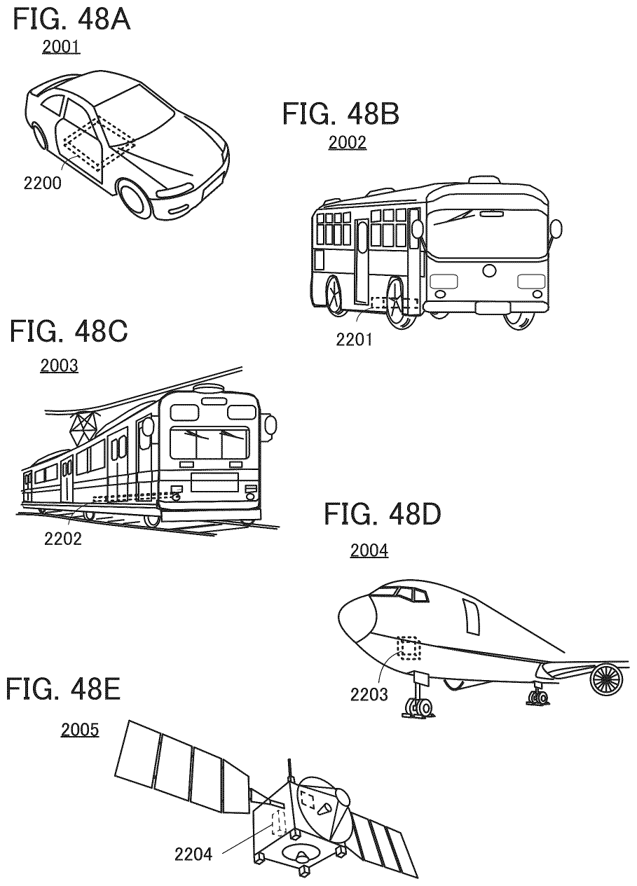

FIG. 48A to FIG. 48D illustrate examples of transport vehicles using one embodiment of the present invention. An automobile 2001 illustrated in FIG. 48A is an electric vehicle that runs using an electric motor as a driving power source. Alternatively, the automobile 2001 is a hybrid vehicle that enables appropriate selection of an electric motor or an engine as a driving power source. In the case where the secondary battery is mounted on the vehicle, an example of the secondary battery described in Embodiment 4 is provided at one position or several positions. The automobile 2001 illustrated in FIG. 48A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charge equipment by a plug-in system, a contactless power feeding system, or the like. In charging, a given method such as CHAdeMO (registered trademark) or Combined Charging System can be employed as a charge method, the standard of a connector, or the like as appropriate. The secondary battery may be a charge station provided in a commerce facility or a household power supply. For example, with use of the plug-in system, the power storage device mounted on the automobile 2001 can be charged by being supplied with electric power from the outside. Charging can be performed by converting AC electric power into DC electric power through a converter such as an ACDC converter.

Although not shown, the vehicle may include a power receiving device so that it can be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 48B illustrates a large transporter 2002 having a motor controlled by electricity as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 48A except, for example, the number of secondary batteries configuring the secondary battery module; thus, the description is omitted.

FIG. 48C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have a small variation in the characteristics. By employing the positive electrode active material 100 described in Embodiments 1, 2, and the like for the positive electrode, a secondary battery having stable battery characteristics can be manufactured and mass production at low cost is possible in light of the yield. A battery pack 2202 has the same function as that in FIG. 16A except, for example, the number of secondary batteries configuring the secondary battery module; thus, the description is omitted.

FIG. 48D illustrates an aircraft 2004 having a combustion engine as an example. The aircraft 2004 illustrated in FIG. 48D can be regarded as a kind of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 48A except, for example, the number of secondary batteries configuring the secondary battery module; thus, the description is omitted.

FIG. 48E illustrates an artificial satellite 2005 including a secondary battery 2204 as an example. Because the artificial satellite 2005 is used in an ultra-low-temperature cosmic space, the secondary battery 2204 having excellent low temperature resistance of one embodiment of the present invention is preferably provided. It is further preferable that the secondary battery 2204 be mounted inside the artificial satellite 2005 while being covered with a heat-retaining member.

### Embodiment 6

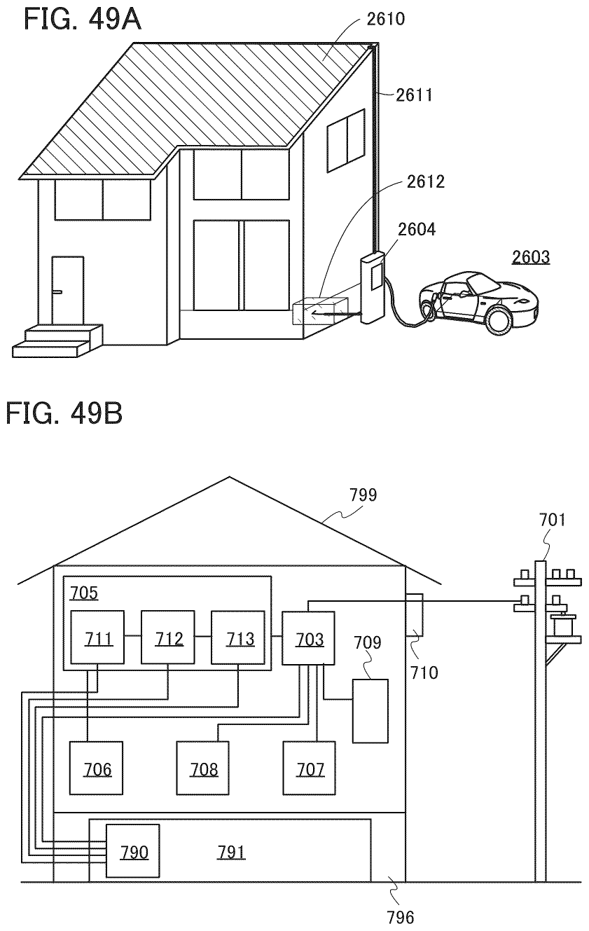

In this embodiment, examples in which the secondary battery of one embodiment of the present invention is mounted on a building will be described with reference to FIG. 49A and FIG. 49B.

A house illustrated in FIG. 49A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charge apparatus 2604. The power storage device 2612 can be charged with electric power generated by the solar panel 2610. A secondary battery included in a vehicle 2603 can be charged with the electric power stored in the power storage device 2612 through the charge apparatus 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with use of the power storage device 2612 of one embodiment of the present invention as an uninterruptible power source, electronic devices can be used even when electric power cannot be supplied from a commercial power source due to power failure or the like.

FIG. 49B illustrates an example of a power storage device of one embodiment of the present invention. As illustrated in FIG. 49B, a power storage device 791 of one embodiment of the present invention is provided in an underfloor space 796 of a building 799. The power storage device 791 may be provided with the control circuit described in Embodiment 7, and when a secondary battery including the positive electrode active material 100 obtained in Embodiments 1, 2, and the like for a positive electrode is used for the power storage device 791, the synergy on safety can be obtained. The secondary battery including the control circuit described in Embodiment 7 and a positive electrode using the positive electrode active material 100 described in Embodiments 1, 2, and the like can contribute greatly to elimination of accidents due to the power storage device 791 including secondary batteries, such as fires.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

### Embodiment 7

In this embodiment, examples in which a motorcycle and a bicycle are each provided with the power storage device of one embodiment of the present invention will be described.

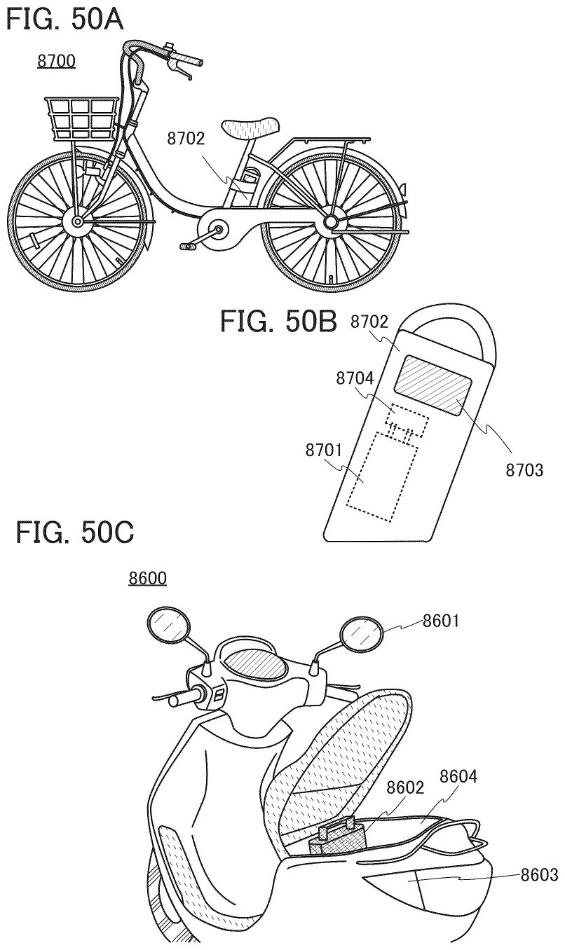

FIG. 50A illustrates an example of an electric bicycle using the power storage device of one embodiment of the present invention. The power storage device of one embodiment of the present invention can be used for an electric bicycle 8700 illustrated in FIG. 50A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 50B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 7. The control circuit 8704 is electrically connected to a positive electrode and a negative electrode of the storage battery 8701. When the control circuit 8704 is used in combination with a secondary battery including a positive electrode using the positive electrode active material 100 obtained in Embodiments 1, 2, and the like, the synergy on safety can be obtained. The secondary battery including a positive electrode using the positive electrode active material 100 obtained in Embodiments 1, 2, and the like and the control circuit 8704 can contribute greatly to elimination of accidents due to secondary batteries, such as fires.

FIG. 50C illustrates an example of a motorcycle using the power storage device of one embodiment of the present invention. A motor scooter 8600 illustrated in FIG. 50C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in Embodiments 1, 2, and the like can have high capacity and contribute to a reduction in size.

In the motor scooter 8600 illustrated in FIG. 50C, the power storage device 8602 can be stored in an under-seat storage unit 8604. The power storage device 8602 can be stored in the under-seat storage unit 8604 even when the under-seat storage unit 8604 is small.

### Embodiment 8

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

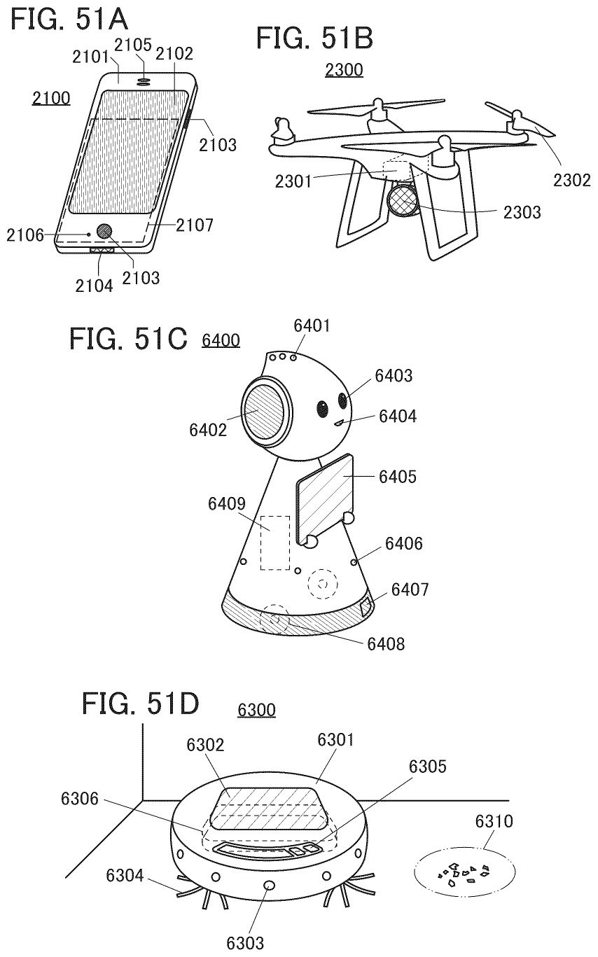

FIG. 51A illustrates an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 100 described in Embodiments 1, 2, and the like achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 51B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiments 1, 2, and the like has high energy density and a high level of safety, and thus can be used safely for a long time over a long period of time and is preferable as the secondary battery included in the unmanned aircraft 2300.

FIG. 51C illustrates an example of a robot. A robot 6400 illustrated in FIG. 51C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in Embodiments 1, 2, and the like has high energy density and a high level of safety, and thus can be used safely for a long time over a long period of time and is preferable as the secondary battery 6409 included in the robot 6400.

FIG. 51D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a secondary battery 6306, a variety of sensors, and the like. Although not shown, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 obtained in Embodiments 1, 2, and the like has high energy density and a high level of safety, and thus can be used safely for a long time over a long period of time and is preferable as the secondary battery 6306 included in the cleaning robot 6300.

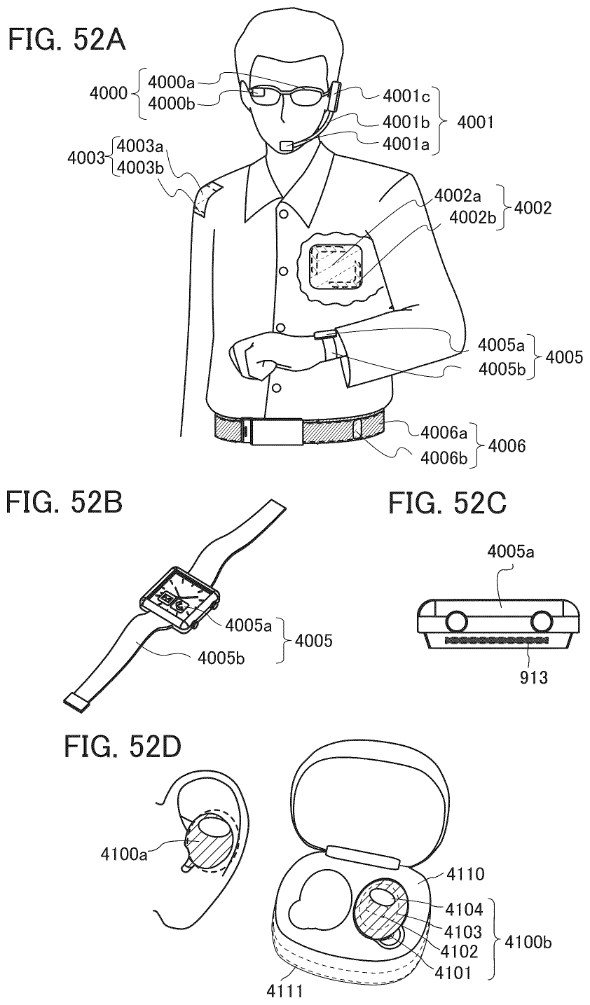

FIG. 52A illustrates examples of wearable devices. A secondary battery is used as a power supply of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 52A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in Embodiments 1, 2, and the like has high energy density and achieves a structure that accommodates space saving due to a reduction in size of the housing.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 52B is a perspective view of the watch-type device 4005 that is detached from an arm.

FIG. 52C is a side view. FIG. 52C illustrates a state where the secondary battery 913 is incorporated in the inner region. The secondary battery 913 is the secondary battery described in Embodiment 4. The secondary battery 913 is provided to overlap with the display portion 4005a, can have high density and high capacity, and is small and lightweight.

Since the secondary battery in the watch-type device 4005 is required to be small and lightweight, the use of the positive electrode active material 100 obtained in Embodiments 1, 2, and the like in the positive electrode of the secondary battery 913 enables the secondary battery 913 to have high energy density and a small size.

FIG. 52D illustrates an example of wireless earphones. The wireless earphones illustrated here as an example consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charging, and the like are preferably included. Furthermore, a microphone may be included.

A case 4110 includes a secondary battery 4111. Moreover, a substrate where a circuit such as a wireless IC or a charge control IC is provided, and a terminal for charging are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. The secondary battery obtained in the above embodiment has a high energy density; thus, with the use of the secondary battery as the secondary battery 4103 and the secondary battery 4111, a structure that accommodates space saving due to a reduction in size of the wireless earphones can be achieved.

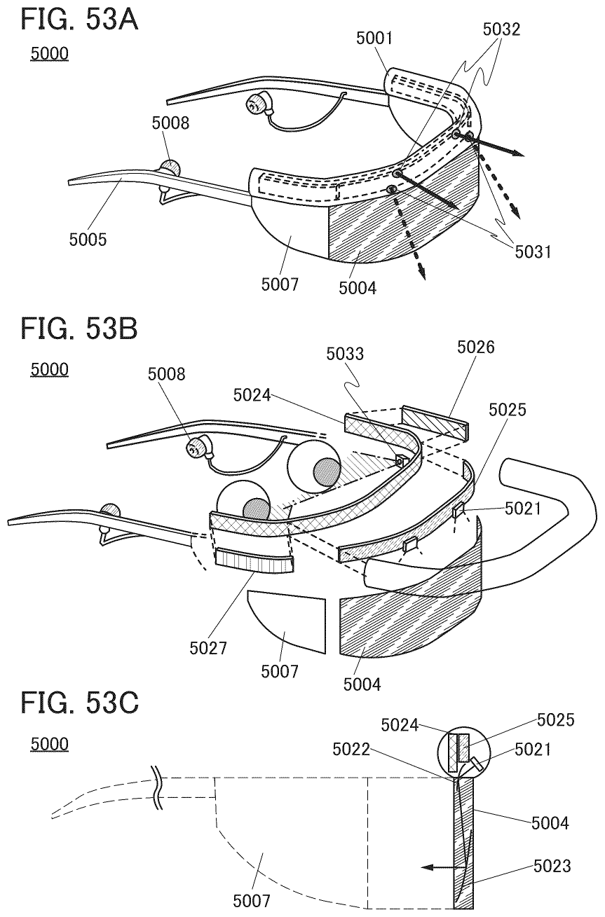

FIG. 53A to FIG. 53C illustrate an example of a glasses-type device that is different from the above. FIG. 53A is a perspective view of a glasses-type device 5000.

The glasses-type device 5000 has a function of what is called a portable information terminal and can execute a variety of programs and reproduce a variety of contents when connected to the Internet, for example. The glasses-type device 5000 has a function of displaying augmented reality contents in an AR mode, for example. The glasses-type device 5000 may have a function of displaying virtual reality contents in a VR mode. Note that the glasses-type device 5000 may also have a function of displaying substitutional reality (SR) contents or mixed reality (MR) contents, in addition to AR and VR contents.

The glasses-type device 5000 includes a housing 5001, an optical component 5004, a wearing tool 5005, a light-blocking portion 5007, and the like. The housing 5001 preferably has a cylindrical shape. The glasses-type device 5000 is preferably wearable on the user's head. Furthermore, it is preferred that the glasses-type device 5000 be worn such that the housing 5001 be positioned above the circumference of the user's head passing through eyebrows and ears. When the housing 5001 has a cylindrical shape that is curved along the user's head, the glasses-type device 5000 can fit the head well. The housing 5001 is fixed to the optical component 5004. The optical component 5004 is fixed to the wearing tool 5005 with the light-blocking portion 5007 or the housing 5001 therebetween.

The glasses-type device 5000 includes a display device 5021, a reflective plate 5022, a secondary battery 5024, and a system unit. Each of the display device 5021, the reflective plate 5022, the secondary battery 5024, and the system unit is preferably provided in the housing 5001. The system unit can be provided with a control unit, a memory unit, and a communication unit included in the glasses-type device 5000, a sensor, and the like. The system unit is preferably provided with a charge circuit, a power supply circuit, and the like.

FIG. 53B illustrates portions included in the glasses-type device 5000 in FIG. 53A. FIG. 53B is a schematic view illustrating details of the portions included in the glasses-type device 5000 illustrated in FIG. 53A.

In the glasses-type device 5000 illustrated in FIG. 53B, the secondary battery 5024, a system unit 5026, and a system unit 5027 are provided in and along the cylindrical housing 5001. Furthermore, a system unit 5025 is provided along the secondary battery 5024 and the like.

The housing 5001 preferably has a curved cylindrical shape. When the secondary battery 5024 is provided along the curved cylinder, the secondary battery 5024 can be positioned efficiently in the housing 5001 and the space in the housing 5001 can be used efficiently; as a result, the volume of the secondary battery 5024 can be increased in some cases.

The housing 5001 has a cylindrical shape and the axis of the cylinder is along a part of a substantially elliptical shape, for example. A cross section of the cylinder is preferably substantially elliptical, for example. Alternatively, a cross section of the cylinder preferably has a part of an elliptical shape, for example. In particular, in the case where the glasses-type device 5000 is worn on ahead, the part of the cross section having a part of an elliptical shape is preferably positioned on a side facing the head. Note that one embodiment of the present invention is not limited thereto. For example, a part of a cross section of the cylinder may have a polygonal (e.g., triangular, quadrangular, or pentagonal) part.

The housing 5001 is curved along the user's forehead, for example. Alternatively, the housing 5001 is positioned along the user's forehead, for example.

The housing 5001 may be formed using two or more cases in combination. For example, the housing 5001 may be formed using an upper case and a lower case in combination. Alternatively, the housing 5001 may be formed using a case on an inner side (a side in contact with the user) and a case on an outer side in combination, for example. The housing 5001 may be formed using three or more cases in combination.

An electrode can be provided in a portion of the housing 5001 in contact with the user's forehead to measure brain waves using the electrode. Alternatively, an electrode may be provided in a portion in contact with the user's forehead to acquire information such as user's sweat using the electrode.

A plurality of secondary batteries having cylindrical shapes, elliptic cylindrical shapes, or prism shapes, for example, may be provided as the secondary batteries 5024 in the housing 5001.

A flexible secondary battery is preferably used as the secondary battery 5024, in which case the battery can have a shape along the curved cylinder. The use of the flexible secondary battery can increase the degree of freedom in placing the battery in the housing. As the flexible secondary battery, the bendable battery described in Embodiment 4 can be used. The secondary battery 5024, the system units, and the like are placed in the cylindrical housing. The system units are provided over a plurality of circuit boards, for example. The plurality of circuit boards and the secondary battery are connected using a connecter, a wiring, and the like. The flexible secondary battery can be placed aside from the connecter, the wiring, and the like.

Note that the secondary battery 5024 may be provided in the wearing tool 5005 as well as in the housing 5001, for example.

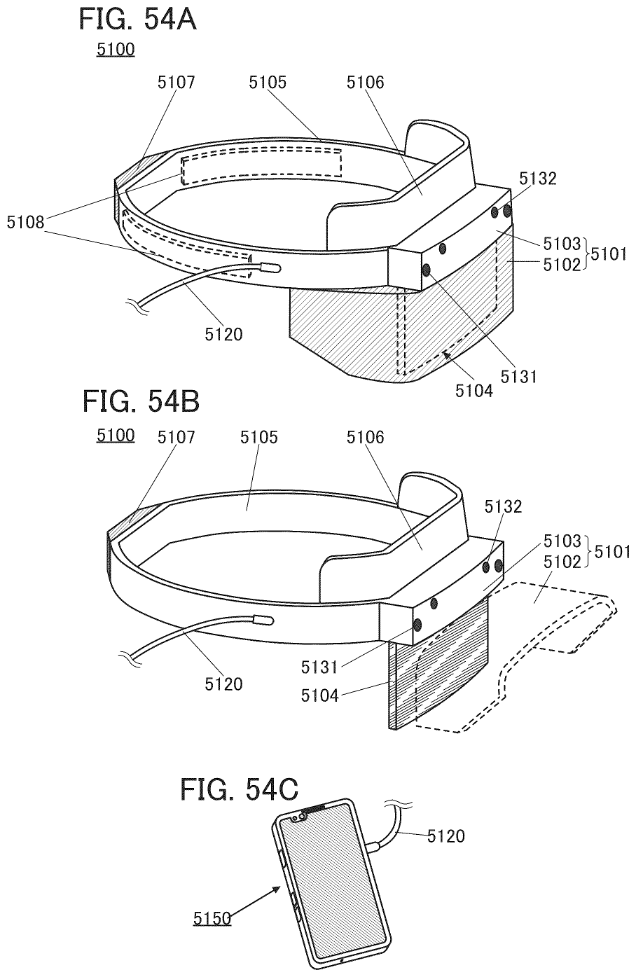

FIG. 54A to FIG. 54C illustrate an example of a head-mounted device. FIG. 54A and FIG. 54B each illustrate a head-mounted device 5100 including a band-shaped wearing tool 5105, and the head-mounted device 5100 is connected to a terminal device 5150 illustrated in FIG. 54C through a cable 5120.

FIG. 54A illustrates a first portion 5102 closing, and FIG. 54B illustrates the first portion 5102 opening. The first portion 5102 has a shape that covers not only the front but also the side of the face when closing. Accordingly, the user's view can be blocked from external light, so that realistic sensation and the sense of immersion can be increased. For example, it is also possible to increase user's sense of fear depending on contents to be displayed.

In the electronic device illustrated in FIG. 54A and FIG. 54B, the wearing tool 5105 has a band-like shape. Accordingly, the electronic device is less likely to slip as compared with the structure illustrated in FIG. 53A and the like and thus is preferable in enjoying contents with relatively large momentum, such as an attraction.

A secondary battery 5107 and the like may be incorporated in the rear head side of the wearing tool 5105. Balancing the weight of the housing 5101 on the front head side and the weight of the secondary battery 5107 on the rear head side can adjust the barycenter of the head-mounted device 5100, whereby the head-mounted device 5100 can be worn more comfortably.

A secondary battery 5108 having flexibility may be provided in the band-shaped wearing tool 5105. In the example illustrated in FIG. 54A, two secondary batteries 5108 are provided in the wearing tool 5105. The use of the flexible secondary battery is preferable because the secondary battery can be provided along the curved band shape. As the flexible secondary battery 5108, the bendable battery described in Embodiment 4 can be used.

The wearing tool 5105 includes a portion 5106 covering the user's forehead or front head. Owing to the portion 5106, the head-mounted device 5100 can be less likely to slip. An electrode can be provided in a portion of the portion 5106 or the housing 5101 in contact with the user's forehead to measure brain waves using the electrode.

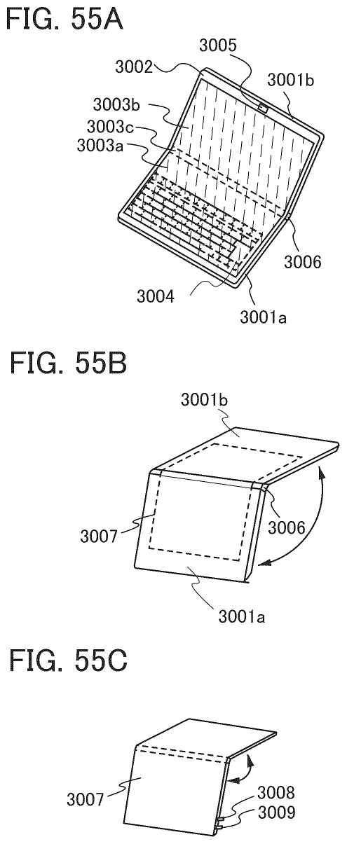

FIG. 55A illustrates an example of a foldable personal computer or a foldable tablet fabricated by mounting the secondary battery disclosed in this specification as at least one component, and illustrates an example of the appearance.

In FIG. 55A, a first housing 3001a, a second housing 3001b, and a hinge portion 3006 between the first housing 3001a and the second housing 3001b are provided, and the device is folded in a region shown by the dotted lines in the drawing and can be opened and closed. A peripheral portion 3002 is protected using a rubber member that surrounds the periphery of a display portion.

The rubber member of the peripheral portion 3002 includes openings: an opening of the display portion and an opening of a sensor portion 3005. An optical system including a lens and an imaging element are provided in the sensor portion 3005, and an image of a user can be captured. As the imaging element, a CCD camera or a CMOS camera can be used, for example. In addition, an infrared camera may be used in combination with such a camera. The infrared camera, which has a higher output level with a higher temperature of an object, can sense or extract a living body such as a human or an animal. A distance image sensor may be provided as the imaging element, which can also be used as a biometric authentication sensor by capturing an image of the user.

When the user opens or closes the device by changing a distance between the first housing 3001a and the second housing 3001b, the device is folded in the portion shown by the dotted lines in the drawing; thus, in the case where the display portion is used as one display region, the display portion is preferably formed using a plurality of flexible films. Note that the film is not limited to an organic material and may be a thin glass substrate having flexibility, for example.

The display portion is formed using a plurality of flexible films and uses a plurality of light-emitting elements arranged in a matrix.

As the light-emitting element, an EL element (also referred to as an EL device) such as an OLED or a QLED is preferably used. Examples of a light-emitting substance contained in the EL element include a substance exhibiting fluorescence (a fluorescent material), a substance exhibiting phosphorescence (a phosphorescent material), an inorganic compound (such as a quantum dot material), and a substance exhibiting thermally activated delayed fluorescence (a thermally activated delayed fluorescence (TADF) material). An LED such as a micro LED can also be used as the light-emitting element.

The display portion can be divided into three display regions: a display region 3003a overlapping with the first housing 3001a, a display region 3003b overlapping with the second housing 3001b, and a display region 3003c overlapping with the hinge portion 3006.

The display portion may have a touch input function, and FIG. 55A illustrates an example in which display buttons 3004 such as a keyboard are displayed.

When a light-receiving element is used as a touch sensor, touch operation of an object can be detected using the light-receiving element.

Alternatively, both a light-emitting element and a light-receiving element may be provided in the display portion, and an image can be captured using the light-receiving element. For example, the light-receiving element can be used as an image sensor. Data on biological information such as a fingerprint or a palm print can be obtained by the function of the image sensor. That is, a biometric authentication sensor can be incorporated in the display portion. When the display portion incorporates a biometric authentication sensor, the number of components of an electronic device can be reduced as compared to the case where a biometric authentication sensor is provided separately from the display portion; thus, the size and weight of the electronic device can be reduced. In the case where the display portion includes a biometric authentication sensor, the sensor portion 3005 illustrated in FIG. 55A is not necessarily provided.

As the light-receiving element, a pn photodiode or a pin photodiode can be used, for example. The light-receiving element functions as a photoelectric conversion element (also referred to as a photoelectric conversion device) that detects light entering the light-receiving element and generates electric charge. The amount of electric charge generated from the light-receiving element depends on the amount of light entering the light-receiving element.

It is particularly preferable to use an organic photodiode including a layer containing an organic compound as the light-receiving element. An organic photodiode, which is easily made thin, lightweight, and large in area and has a high degree of freedom for shape and design, can be used in a variety of devices.

FIG. 55A is an external view seen from the side where the display portion is provided, and FIG. 55B is an external view seen from a point of view different from that in FIG. 55A.

In FIG. 55B, a secondary battery 3007 incorporated in the first housing 3001a and the second housing 3001b is shown by the dotted line.

The secondary battery 3007 is incorporated in both the first housing 3001a and the second housing 3001b, whereby the secondary battery with higher capacity can be provided.

FIG. 55C illustrates an example of the appearance of the incorporated secondary battery 3007 having flexibility. In this embodiment, the flexible secondary battery 3007 that can be bent at least partly, specifically in a region shown by the dotted lines is used.

As the flexible secondary battery 3007, the bendable battery described in Embodiment 4 can be used. The flexible secondary battery 3007 is the laminated secondary battery in Embodiment 3 and includes tab portions 3008 and 3009 for electrical connection with the control circuit portion of the secondary battery.

The contents of this embodiment can be freely combined with the contents in the other embodiments.

### Example

In this example, acquisition results of battery characteristics through fabrication of a lithium ion battery described in Embodiments or the like are shown.

### <Formation of Positive Electrode Active Material>

A positive electrode active material used in the lithium ion battery is described. First, a formation process of a positive electrode active material is described in detail with reference to the formation method shown in FIG. 20 and FIG. 21. Note that the method for forming the positive electrode active material used in this example is based on the method for forming the positive electrode active material specifically described in Embodiment 2.

As lithium cobalt oxide (LiCoO₂) in Step S14 in FIG. 20, commercially available lithium cobalt oxide (Cellseed C-10N produced by NIPPON CHEMICAL INDUSTRIAL CO., LTD.) not containing any additive element was prepared. The heating in Step S15 was performed on the lithium cobalt oxide, which was put in a crucible covered with a lid, in a muffle furnace at 850° C. for 2 hours. After the muffle furnace was filled with an oxygen atmosphere, no flowing was performed (O₂ purging). The collected amount after the heating in Step S15 showed a slight decrease in weight. The decrease in weight was probably caused by elimination of impurities from the lithium cobalt oxide.

Next, in accordance with Step S21 and Step S41 shown in FIG. 21A and FIG. 21B, addition of Mg and F and addition of Ni and Al were separately performed as addition of the additive elements. First, LiF and MgF₂ were prepared as the F source and the Mg source, respectively in accordance with Step S21 shown in FIG. 21A. The LiF and MgF₂ were weighed such that LiF:MgF₂=1:3 (molar ratio). Then, LiF and MgF₂ were mixed into dehydrated acetone and the mixture was stirred at a rotating speed of 400 rpm for 12 hours, whereby the additive element source (A1 source) was produced. In the mixing, a ball mill was used and a grinding medium was zirconium oxide balls. The F source and Mg source weighing approximately 10 g in total were put in a 45-mL-capacity container of the mixing ball mill together with 20 mL of dehydrated acetone and 22 g of zirconium oxide balls (1 mmϕ) and mixed. Then, the mixture was made to pass through a sieve with an aperture of 300 μm, whereby the A1 source having a uniform particle diameter was obtained.

Next, as Step S31, approximately 9 g in total of the A1 source was weighed such that the amount of the additive elements contained in the A1 source was 1 mol % with respect to lithium cobalt oxide, and then mixed by a dry method with lithium cobalt oxide subjected to the initial heating. At this time, stirring was performed at a rotating speed of 150 rpm for 1 hour. These conditions were milder than those of the stirring in the production of the A1 source. Finally, the mixture was made to pass through a sieve with an aperture of 300 μm, whereby a mixture 903 was obtained (Step S32).

Next, as Step S33, the mixture 903 was heated. The heating conditions were 900° C. and 20 hours. During the heating, a lid was put on a crucible containing the mixture 903. The crucible was filled with an atmosphere containing oxygen and entry and exit of the oxygen were blocked (purged). By the heating, a composite oxide containing Mg and F was obtained (Step S34a).

Then, as Step S51, the composite oxide and the additive element source (A2 source) were mixed. In accordance with Step S41 shown in FIG. 21B, nickel hydroxide and aluminum hydroxide were prepared as the Ni source and the Al source, respectively. The nickel hydroxide was weighed to be 0.5 mol % with respect to lithium cobalt oxide and the aluminum hydroxide was weighed to be 0.5 mol % with respect to lithium cobalt oxide, and then mixing with the composite oxide was performed by a dry method. At this time, stirring was performed at a rotational speed of 150 rpm for 1 hour. In the mixing, a ball mill was used and a grinding medium was zirconium oxide balls. The Ni source and Al source weighing approximately 7.5 g in total were put in a 45-mL-capacity container of the mixing ball mill together with 22 g of zirconium oxide balls (1 mmϕ) and mixed. These conditions were milder than those of the stirring in the production of the A1 source. Finally, the mixture was made to pass through a sieve with an aperture of 300 μm, whereby a mixture 904 having a uniform particle diameter was obtained (Step S52).

Next, as Step S53, the mixture 904 was heated. The heating conditions were 850° C. and 10 hours. During the heating, a lid was put on a crucible containing the mixture 904. The crucible was filled with an atmosphere containing oxygen and entry and exit of the oxygen were blocked (purged). By the heating, lithium cobalt oxide containing Mg, F, Ni, and Al was obtained (Step S54). The positive electrode active material (composite oxide) obtained in the above manner was used as Positive Electrode Active Material Sample 1. Note that the positive electrode active material of Positive Electrode Active Material Sample 1 obtained in this example is one formed on the basis of the method for forming the positive electrode active material 100 specifically described in Embodiment 2, and the formed positive electrode active material 100 also have the features of the positive electrode active material 100 specifically described in Embodiment 2.

### <Formation 1 of Positive Electrode>

First, Positive Electrode Active Material Sample 1, acetylene black (AB), and poly(vinylidene fluoride) (PVDF) were prepared as a positive electrode active material, a conductive material, and a binding agent, respectively. A slurry was formed by mixing the positive electrode active material, AB, and PVDF at a weight ratio of 95:3:2, and the slurry was applied to a positive electrode current collector of aluminum. As a solvent of the slurry, NMP was used.

After the slurry was applied to the positive electrode current collector, the solvent was volatilized. Through the above process, Positive Electrode Sample 1 was obtained. The loading level of the positive electrode active material was approximately 10.8 mg/cm².

### <Formation 2 of Positive Electrode>

Positive Electrode Sample 2 was formed in a manner similar to that of Positive Electrode Sample 1 except that commercial lithium cobalt oxide (CELLSEED C-10N produced by NIPPON CHEMICAL INDUSTRIAL CO., LTD.) was used instead of Positive Electrode Active Material Sample 1 as the positive electrode active material. The loading level of the positive electrode active material was approximately 10.5 mg/cm².

### <Formation of Negative Electrode>

Non-graphitizing carbon was prepared as the negative electrode active material. For a binding agent, CMC and SBR were prepared. Then, non-graphitizing carbon, CMC, and SBR were mixed at a weight ratio of 98:1:1 to form a slurry, and the slurry was applied on a copper negative electrode current collector. As a solvent of the slurry, water was used.

After the slurry was applied on the negative electrode current collector, the solvent was volatilized. Through the above process, the negative electrode was obtained. The loading level of the negative electrode active material was approximately 8.8 mg/cm².

### <Fabrication of Lithium Ion Battery>

A lithium ion battery (Cell 1) was fabricated using Positive Electrode Sample 1 formed above, the negative electrode formed above, a separator, an electrolyte, and an exterior body. A lithium ion battery (Cell 2) was fabricated using Positive Electrode Sample 2 formed above, the negative electrode formed above, a separator, an electrolyte, and an exterior body. For a method for fabricating the lithium ion battery, the method for the laminated secondary battery described in Embodiment 3 was referred to.

As the separator, 25-μm-thick polypropylene was used.

As the electrolyte, an organic electrolyte solution obtained by dissolving lithium hexafluorophosphate (LiPF₆) at 1 mol/L in a mixed organic solvent containing EC (ethylene carbonate), EMC (ethyl methyl carbonate), and DMC (dimethyl carbonate) at a volume ratio of 30:35:35 was used.

As the exterior body, an aluminum laminated film was used.

Next, initial charging and discharging of Cell 1 and Cell 2 were performed. Table 2 shows a method of the initial charging and discharging. The initial charging and discharging are sometimes referred to as aging or conditioning. Note that 1 C=200 mA/g (positive electrode active material weight).

TABLE 2

| | Charging/ | |
|---|---|---|
| | discharging | Conditions |
| Step | Constant | 0.01 C. Environment temperature: 25° C. |
| A1 | current | End when any of termination voltage: 4.5 V [symbol] |
| | charging | termination capacity: 15 mAb/g [symbol] and |
| | | termination time: 20 hours is satisfied. |
| Step | Constant | 0.1 C. Environment temperature: 25° C. |
| A2 | current | End when any of termination voltage: 4.5 V [symbol] |
| | charging | termination capacity: 105 mA/g [symbol] and |
| | | termination time: 20 hours is satisfied. |
| Step | Constant | 0.1 C [symbol] 4.5 V. Environment temperature: 25° C. |
| A3 | current- | End when either termination current: 0.01 C |
| | constant | or lower or termination time: 10 hours is |
| | voltage | satisfied |
| | charging | |
| Step | Constant | 0.2 C. Environment temperature: 25° C. |
| A4 | current | End when either termination voltage: 2.5 V |
| | discharging | or termination time: 8 hours is satisfied. |
| Step | Constant | 0.2 C [symbol] 4.5 V. Environment temperature: 25° C. |
| A5 | current- | End when either termination current: 0.02 C |
| | constant | or lower or termination time: 8 hours is |
| | voltage | satisfied |
| | charging | |
| Step | Constant | 0.2 C. Environment temperature: 25° C. |
| A6 | current | End when either termination voltage: 2.5 V |
| | discharging | or termination time: 8 hours is satisfied. |

*Step A5 and Step A6 are repeated three times in total. [symbol]
indicates data missing or illegible when filed

### <Measurement Conditions 1>

The discharge characteristics in a low-temperature environment were measured using Cell 1 that had been subjected to the initial charging and discharging shown in Table 2. The measurement conditions are listed in Table 3.

TABLE 3

| | | |
|---|---|---|
| Step | Constant | 0.1 C [symbol] 4.5 V. Environment temperature: 25° C. |
| B1 | current- | End when either termination current: 0.05 C |
| | constant | or lower or termination time: 10 hours is |
| | voltage | satisfied |
| | charging | |
| Step | Constant | 0.1 C. Environment temperature: 25° C. |
| B2 | current | End when either termination voltage: 2.5 V or |
| | discharging | termination time: 10 hours is satisfied. |
| Step | Constant | 0.1 C [symbol] 4.5 V. Environment temperature: 25° C. |
| B3 | current- | End when either termination current: 0.05 C or |
| | constant | lower or termination time: 10 hours is satisfied |
| | voltage | |
| | charging | |
| Step | Constant | 0.1 C. Environment temperature: −40° C. |
| B4 | current | End when either termination voltage: 2.5 V or |
| | discharging | termination time: 10 hours is satisfied. |

[symbol]

indicates data missing or illegible when filed

In order to equalize the charged states before discharging at each environment temperature, Step B1 and Step B3 in Table 3 were performed under the same conditions.

### <Measurement Conditions 2>

In addition to the measurement shown in Table 3, the charge and discharge characteristics in an environment of 25° C. and the charge and discharge characteristics in an environment of −40° C. were measured. The lithium ion battery that had been subjected to the measurement shown in Table 3 was used as Cell 1. Cell 2 that had been subjected to the initial charging and discharging shown in Table 2 was used. The measurement conditions are listed in Table 4.

TABLE 4

| | | |
|---|---|---|
| Step | Constant | 0.1 C [symbol] 4.5 V. Environment temperature: −40° C. |
| C1 | current- | End when either termination current: 0.005 C |
| | constant | or lower or termination time: 10 hours is |
| | voltage | satisfied |
| | charging | |
| Step | Constant | 0.1 C. Environment temperature: −40° C. |
| C2 | current | End when either termination voltage: 2.5 V or |
| | discharging | termination time: 10 hours is satisfied. |
| Step | Constant | 0.1 C. Environment temperature: 25° C. |
| C3 | current | End when either termination voltage: 2.5 V or |
| | discharging | termination time: 10 hours is satisfied. |
| Step | Constant | 0.1 C [symbol] 4.5 V. Environment temperature: 25° C. |
| C4 | current- | Bad when either termination current: 0.05 C |
| | constant | or lower or termination time: 10 hours is |
| | voltage | satisfied |
| | charging | |
| Step | Constant | 0.1 C. Environment temperature: 25° C. |
| C5 | current | End when either termination voltage: 2.5 V or |
| | discharging | termination time: 10 hours is satisfied. |

[symbol]

indicates data missing or illegible when filed

### <Measurement Results of Lithium Ion Battery>

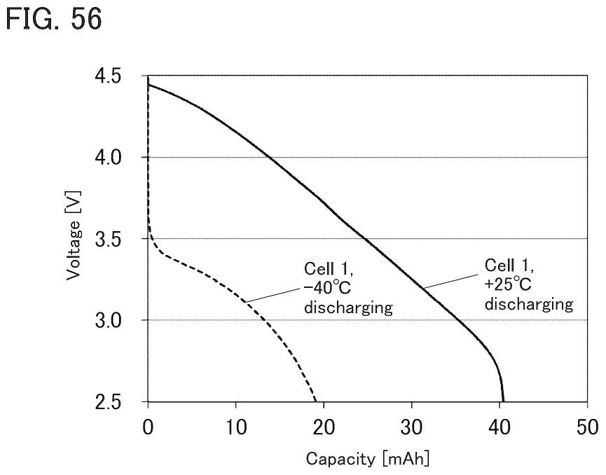

FIG. 56 is a diagram showing the discharge characteristics of Cell 1. In the measurement described with the above measurement conditions 1, the discharge curve of Step B2 (25° C.) is denoted by a solid line and the discharge curve of Step B4 (−40° C.) is denoted by a dotted line. Here, when the discharge capacity at 25° C. and the discharge capacity at −40° C. were compared, a value of the discharge capacity at −40° C. (19.1 mAh (70.2 mAh/g)) was 47.3% of a value of the discharge capacity at 25° C. (40.4 mAh (148.4 mAh/g)). Note that a unit where capacity (mAh) is divided by mass (g) is sometimes used in describing the characteristics of the lithium ion battery in this example, and the mass is the total mass of the positive electrode active material contained in the positive electrode of the lithium ion battery.

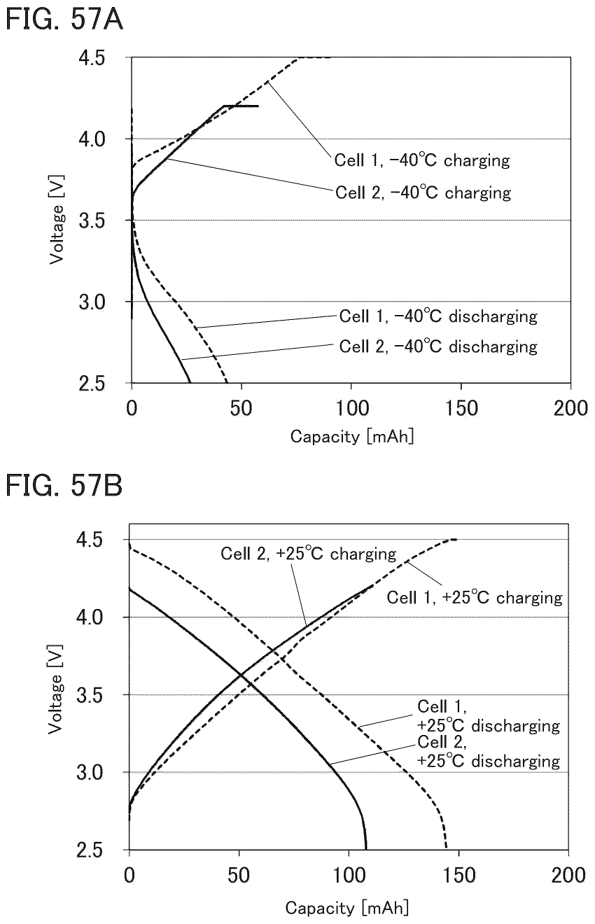

FIG. 57A and FIG. 57B are diagrams showing the charge characteristics and the discharge characteristics of Cell 1 and Cell 2. FIG. 57A shows charge curves of Step C1 (−40° C.) and discharge curves of Step C2 (−40° C.) in the measurement described with the above measurement conditions 2. FIG. 57B shows charge curves of Step C4 (25° C.) and discharge curves of Step C5 (25° C.) among Measurement Conditions 2 described above. In FIG. 57A and FIG. 57B, the results of Cell 1 are denoted by dashed lines and the results of Cell 2 are denoted by solid lines.

Cell 1 containing a positive electrode active material that can be used to high charge voltage exhibited high discharge capacity and high discharge voltage in discharging at 25° C. In addition, Cell 1 exhibited high discharge capacity and high discharge voltage even in discharging at −40° C.

From the above results, Cell 1 of one embodiment of the present invention was found to be a lithium ion battery having excellent discharge characteristics even at a temperature below freezing (−40° C.).

### REFERENCE NUMERALS

100: positive electrode active material, 100a: surface portion, 100b: inner portion, 560a-1: negative electrode characteristic curve, 560a-2: negative electrode characteristic curve, 560b-1: positive electrode characteristic curve, 560b-2: positive electrode characteristic curve, 570a: negative electrode, 570b: positive electrode, 571a: negative electrode current collector, 571b: positive electrode current collector, 572a: negative electrode active material layer, 572b: positive electrode active material layer, 576: electrolyte

1. A lithium ion battery comprising:
a positive electrode comprising a positive electrode active material;
an electrolyte solution; and
a negative electrode comprising a negative electrode active material comprising a carbon material,
wherein in X-ray diffraction analysis with CuKα₁ radiation, the carbon material has peaks at:
2θ of greater than or equal to 20° and less than or equal to 24°;
2θ of greater than or equal to 42° and less than or equal to 46.5°; and
2θ of greater than or equal to 78° and less than or equal to 82°,
wherein a value of discharge capacity obtained by subjecting the lithium ion battery to constant current charging at a charge rate of 0.1 C to a voltage of 4.5 V and constant voltage charging at 4.5 V to a current value of 0.05 C at 25° C. and then constant current discharging at a discharge rate of 0.1 C to a voltage of 2.5 V at −40° C. is higher than or equal to 40% of a value of discharge capacity obtained by subjecting the lithium ion battery to constant current charging at a charge rate of 0.1 C to a voltage of 4.5 V and constant voltage charging at 4.5 V to a current value of 0.05 C at 25° C. and then constant current discharging at a discharge rate of 0.1 C to a voltage of 2.5 V at 25° C., and
wherein 1 C is defined as 200 mA/g.

2. The lithium ion battery according to claim 1,
wherein the positive electrode active material comprises lithium cobalt oxide represented by LiₓCoO₂ (0<x≤1),
wherein when x in the LiₓCoO₂ is 1, the LiₓCoO₂ has a layered rock-salt crystal structure of a space group R-3m, and
wherein when x in the LiₓCoO₂ is greater than 0.1 and less than or equal to 0.24 in a charged state, the LiₓCoO₂ has a crystal structure of a space group P2/m where:
a lattice constant a=4.88±0.01 (×10⁻¹ nm);
a lattice constant b=2.82±0.01 (×10⁻¹ nm);
a lattice constant c=4.84±0.01 (×10⁻¹ nm);
α=90°;
β=109.58±0.01°; and
γ=90°.

3. The lithium ion battery according to claim 1,
wherein the positive electrode active material comprises lithium cobalt oxide represented by LiₓCoO₂ (0<x≤1),
wherein when x in the LiₓCoO₂ is 1, the LiₓCoO₂ has a layered rock-salt crystal structure of a space group R-3m, and
wherein when x in the LiₓCoO₂ is greater than 0.1 and less than or equal to 0.24 in a charged state, a diffraction pattern of the LiₓCoO₂ analyzed by X-ray diffraction with CuKα₁ radiation has peaks at least at:
2θ of greater than or equal to 19.37° and less than or equal to 19.57°; and
2θ of greater than or equal to 45.57° and less than or equal to 45.67°.

4. The lithium ion battery according to claim 1,
wherein the electrolyte solution comprises ethylene carbonate, ethyl methyl carbonate, and dimethyl carbonate, and a volume ratio between the ethylene carbonate, the ethyl methyl carbonate, and the dimethyl carbonate is x:y:100−x−y (5≤x≤35 and 0<y<65) when a total amount of the ethylene carbonate, the ethyl methyl carbonate, and the dimethyl carbonate is set to 100 vol %.
